(19) United States
(12) Patent Application Publication
(10) Pub. No.: US 2025/0348149 A1
(43) Pub. Date: Nov. 13, 2025

(54) Devices, Methods, and Graphical User Interfaces for Generating Tactile Outputs

(71) Applicant: Apple Inc., Cupertino, CA (US)

(72) Inventors: Camille Moussette, San Francisco, CA (US); Christopher B. Fleizach, Gilroy, CA (US); Fabio Santini, Menlo Park, CA (US); James E. Hewitt, Campbell, CA (US); Jules K. Fennis, Seattle, WA (US); Lewis K. Murphy, London (GB); Jorge A. Herrera Soto, Vitacura (CL); Nicholas Y. Sakamoto, Cupertino, CA (US)

(21) Appl. No.: 19/098,654

(22) Filed: Apr. 2, 2025

Related U.S. Application Data
(60) Provisional application No. 63/646,579, filed on May 13, 2024.
(60) Provisional application No. 63/655,975, filed on Jun. 4, 2024.

(51) Int. Cl. G06F 3/01; G06F 3/04817; G06F 3/0484; G06F 3/0488; G06F 3/16

(52) U.S. Cl. CPC G06F 3/016; G06F 3/04817; G06F 3/0484; G06F 3/0488; G06F 3/165

(57) ABSTRACT

A computer system outputs audio content of media being played via a media player application. While outputting the audio content without outputting tactile outputs corresponding to the audio content, the computer system displays a tactile output control, and detect, via the one or more input devices, a first input activating the tactile output control. In response to detecting the first input activating the tactile output control, the computer system outputs a sequence of tactile outputs corresponding to a plurality of audio features of the audio content that are being output in conjunction with the sequence of tactile outputs.

### RELATED APPLICATIONS

This application claims priority to U.S. Provisional Patent Application No. 63/655,975, filed Jun. 4, 2024, and U.S. Provisional Patent Application No. 63/646,579, filed May 13, 2024, each of which is incorporated by reference in its entirety.

### TECHNICAL FIELD

This relates generally to electronic devices with touch-sensitive surfaces, including but not limited to electronic devices with touch-sensitive surfaces that generate tactile outputs to provide haptic feedback to a user.

### BACKGROUND

The use of haptic feedback in computers and other electronic computing devices has increased significantly in recent years. Haptic feedback, typically in combination with visual and/or audio feedback, is often used to indicate a particular state of electronic devices. But methods for providing such feedback are cumbersome and inefficient. For example, providing visual and/or audio feedback without tactile feedback offers a partial sensory experience that some users have difficulty perceiving, such as users with vision and/or hearing impairments, and providing tactile outputs that are not sufficiently noticeable or informative makes it harder for users to recognize alerts. In addition, these methods take longer than necessary, thereby wasting energy. This latter consideration is particularly important in battery-operated devices.

### SUMMARY

Accordingly, there is a need for electronic devices with improved methods and interfaces for providing haptic feedback (typically in conjunction with visual and/or audio feedback) that make manipulation of user interfaces and consumption of media content more efficient and intuitive for a user. Such methods and interfaces optionally complement or replace conventional methods for providing haptic feedback. Such methods and interfaces reduce the number, extent, and/or nature of the inputs from a user by helping the user to understand the connection between provided inputs and device responses to the inputs, thereby creating a more efficient human-machine interface and improving the operability of electronic devices.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed a computer system that includes one or more display devices, and one or more tactile output generators and is in communication with one or more audio output devices and one or more input devices. The method includes outputting, via the one or more audio output devices, audio content of media being played via a media player application. The method further includes, while outputting the audio content without outputting tactile outputs corresponding to the audio content, displaying, via the one or more display devices, a tactile output control, and detecting, via the one or more input devices, a first input activating the tactile output control. The method includes, in response to detecting the first input activating the tactile output control, outputting, via the one or more tactile output generators, a sequence of tactile outputs corresponding to a plurality of audio features of the audio content that are being output in conjunction with the sequence of tactile outputs.

In accordance with some embodiments, a method is performed at a computer system that is in communication with a display device and one or more tactile output generators. The method includes detecting occurrence of a first alert condition; and in response to detecting the occurrence of the first alert condition, outputting, via the one or more tactile output generators, a tactile output corresponding to the first alert condition, including: in accordance with a determination that an increased salience setting of the computer system is not enabled, outputting, via the one or more tactile output generators, a first lower prominence tactile output corresponding to the first alert condition; and in accordance with a determination that the increased salience setting of the computer system is enabled, outputting, via the one or more tactile output generators, a first higher prominence tactile output corresponding to the first alert condition, wherein a prominence of the first higher prominence tactile output is higher than a prominence of the first lower prominence tactile output, and wherein there is a first tactile output difference between the first higher prominence tactile output and the first lower prominence tactile output. The method further includes, after detecting the first alert condition detecting occurrence of a second alert condition that is different from the first alert condition; and in response to detecting the occurrence of the second alert condition, outputting, via the one or more tactile output generators, a tactile output corresponding to the second alert condition, including: in accordance with a determination that the increased salience setting of the computer system is not enabled, outputting, via the one or more tactile output generators, a second lower prominence tactile output corresponding to the second alert condition; and in accordance with a determination that the increased salience setting of the computer system is enabled, outputting, via the one or more tactile output generators, a second higher prominence tactile output corresponding to the second alert condition, wherein a prominence of the second higher prominence tactile output is higher than a prominence of the second lower prominence tactile output, and wherein there is a second tactile output difference between the second higher prominence tactile output and the second lower prominence tactile output; wherein the first tactile output difference is different from the second tactile output difference.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, tactile output generators, optionally audio output generators and/or an audio system, optionally input devices, optionally touch-sensitive surfaces, optionally one or more sensors to detect intensities of contacts with the touch-sensitive surface, and optionally one or more device orientation sensors, are provided with improved methods and interfaces for providing tactile outputs, thereby increasing the effectiveness, efficiency, and user satisfaction with such devices. Such methods and interfaces may complement or replace conventional methods for providing tactile outputs.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 1C is a block diagram illustrating a tactile output module in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C-4E illustrate examples of dynamic intensity thresholds in accordance with some embodiments.

FIGS. 4F-4K illustrate a set of sample tactile output patterns in accordance with some embodiments.

FIGS. 5A-5O illustrate example user interfaces for outputting haptic feedback in conjunction with audio content in accordance with some embodiments.

FIGS. 5P-5S illustrate example graphs for generating haptic outputs in accordance with some embodiments.

FIGS. 6A-6G illustrate example patterns of haptic outputs in accordance with some embodiments.

FIGS. 6H-6S illustrate example user interfaces for controlling and/or receiving haptic outputs in accordance with some embodiments.

FIGS. 7A-7H are flow diagrams of a process for outputting tactile outputs with audio content in accordance with some embodiments.

FIGS. 8A-8D are flow diagrams of a process for outputting tactile outputs for alert conditions in accordance with some embodiments.

### DESCRIPTION OF EMBODIMENTS

Many electronic devices have one or more media playback applications, such as music applications, for outputting audio. Additionally, many electronic devices provide feedback in response to detecting alert conditions, such as notifications and/or other alerts, to provide an indication to the user of device operations. Methods described herein provide haptic feedback, often in conjunction with visual and/or audio feedback, to help a user consume media content and to provide information to a user about the state of a device, including received notifications.

The methods, devices, and GUIs described herein use haptic feedback to improve user interface interactions in multiple ways. For example, they make it easier to: enhance consumption of media output by the device and to distinguish between different types of alerts and/or notifications, including prominent and non-prominent alerts and/or notifications.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

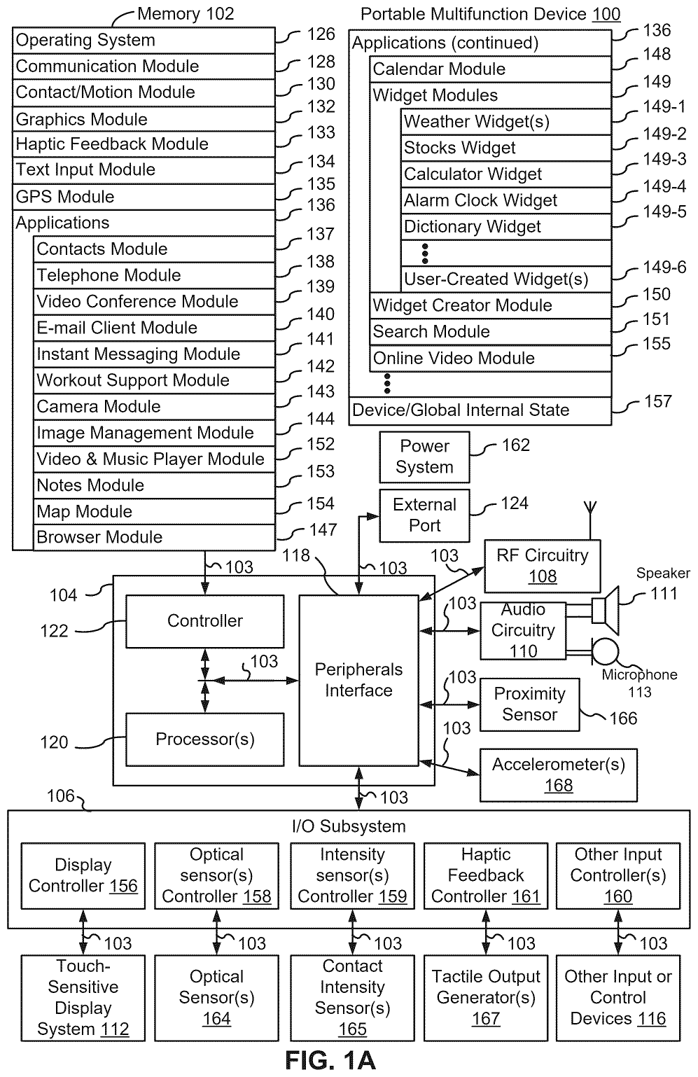

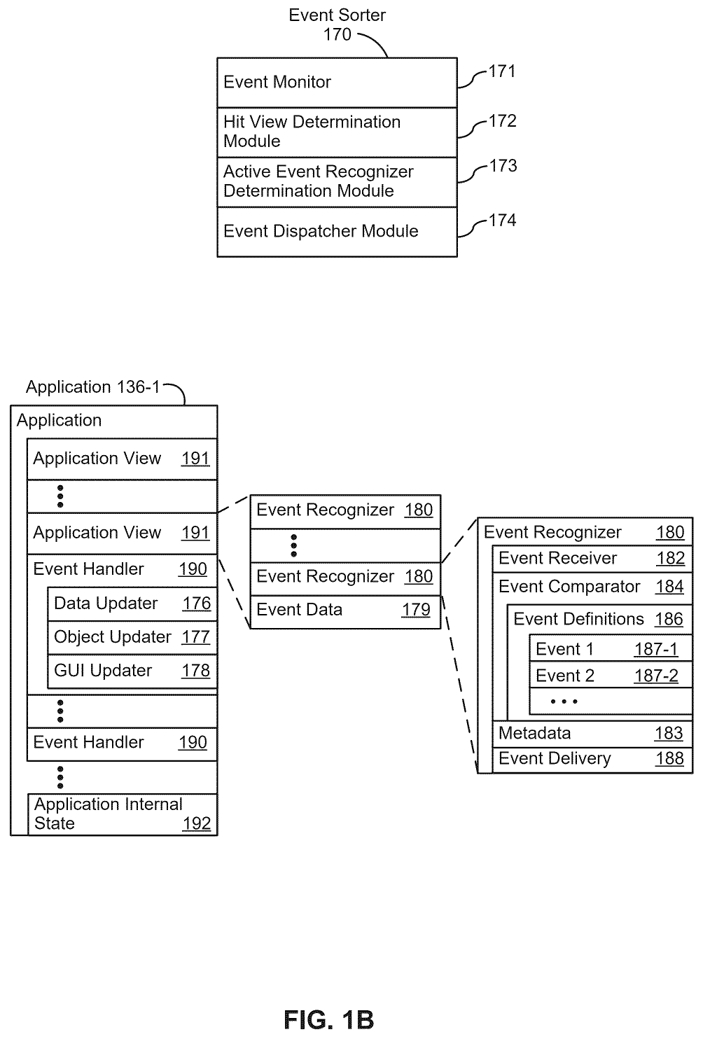

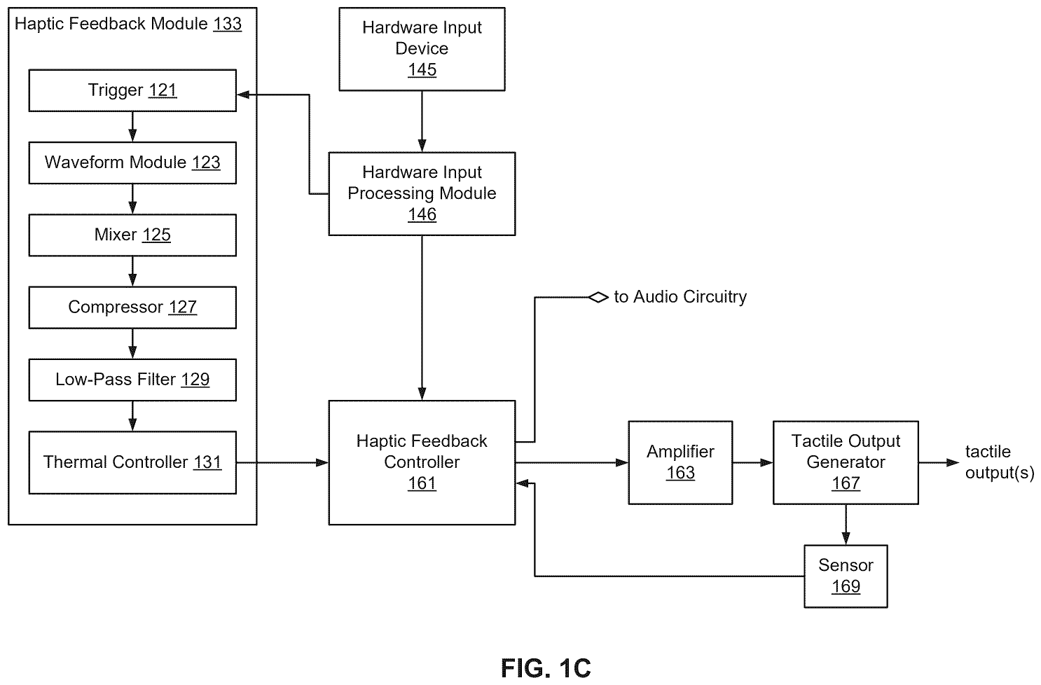

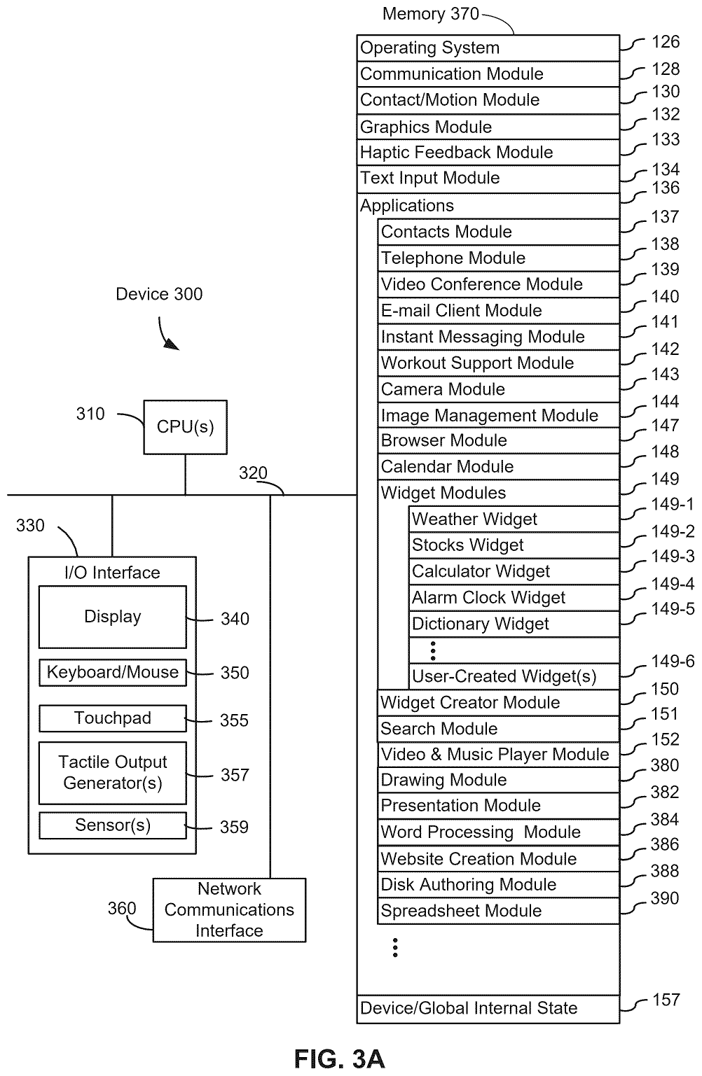

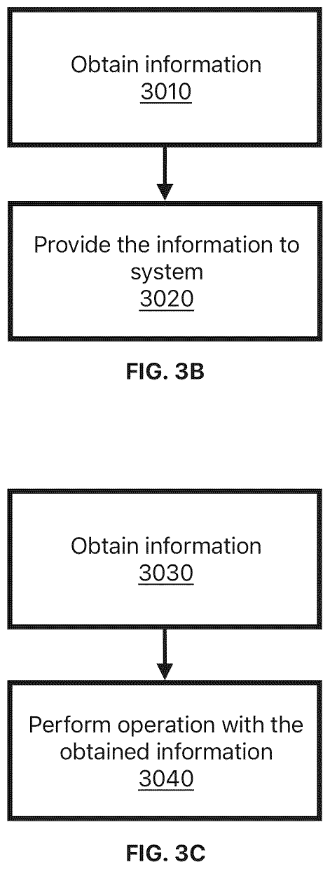

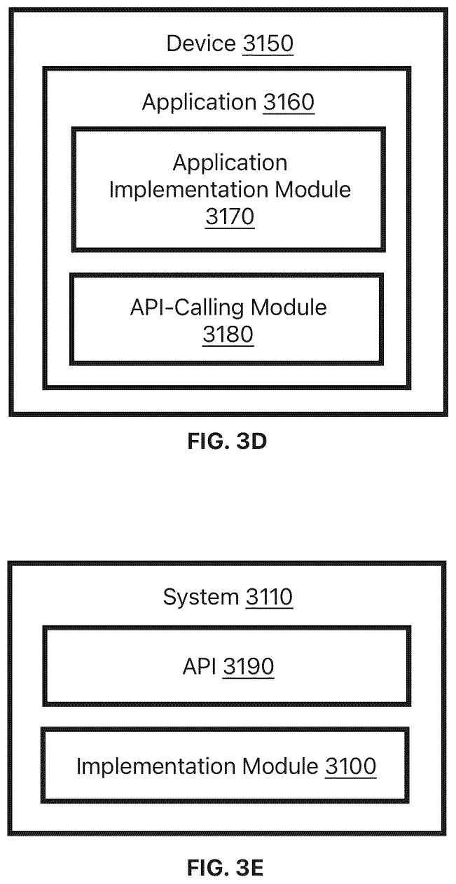

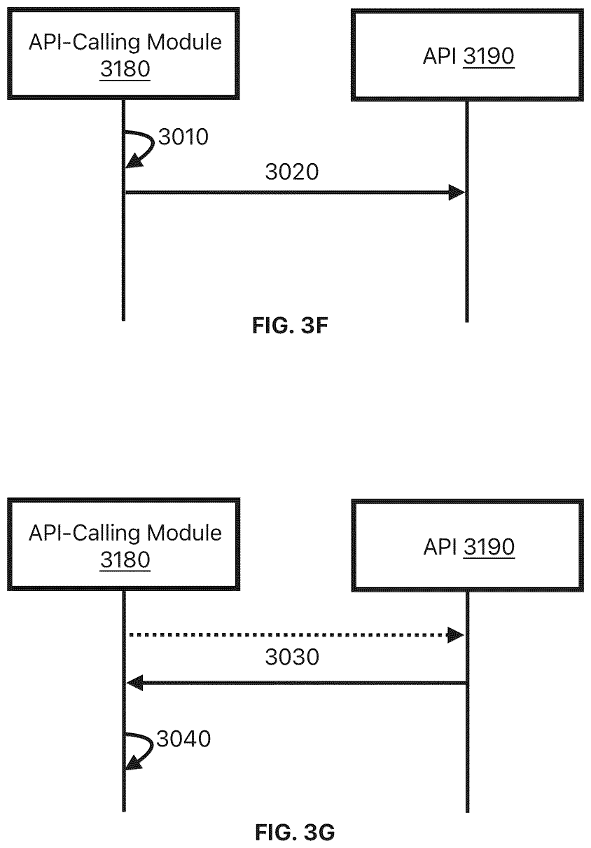

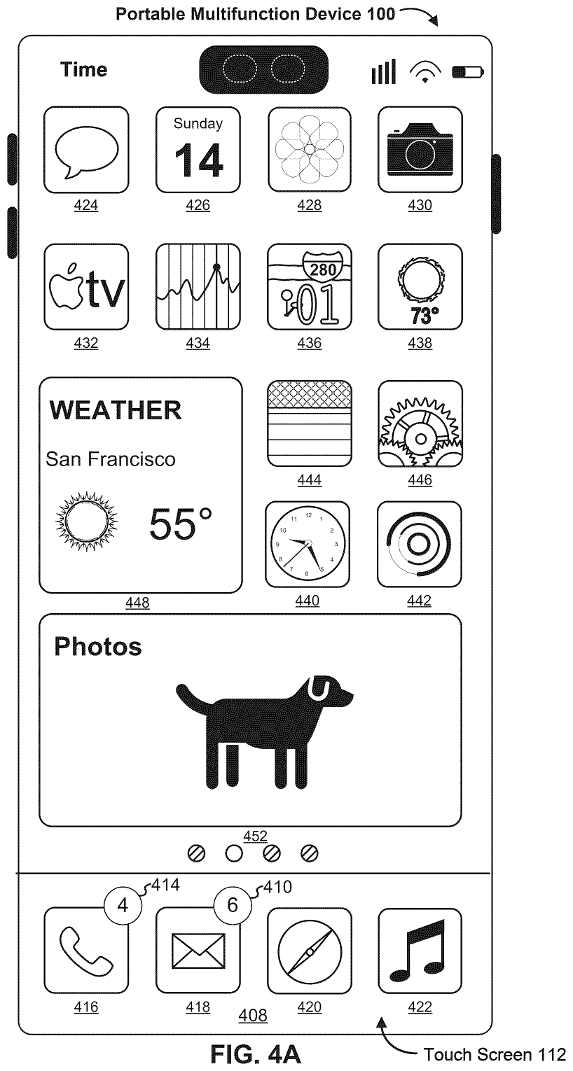

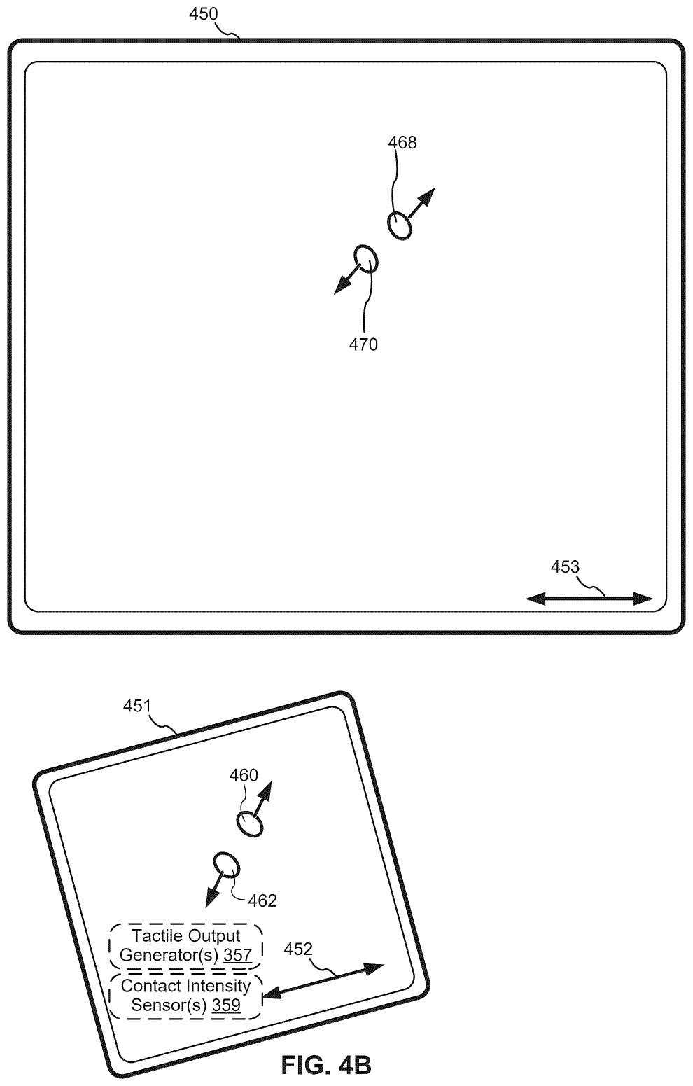

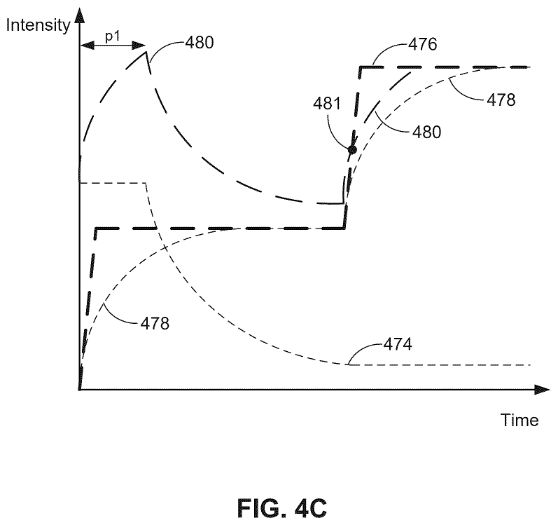

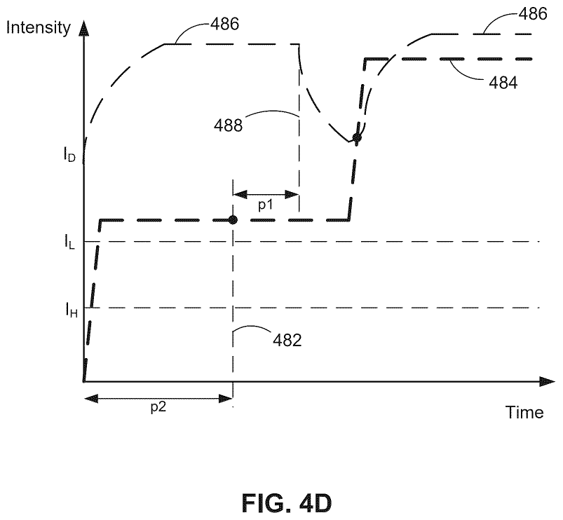

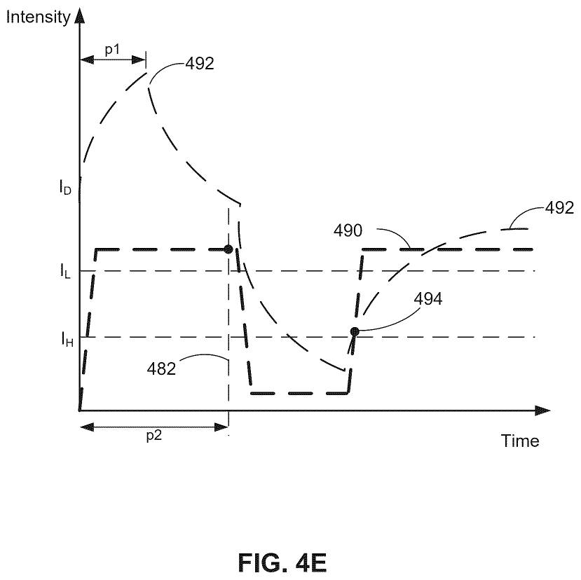

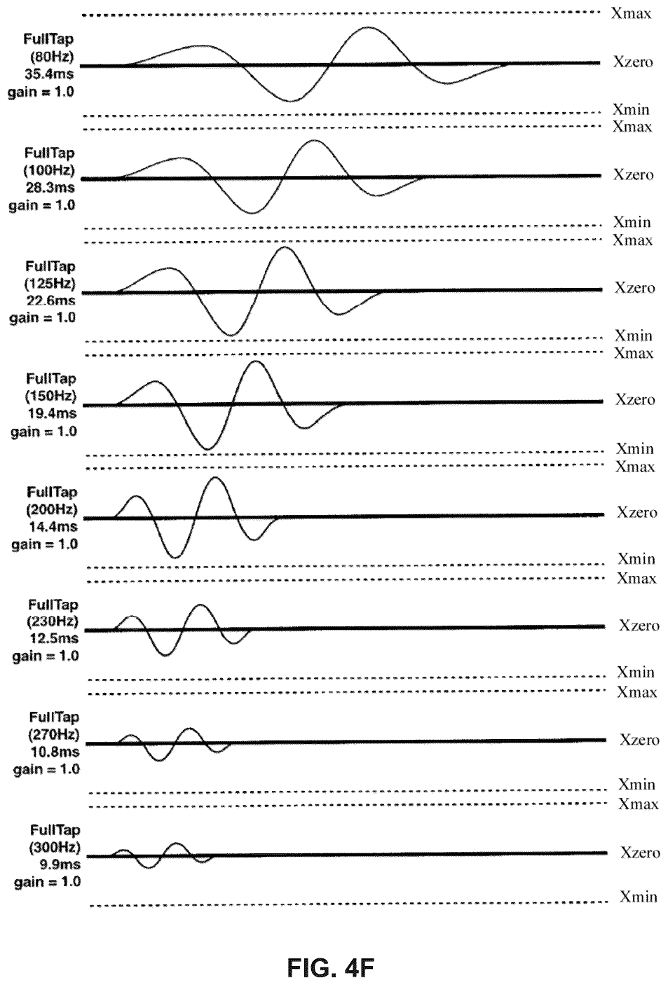

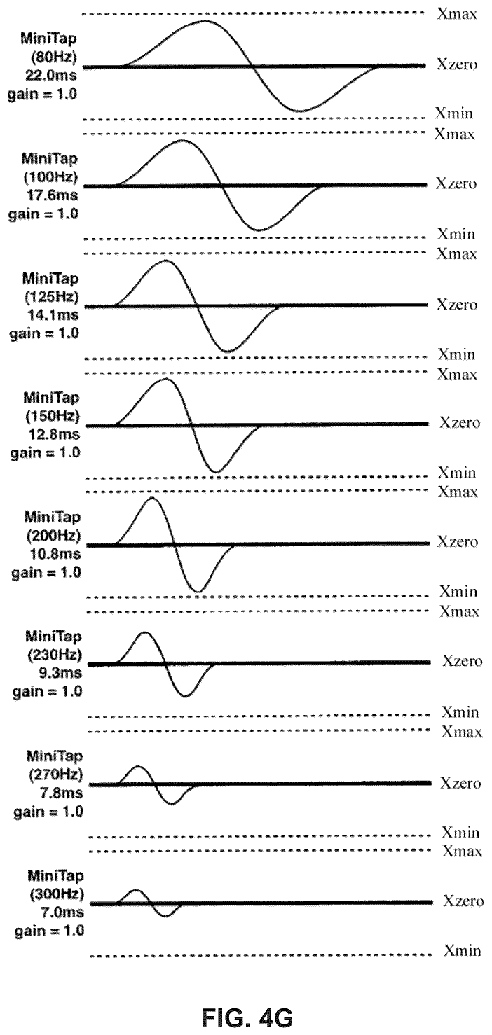

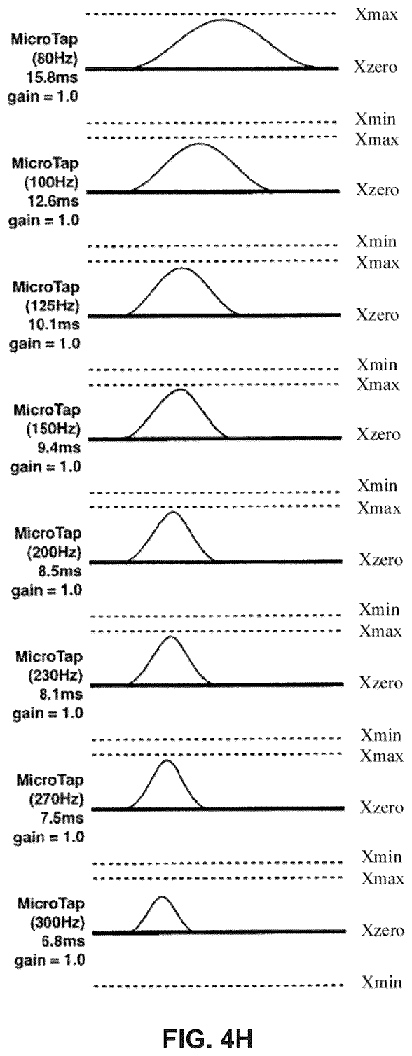

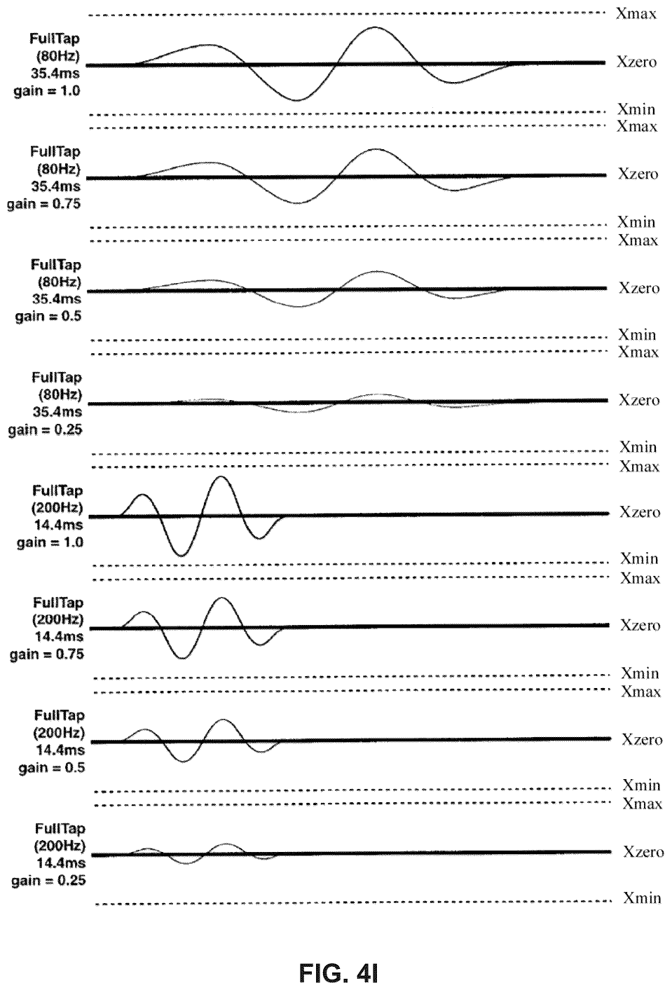

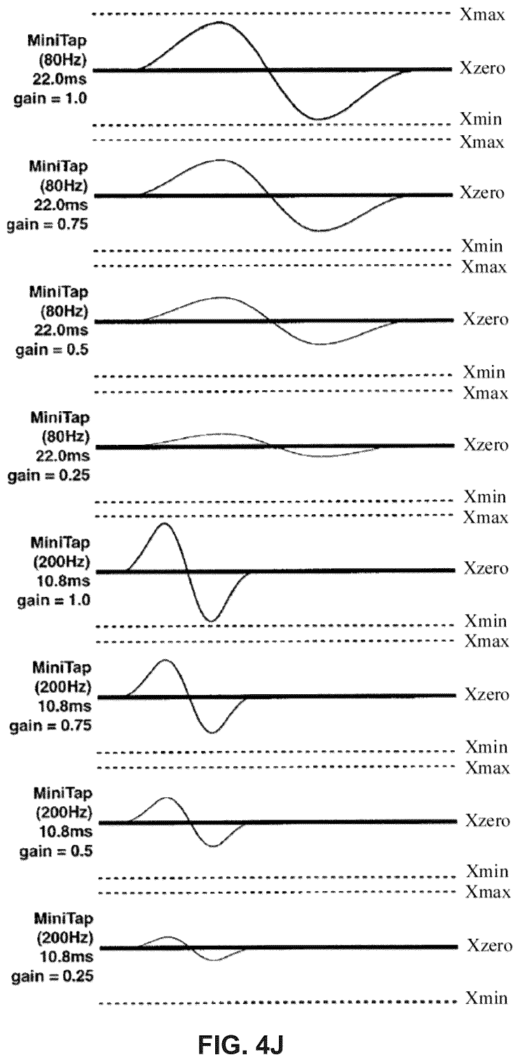

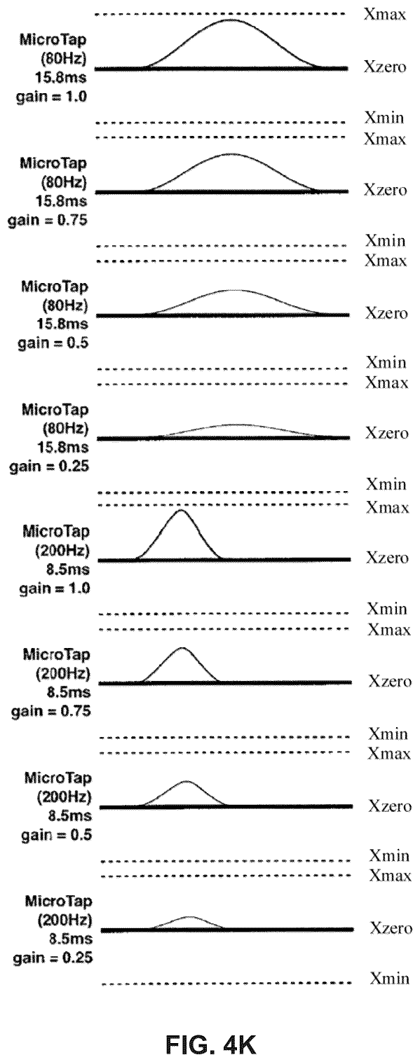

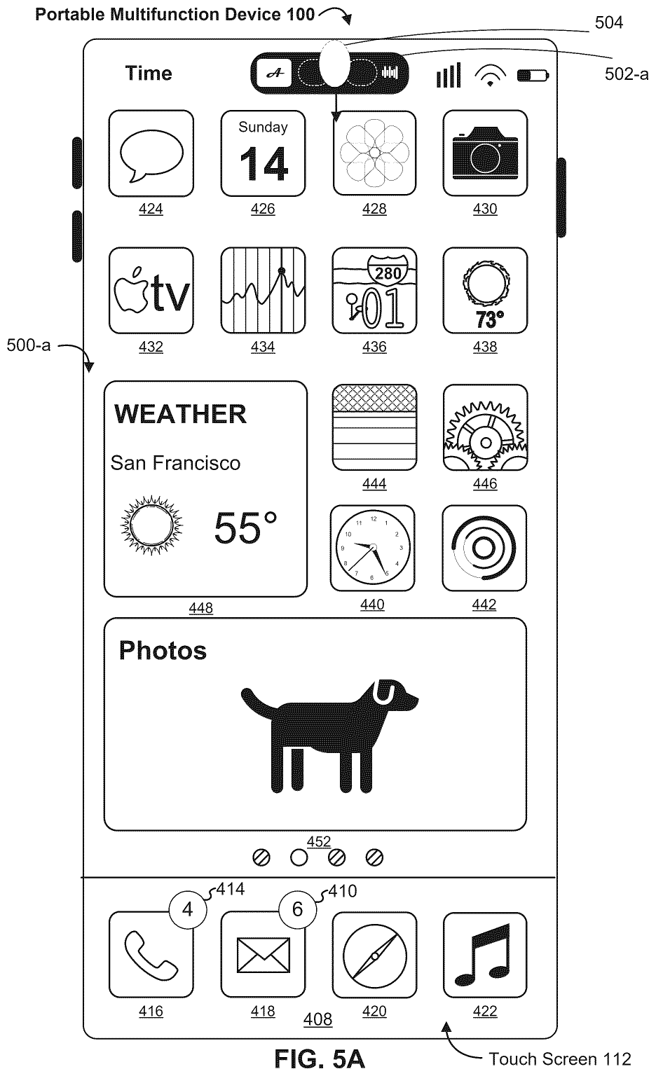

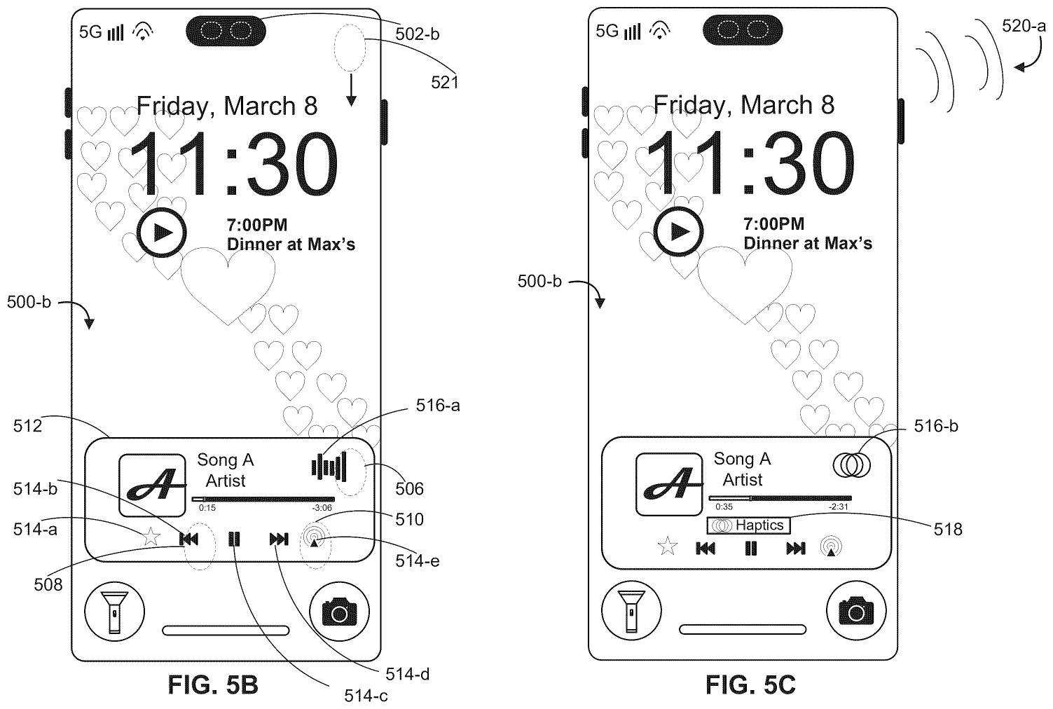

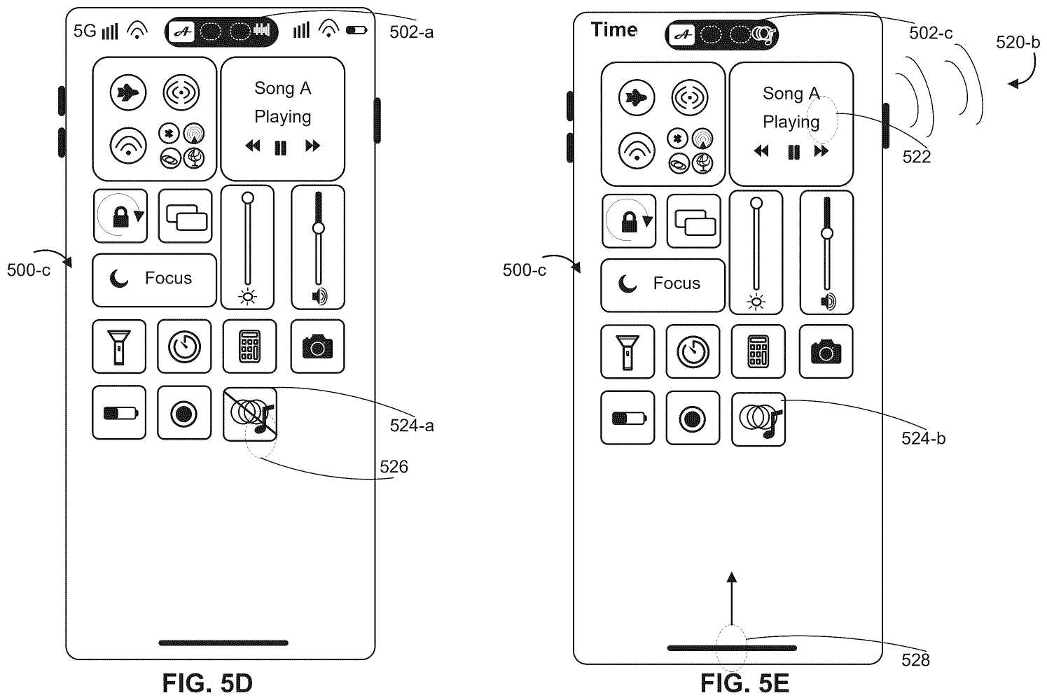

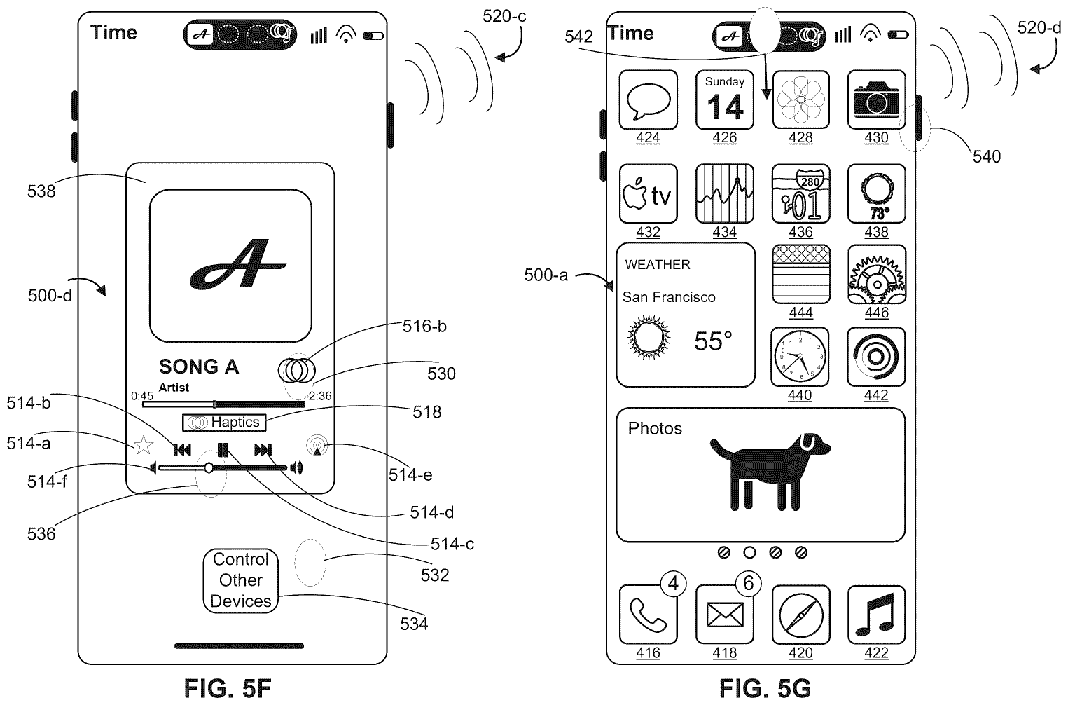

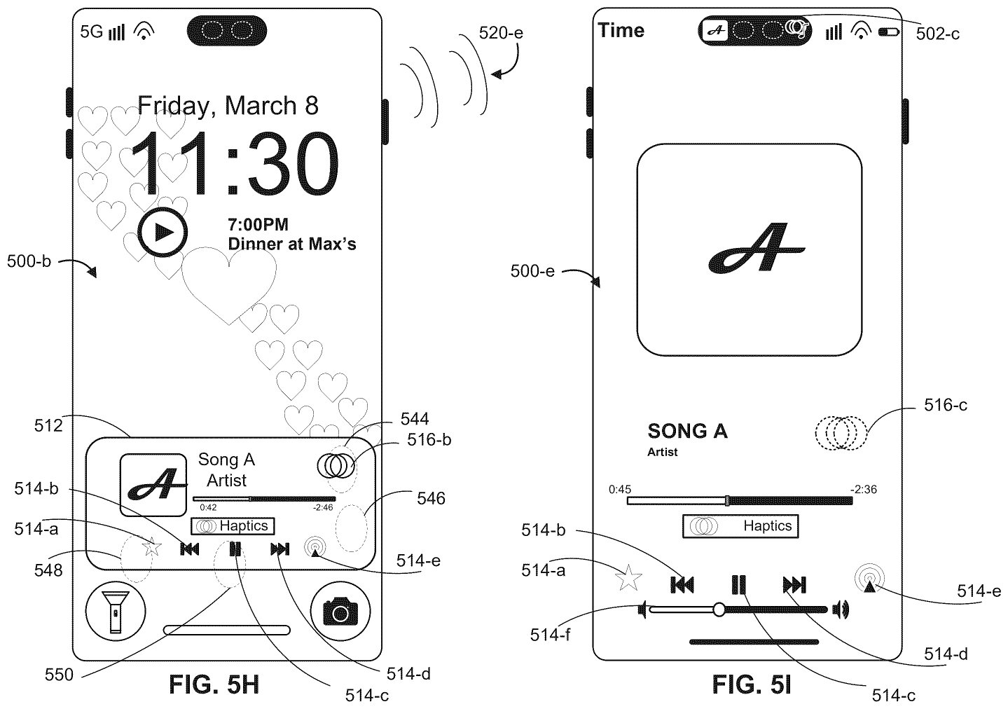

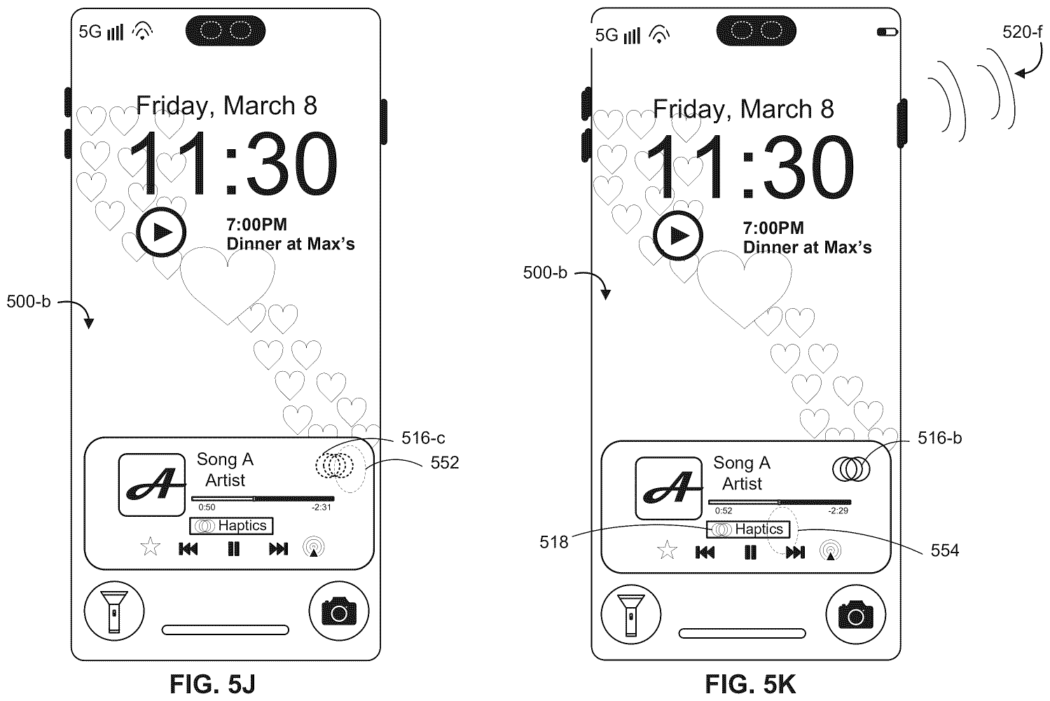

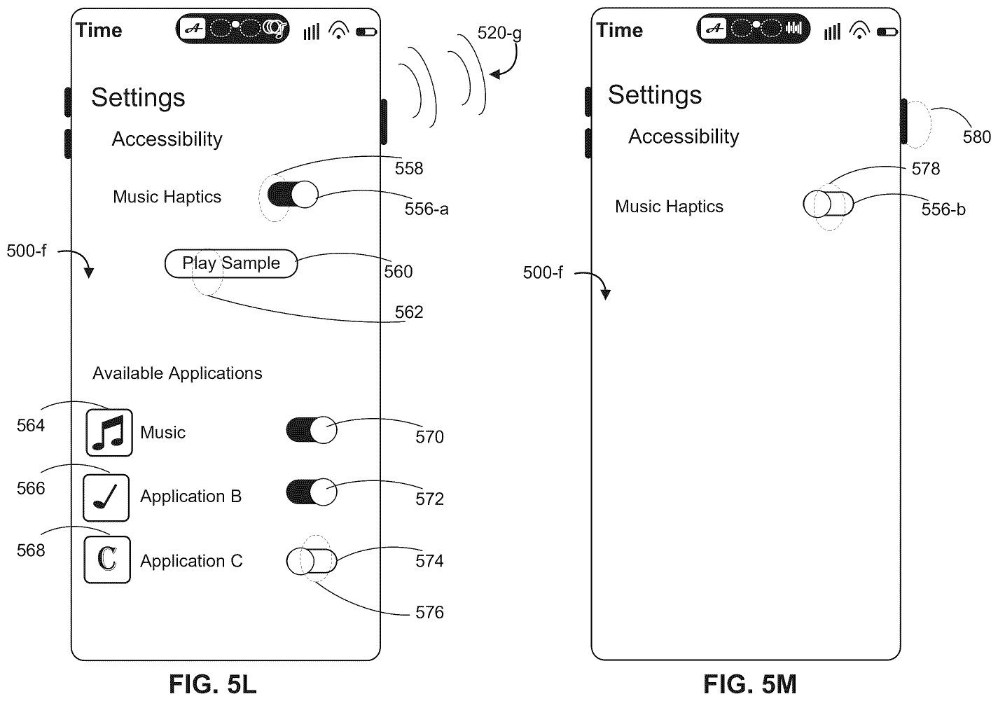

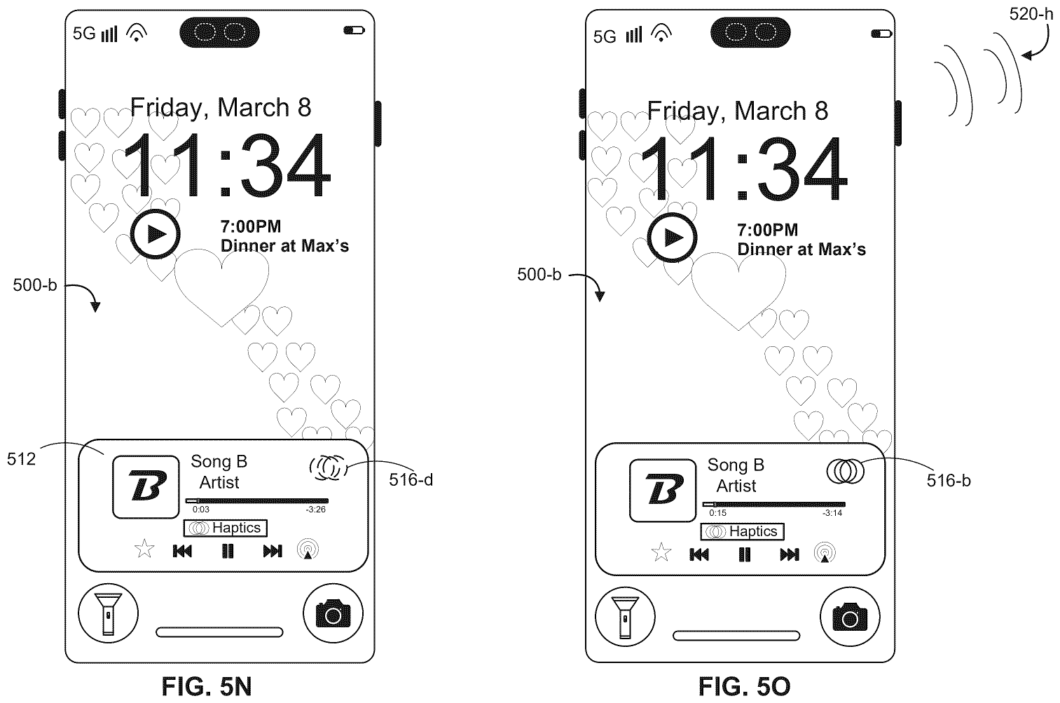

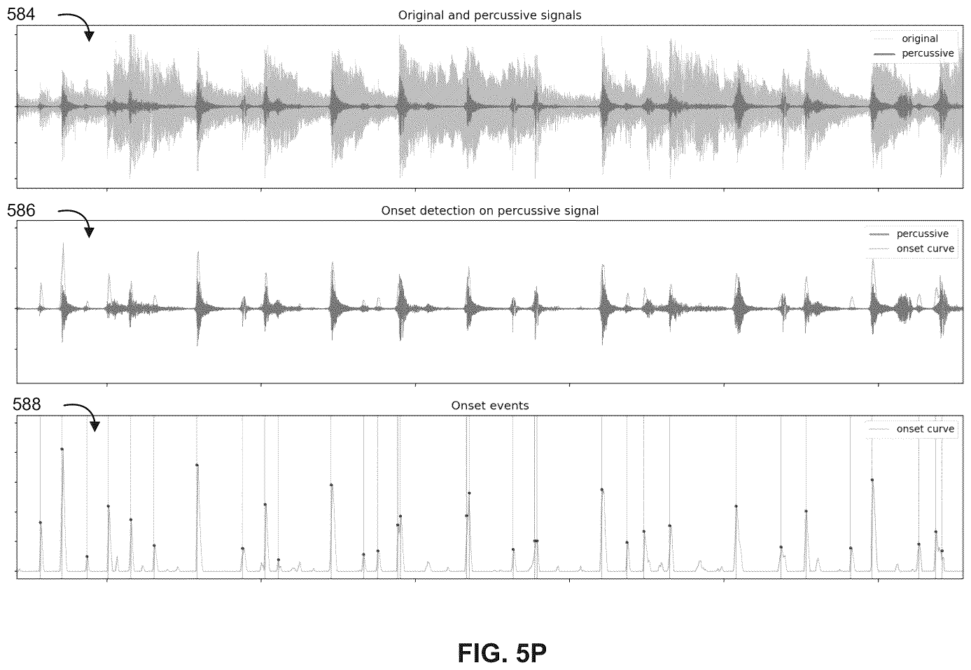

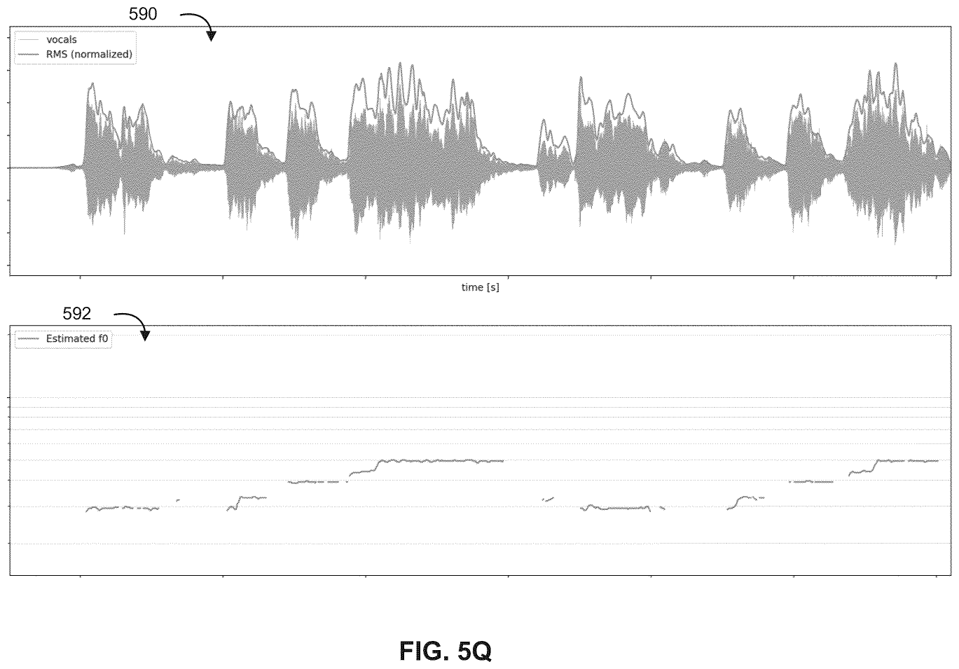

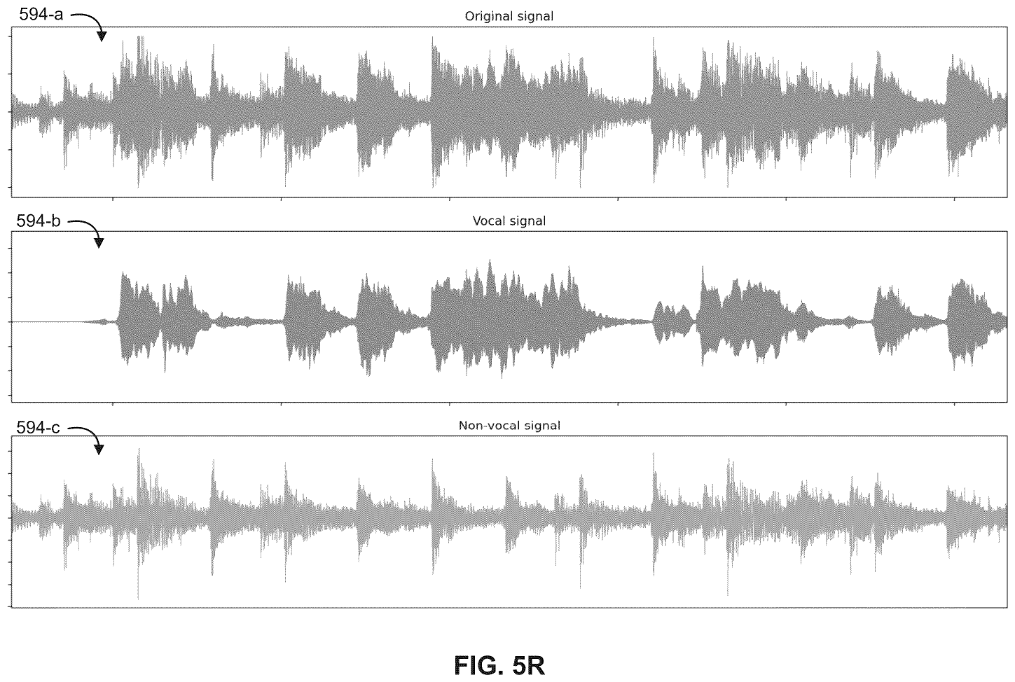

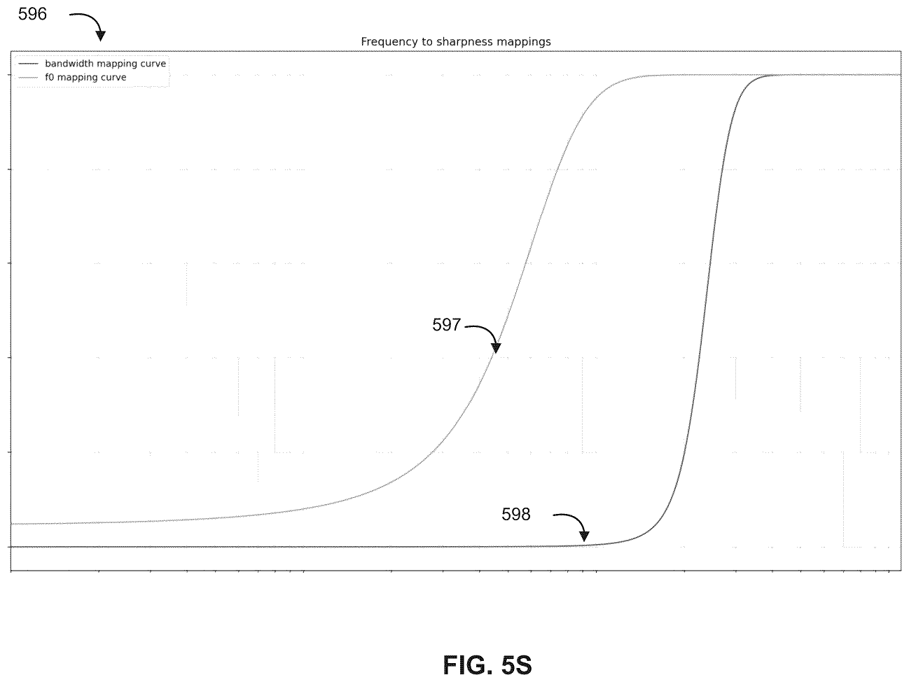

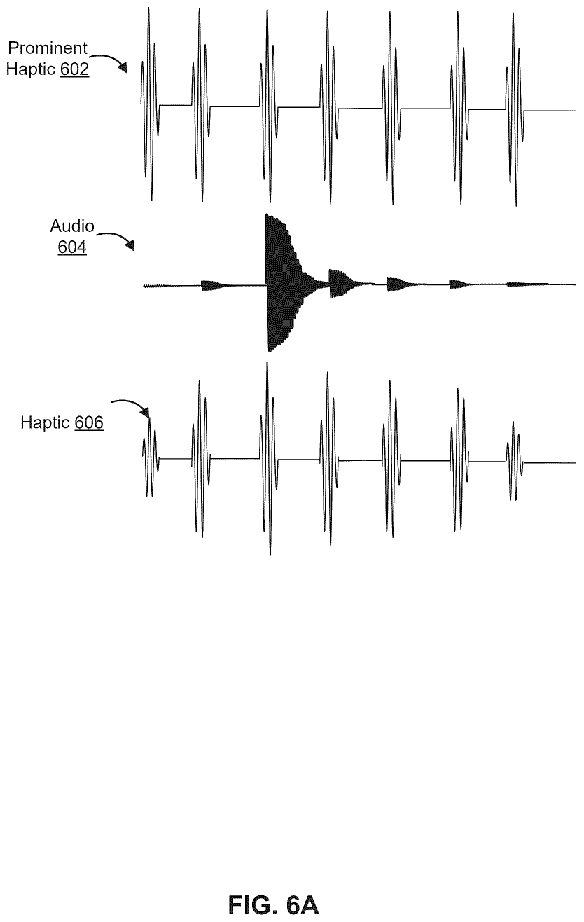

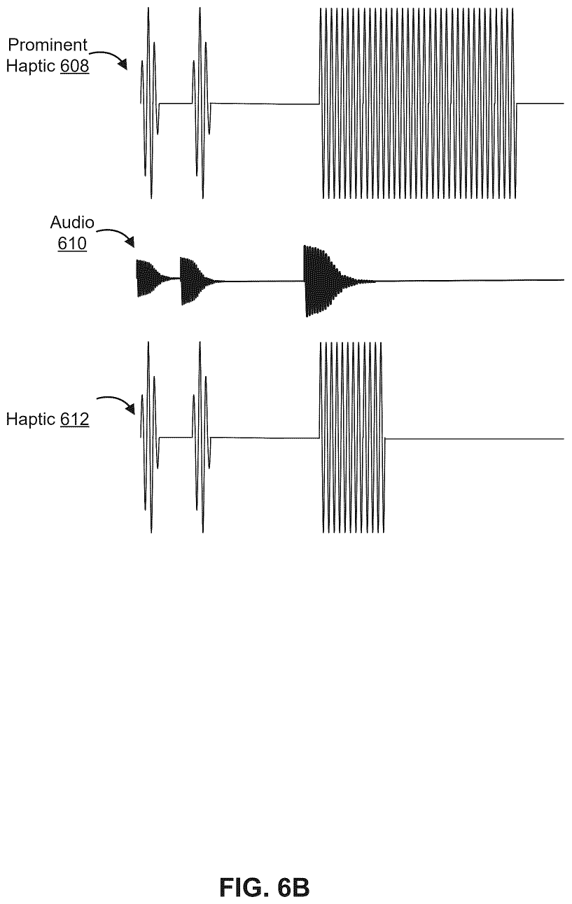

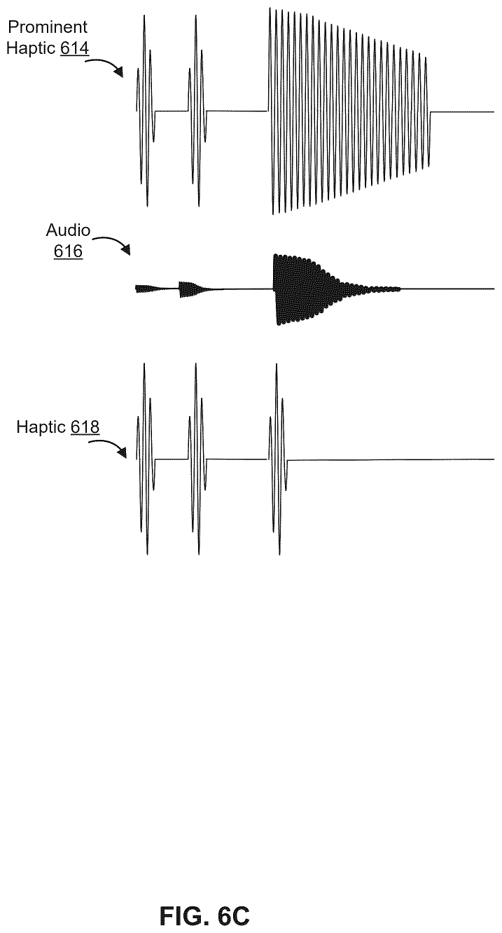

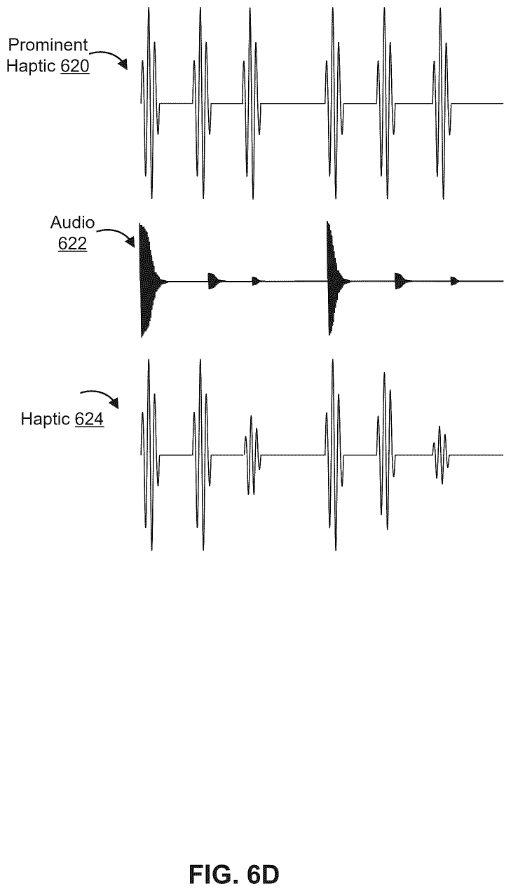

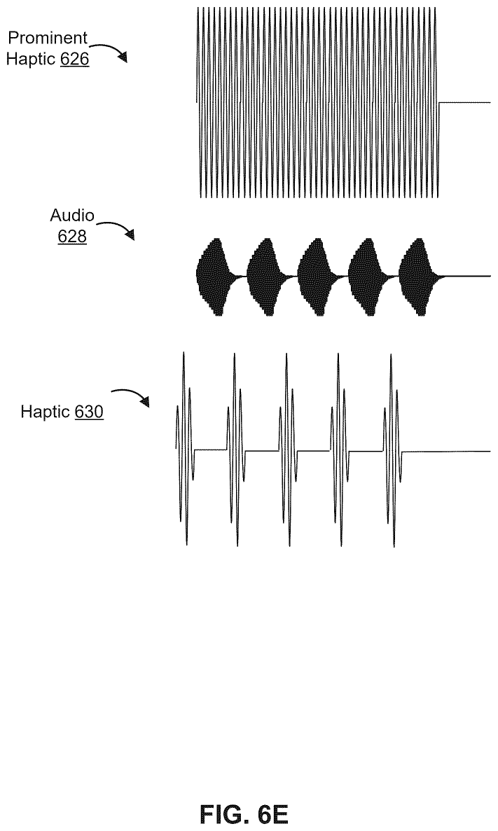

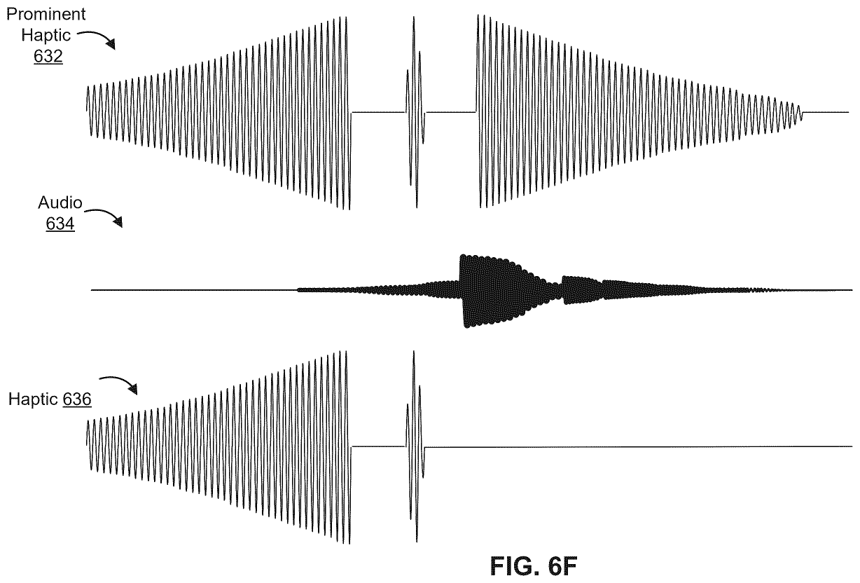

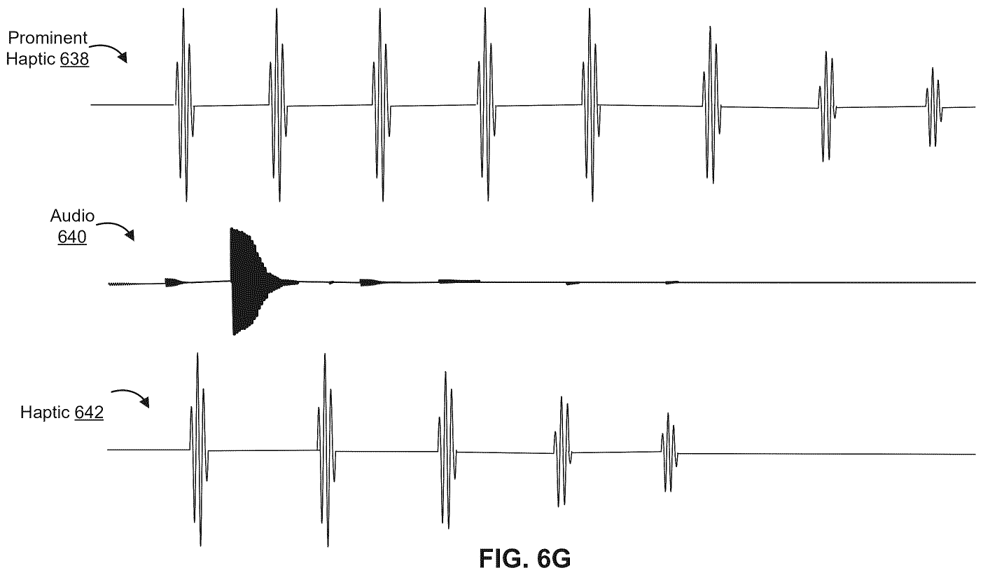

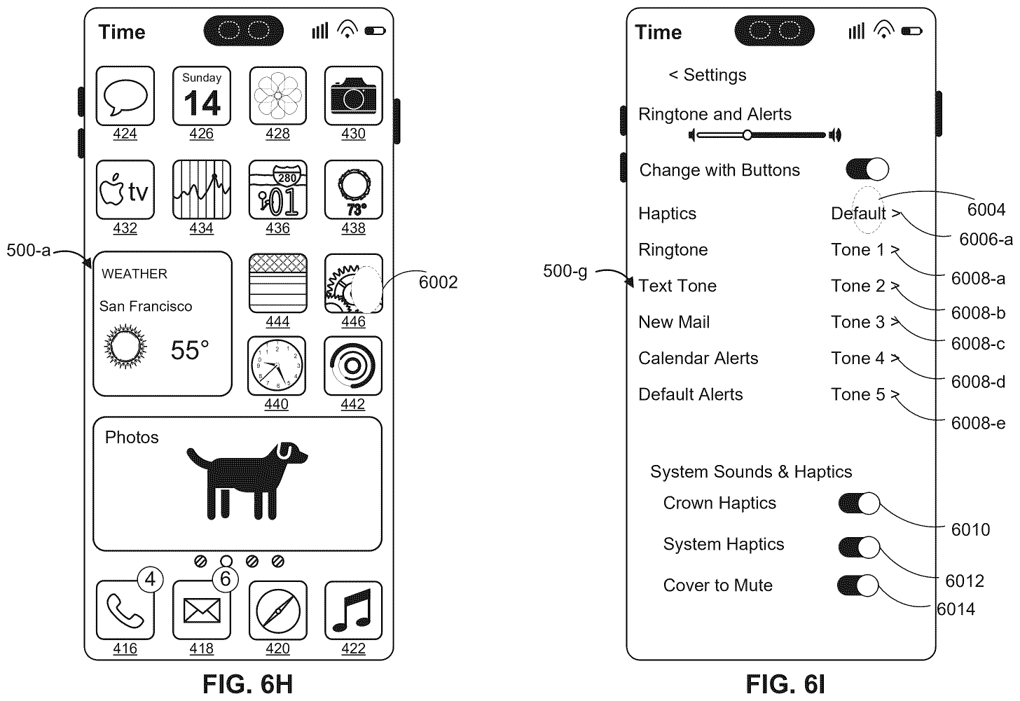

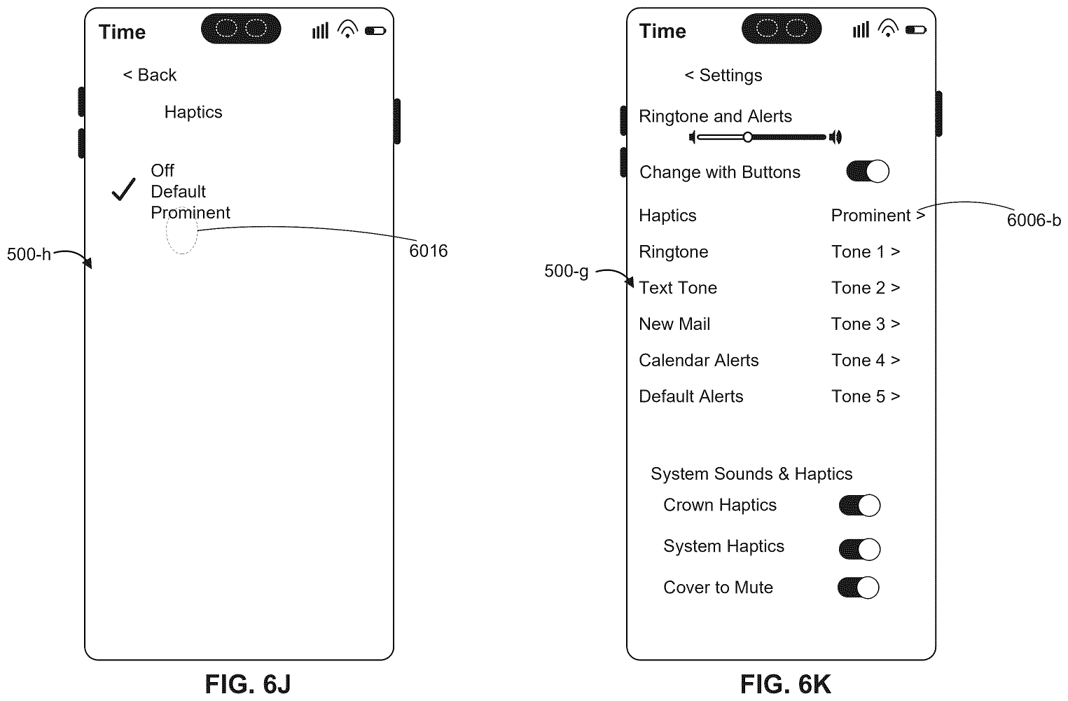

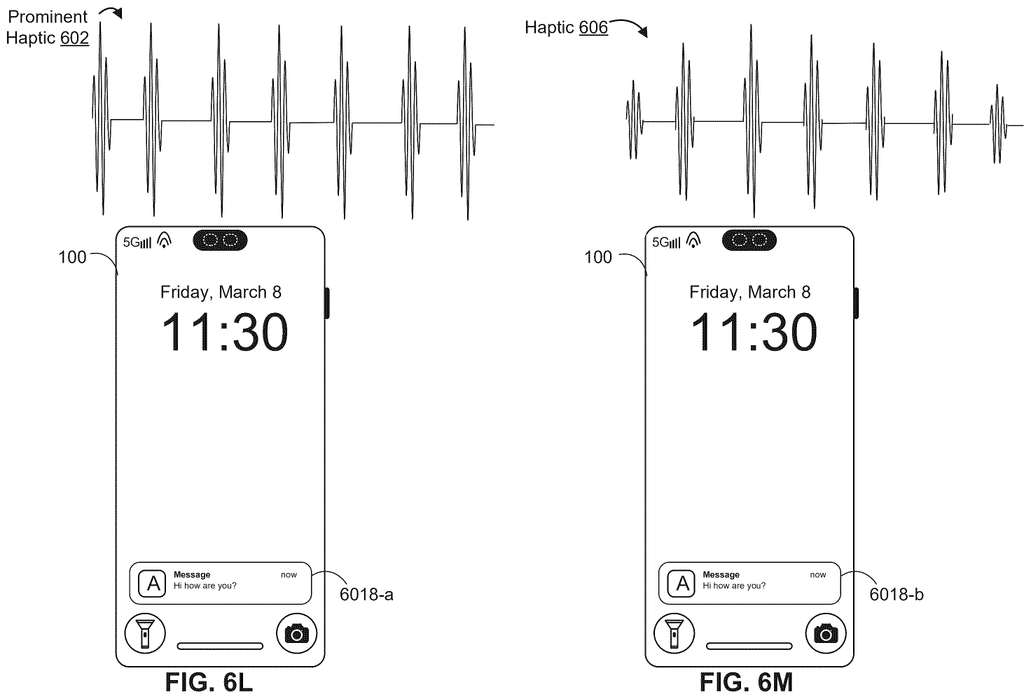

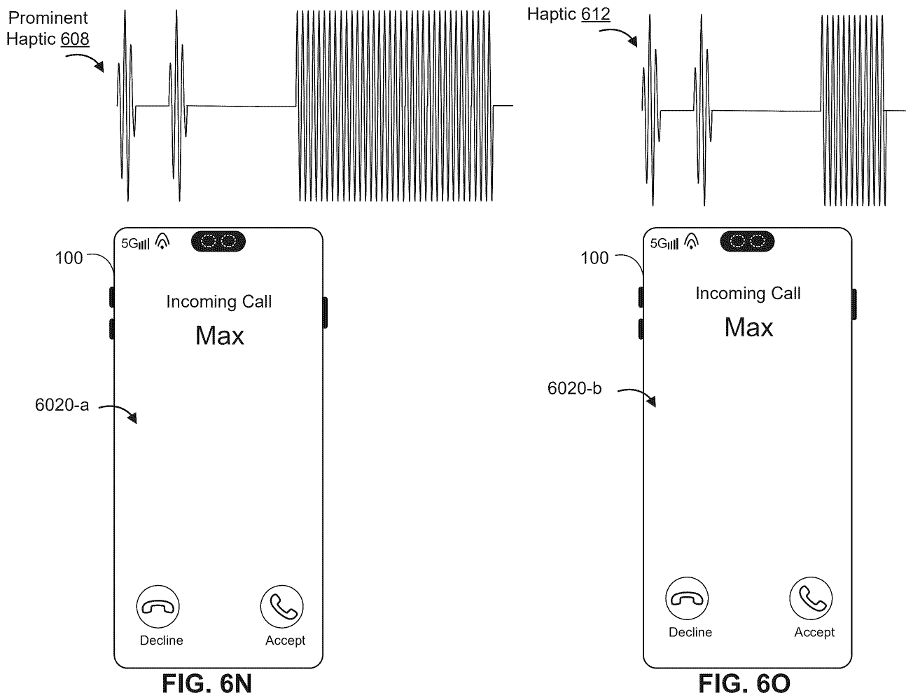

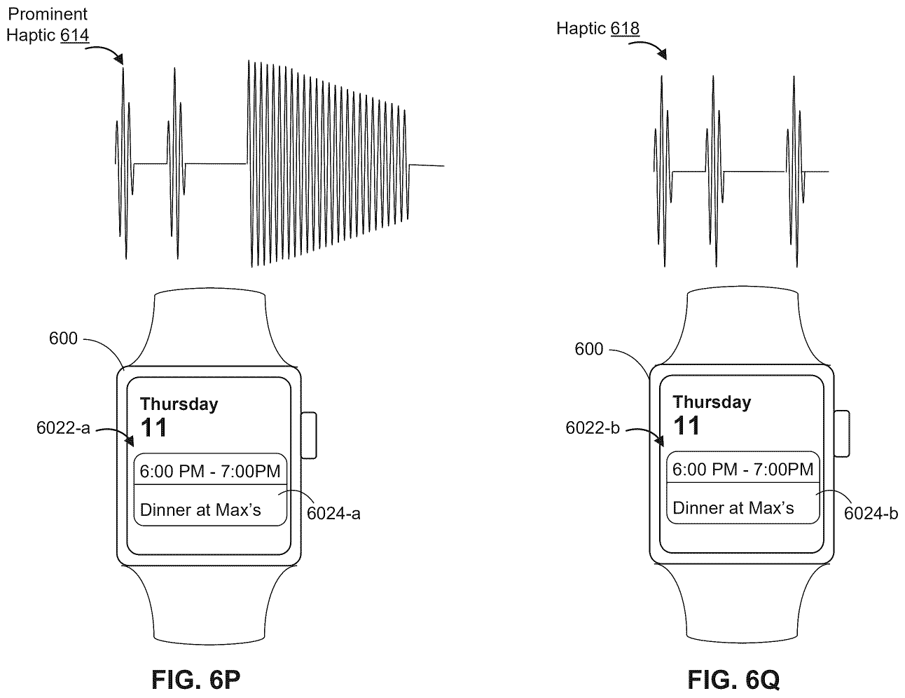

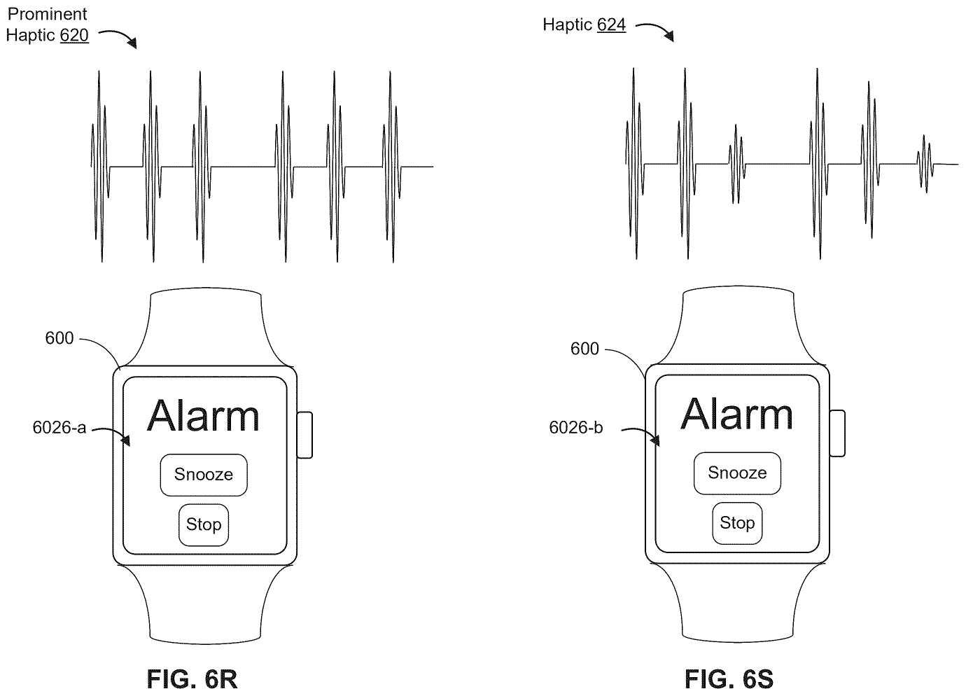

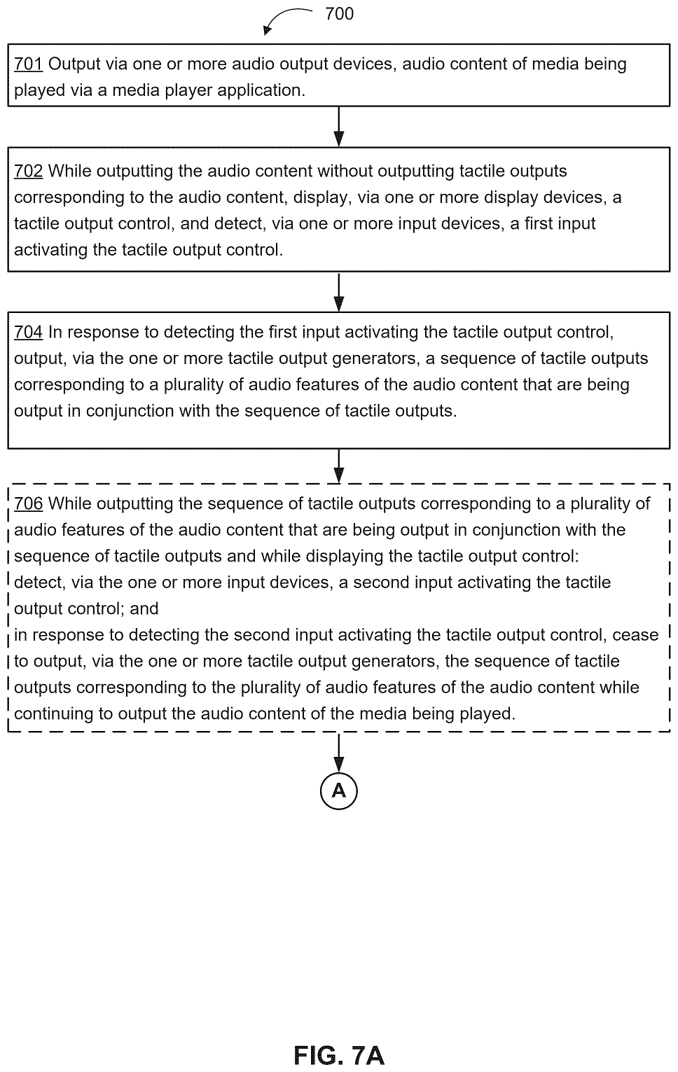

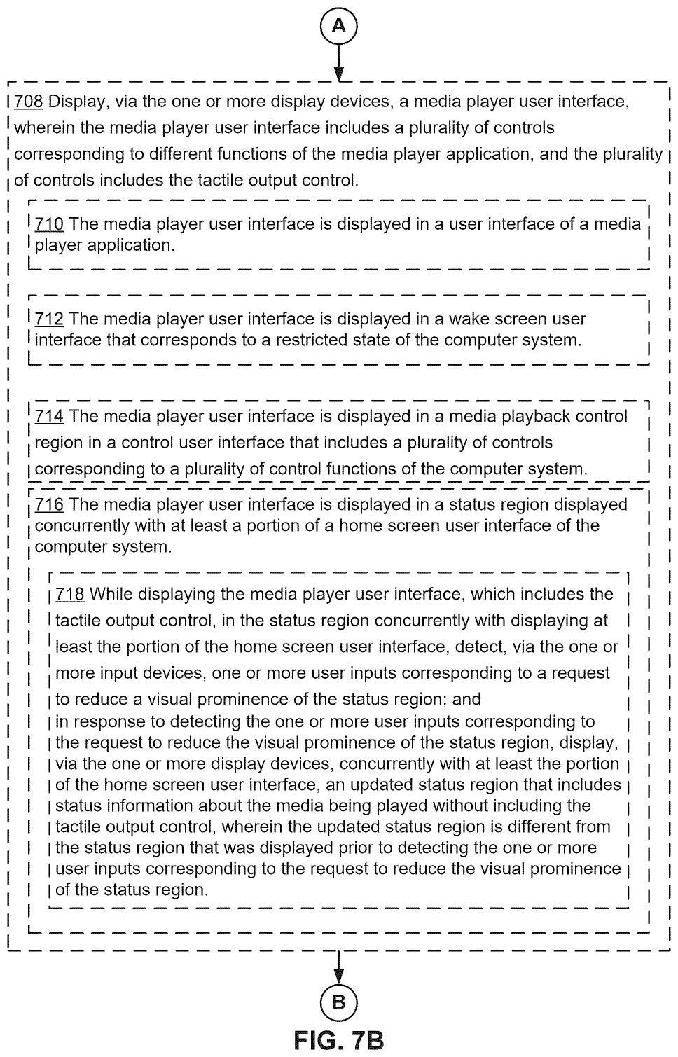

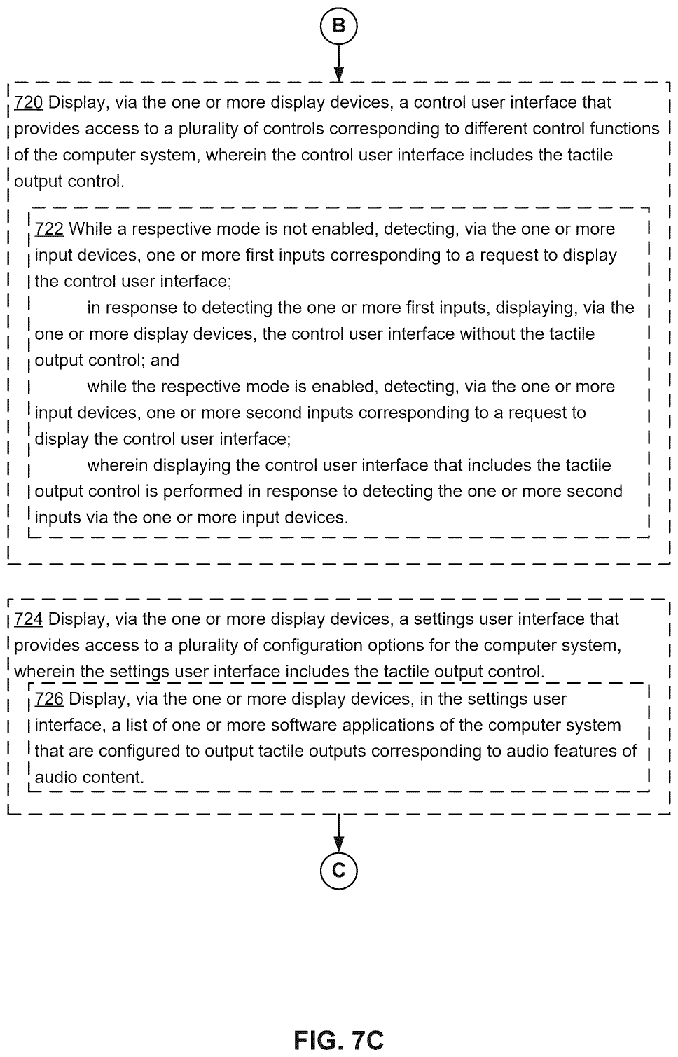

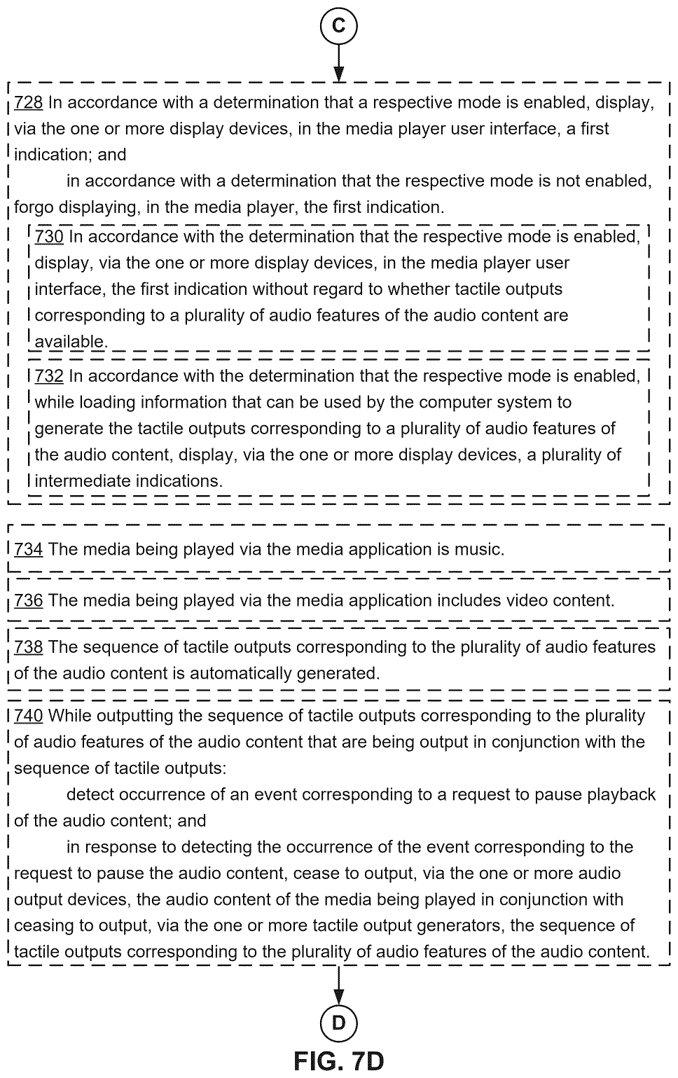

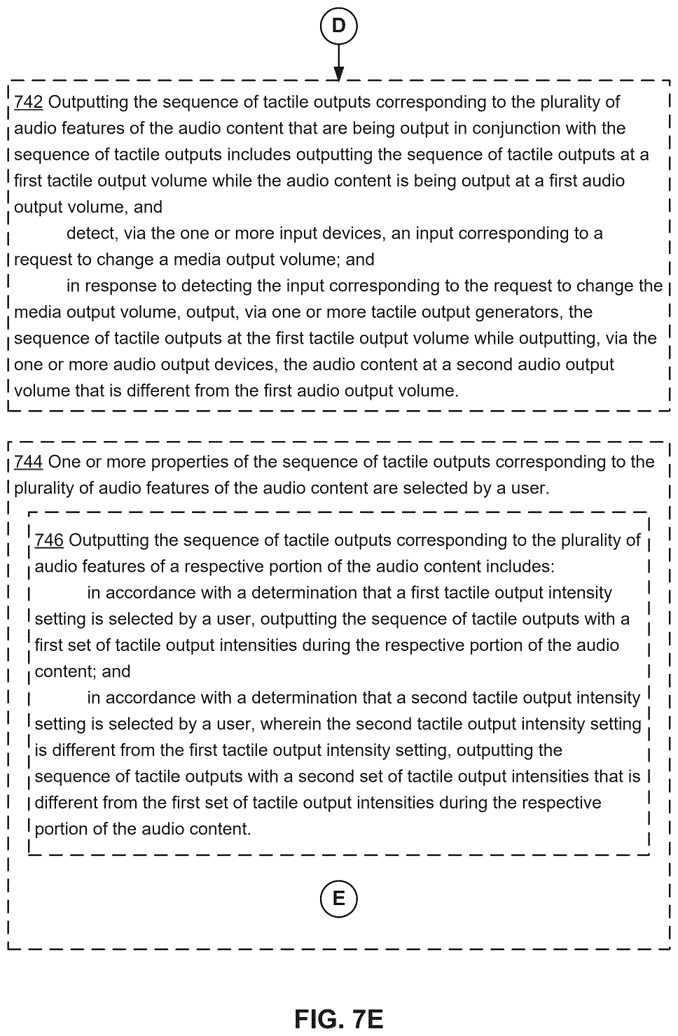

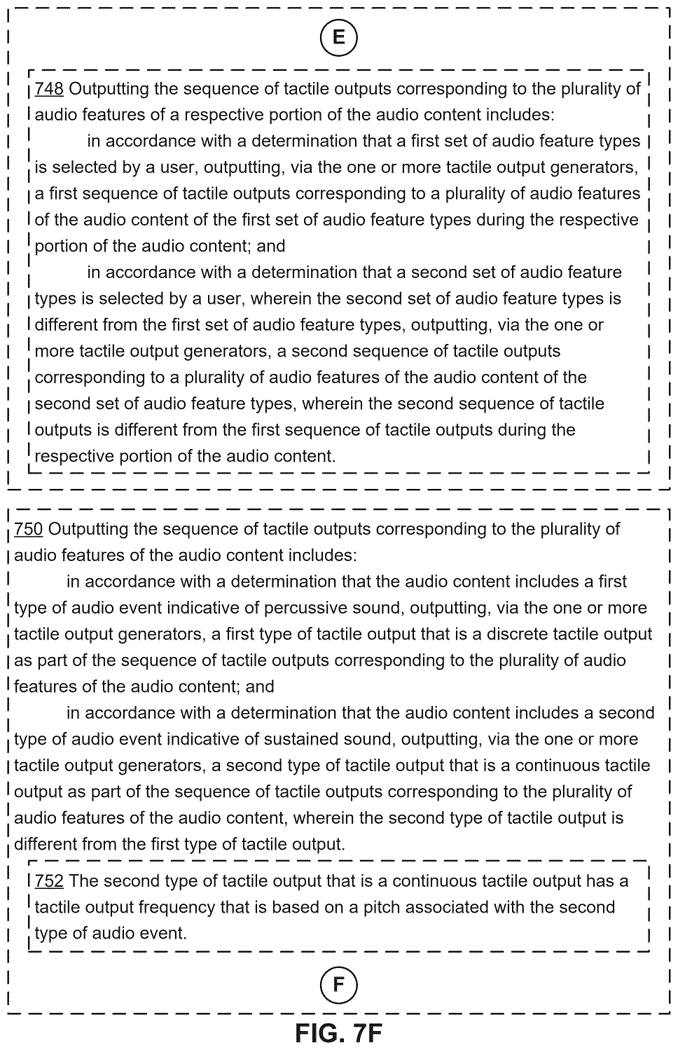

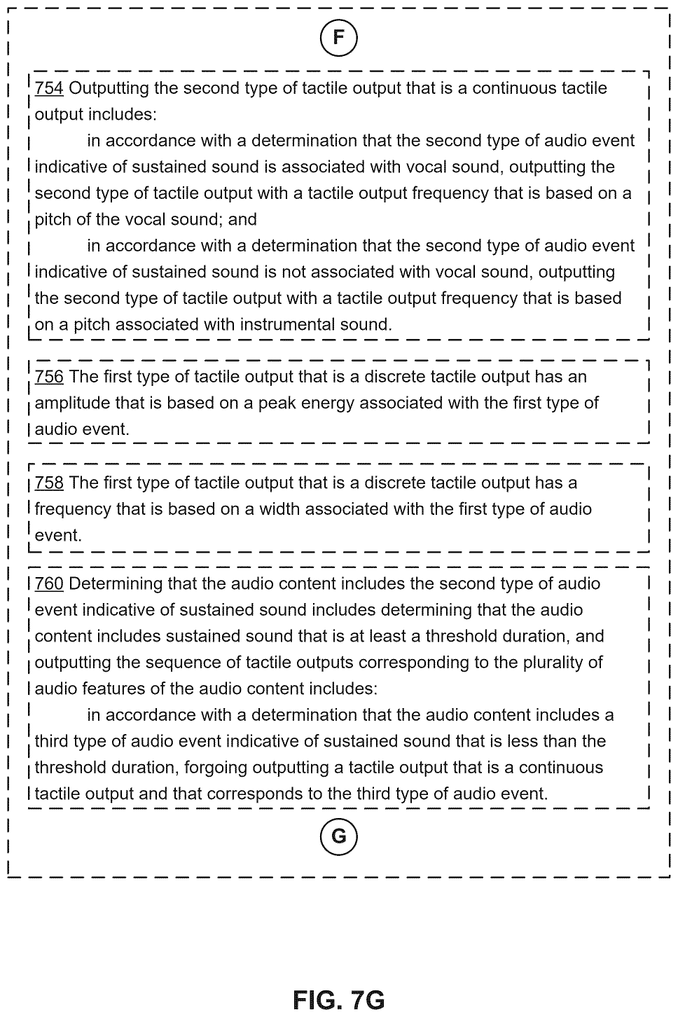

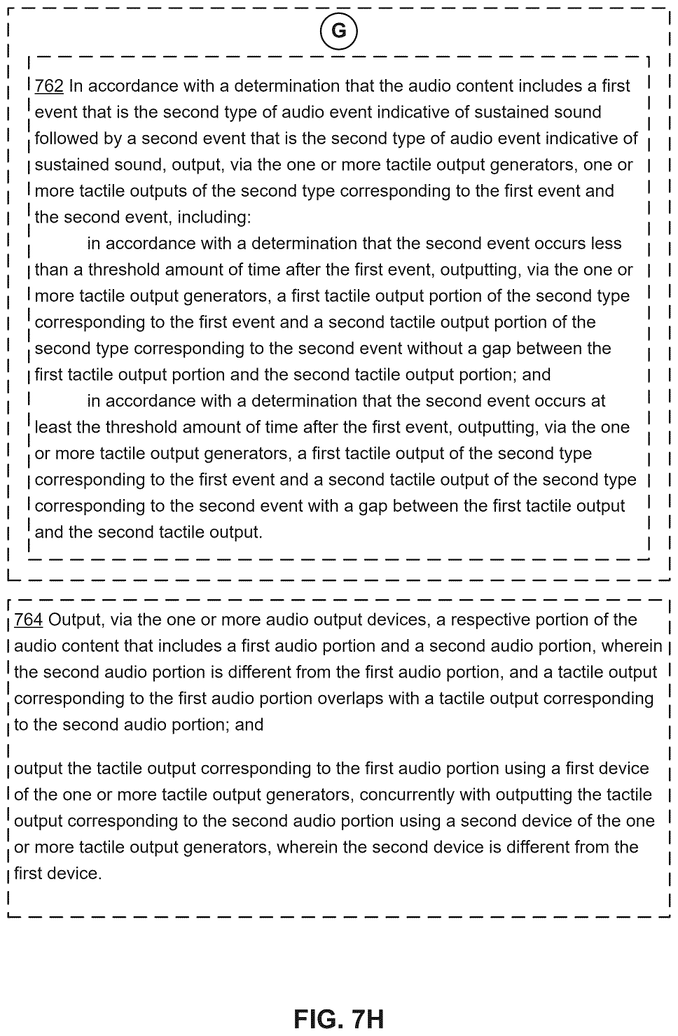

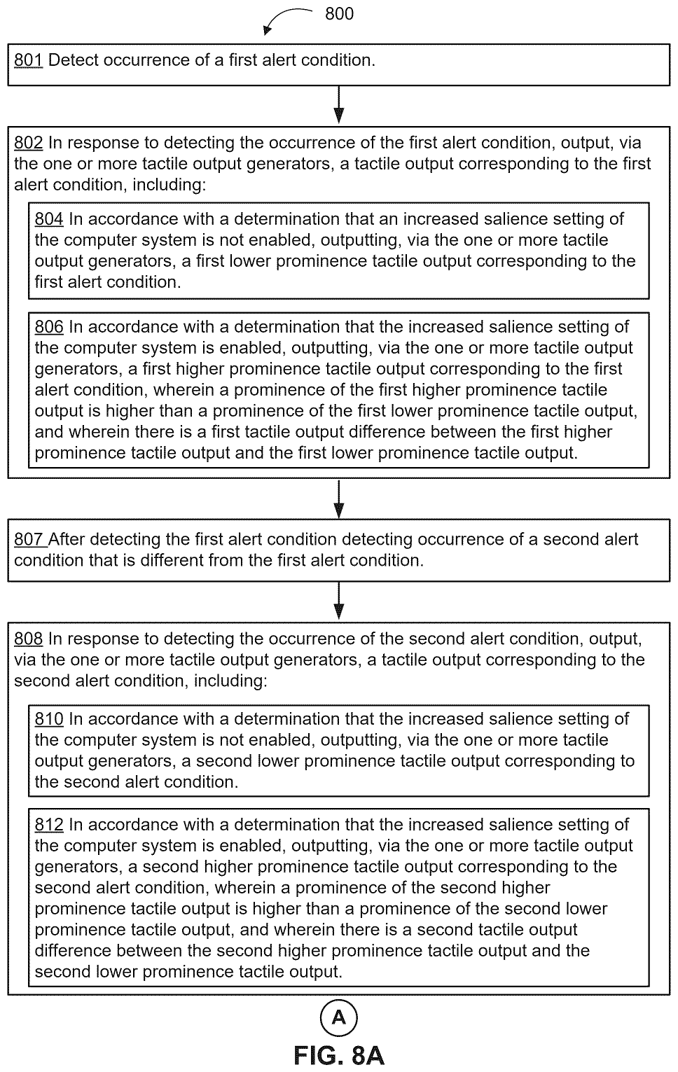

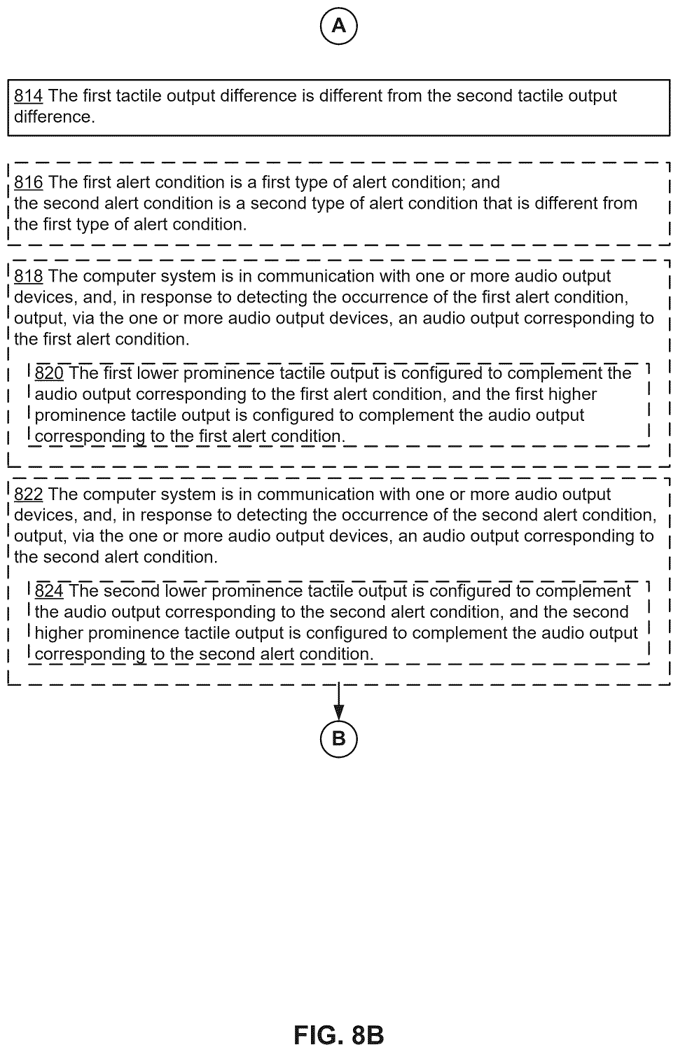

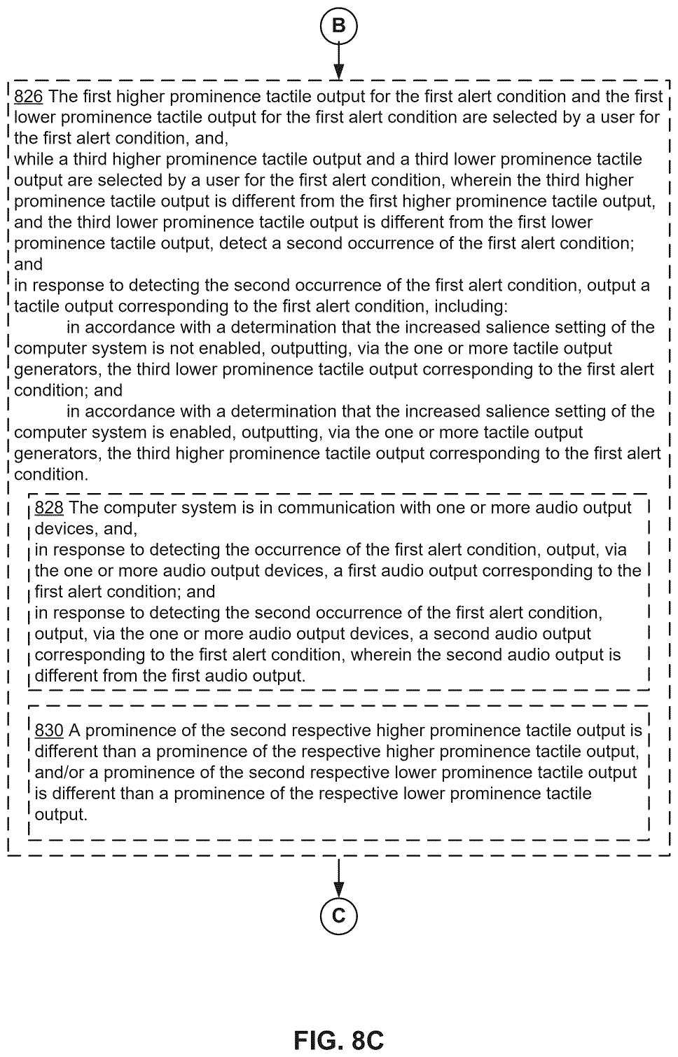

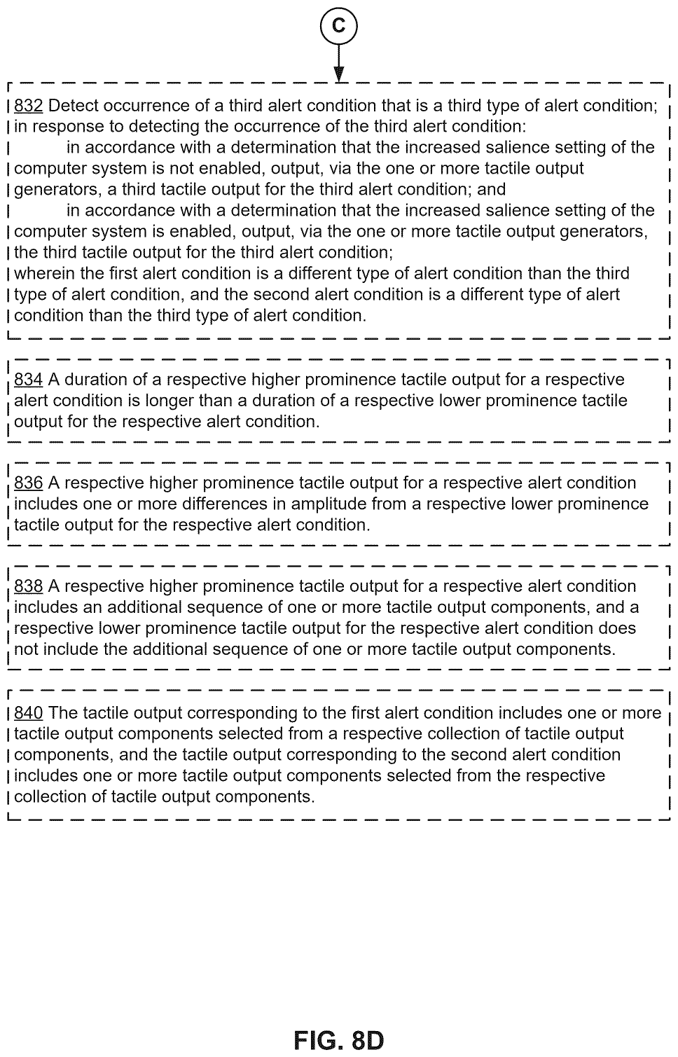

Below, FIGS. 1A-1C, 2, and 3A provide a description of example devices. FIGS. 3B-3G describe the use of Application Programming Interfaces (APIs) to perform operations. FIGS. 4C-4E illustrate examples of dynamic intensity thresholds. FIGS. 4A-4B and 5A-5O illustrate example user interfaces for outputting haptic feedback in conjunction with audio content. FIGS. 5P-5S illustrate example graphs for generating haptic outputs in accordance with some embodiments. FIGS. 6A-6G illustrate example patterns of haptic outputs. FIGS. 6H-6S illustrate example user interfaces for controlling and/or receiving haptic outputs in accordance with some embodiments. FIGS. 7A-7H illustrate flow diagrams of a process for outputting tactile outputs with audio content. FIGS. 8A-8D illustrate flow diagrams of a process for outputting tactile outputs for alert conditions. The user interfaces and/or graphs in FIGS. 5A-5S and FIGS. 6A-6S are used to illustrate the processes in FIGS. 7A-7G and FIGS. 8A-8D.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

FIGS. 4F-4H provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein. This example of a palette of tactile outputs shows how a set of three waveforms and eight frequencies can be used to produce an array of tactile output patterns. In addition to the tactile output patterns shown in this figure, each of these tactile output patterns is optionally adjusted in amplitude by changing a gain value for the tactile output pattern, as shown, for example for FullTap 80 Hz, FullTap 200 Hz, MiniTap 80 Hz, MiniTap 200 Hz, MicroTap 80 Hz, and MicroTap 200 Hz in FIGS. 4I-4K, which are each shown with variants having a gain of 1.0, 0.75, 0.5, and 0.25. As shown in FIGS. 4I-4K, changing the gain of a tactile output pattern changes the amplitude of the pattern without changing the frequency of the pattern or changing the shape of the waveform. In some embodiments, changing the frequency of a tactile output pattern also results in a lower amplitude as some tactile output generators are limited by how much force can be applied to the moveable mass and thus higher frequency movements of the mass are constrained to lower amplitudes to ensure that the acceleration needed to create the waveform does not require force outside of an operational force range of the tactile output generator (e.g., the peak amplitudes of the FullTap at 230 Hz, 270 Hz, and 300 Hz are lower than the amplitudes of the FullTap at 80 Hz, 100 Hz, 125 Hz, and 200 Hz).

FIGS. 4F-4K show tactile output patterns that have a particular waveform. The waveform of a tactile output pattern represents the pattern of physical displacements relative to a neutral position (e.g., xzero) versus time that a moveable mass goes through to generate a tactile output with that tactile output pattern. For example, a first set of tactile output patterns shown in FIG. 4F (e.g., tactile output patterns of a “FullTap”) each have a waveform that includes an oscillation with two complete cycles (e.g., an oscillation that starts and ends in a neutral position and crosses the neutral position three times). A second set of tactile output patterns shown in FIG. 4G (e.g., tactile output patterns of a “MiniTap”) each have a waveform that includes an oscillation that includes one complete cycle (e.g., an oscillation that starts and ends in a neutral position and crosses the neutral position one time). A third set of tactile output patterns shown in FIG. 4H (e.g., tactile output patterns of a “MicroTap”) each have a waveform that includes an oscillation that include one half of a complete cycle (e.g., an oscillation that starts and ends in a neutral position and does not cross the neutral position). The waveform of a tactile output pattern also includes a start buffer and an end buffer that represent the gradual speeding up and slowing down of the moveable mass at the start and at the end of the tactile output. The example waveforms shown in FIGS. 4F-4K include xmin and xmax values which represent the maximum and minimum extent of movement of the moveable mass. For larger electronic devices with larger moveable masses, there may be larger or smaller minimum and maximum extents of movement of the mass. The examples shown in FIGS. 4F-4K describe movement of a mass in 1 dimension, however similar principles would also apply to movement of a moveable mass in two or three dimensions.

As shown in FIGS. 4F-4H, each tactile output pattern also has a corresponding characteristic frequency that affects the “pitch” of a haptic sensation that is felt by a user from a tactile output with that characteristic frequency. For a continuous tactile output, the characteristic frequency represents the number of cycles that are completed within a given period of time (e.g., cycles per second) by the moveable mass of the tactile output generator. For a discrete tactile output, a discrete output signal (e.g., with 0.5, 1, or 2 cycles) is generated, and the characteristic frequency value specifies how fast the moveable mass needs to move to generate a tactile output with that characteristic frequency. As shown in FIGS. 4F-4H, for each type of tactile output (e.g., as defined by a respective waveform, such as FullTap, MiniTap, or MicroTap), a higher frequency value corresponds to faster movement(s) by the moveable mass, and hence, in general, a shorter time to complete the tactile output (e.g., including the time to complete the required number of cycle(s) for the discrete tactile output, plus a start and an end buffer time). For example, a FullTap with a characteristic frequency of 80 Hz takes longer to complete than FullTap with a characteristic frequency of 100 Hz (e.g., 35.4 ms vs. 28.3 ms in FIG. 4F). In addition, for a given frequency, a tactile output with more cycles in its waveform at a respective frequency takes longer to complete than a tactile output with fewer cycles its waveform at the same respective frequency. For example, a FullTap at 150 Hz takes longer to complete than a MiniTap at 150 Hz (e.g., 19.4 ms vs. 12.8 ms), and a MiniTap at 150 Hz takes longer to complete than a MicroTap at 150 Hz (e.g., 12.8 ms vs. 9.4 ms). However, for tactile output patterns with different frequencies this rule may not apply (e.g., tactile outputs with more cycles but a higher frequency may take a shorter amount of time to complete than tactile outputs with fewer cycles but a lower frequency, and vice versa). For example, at 300 Hz, a FullTap takes as long as a MiniTap (e.g., 9.9 ms).

As shown in FIGS. 4F-4H, a tactile output pattern also has a characteristic amplitude that affects the amount of energy that is contained in a tactile signal, or a “strength” of a haptic sensation that may be felt by a user through a tactile output with that characteristic amplitude. In some embodiments, the characteristic amplitude of a tactile output pattern refers to an absolute or normalized value that represents the maximum displacement of the moveable mass from a neutral position when generating the tactile output. In some embodiments, the characteristic amplitude of a tactile output pattern is adjustable, e.g., by a fixed or dynamically determined gain factor (e.g., a value between 0 and 1), in accordance with various conditions (e.g., customized based on user interface contexts and behaviors) and/or preconfigured metrics (e.g., input-based metrics, and/or user-interface-based metrics). In some embodiments, an input-based metric (e.g., an intensity-change metric or an input-speed metric) measures a characteristic of an input (e.g., a rate of change of a characteristic intensity of a contact in a press input or a rate of movement of the contact across a touch-sensitive surface) during the input that triggers generation of a tactile output. In some embodiments, a user-interface-based metric (e.g., a speed-across-boundary metric) measures a characteristic of a user interface element (e.g., a speed of movement of the element across a hidden or visible boundary in a user interface) during the user interface change that triggers generation of the tactile output. In some embodiments, the characteristic amplitude of a tactile output pattern may be modulated by an “envelope” and the peaks of adjacent cycles may have different amplitudes, where one of the waveforms shown above is further modified by multiplication by an envelope parameter that changes over time (e.g., from 0 to 1) to gradually adjust amplitude of portions of the tactile output over time as the tactile output is being generated.

Although specific frequencies, amplitudes, and waveforms are represented in the sample tactile output patterns in FIGS. 4F-4H for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

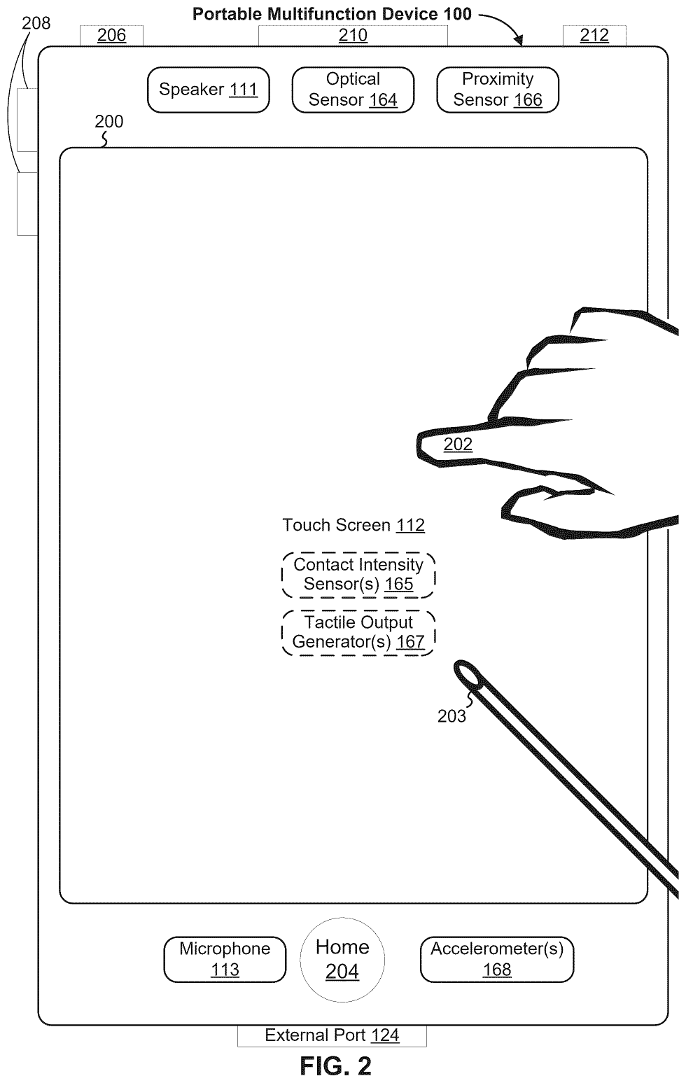

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management, and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 1C is a block diagram illustrating a tactile output module in accordance with some embodiments. In some embodiments, I/O subsystem 106 (e.g., haptic feedback controller 161 (FIG. 1A) and/or other input controller(s) 160 (FIG. 1A)) includes at least some of the example components shown in FIG. 1C. In some embodiments, peripherals interface 118 includes at least some of the example components shown in FIG. 1C.

In some embodiments, the tactile output module includes haptic feedback module 133. In some embodiments, haptic feedback module 133 aggregates and combines tactile outputs for user interface feedback from software applications on the electronic device (e.g., feedback that is responsive to user inputs that correspond to displayed user interfaces and alerts and other notifications that indicate the performance of operations or occurrence of events in user interfaces of the electronic device). Haptic feedback module 133 includes one or more of: waveform module 123 (for providing waveforms used for generating tactile outputs), mixer 125 (for mixing waveforms, such as waveforms in different channels), compressor 127 (for reducing or compressing a dynamic range of the waveforms), low-pass filter 129 (for filtering out high frequency signal components in the waveforms), and thermal controller 131 (for adjusting the waveforms in accordance with thermal conditions). In some embodiments, haptic feedback module 133 is included in haptic feedback controller 161 (FIG. 1A). In some embodiments, a separate unit of haptic feedback module 133 (or a separate implementation of haptic feedback module 133) is also included in an audio controller (e.g., audio circuitry 110, FIG. 1A) and used for generating audio signals. In some embodiments, a single haptic feedback module 133 is used for generating audio signals and generating waveforms for tactile outputs.

In some embodiments, haptic feedback module 133 also includes trigger module 121 (e.g., a software application, operating system, or other software module that determines a tactile output is to be generated and initiates the process for generating the corresponding tactile output). In some embodiments, trigger module 121 generates trigger signals for initiating generation of waveforms (e.g., by waveform module 123). For example, trigger module 121 generates trigger signals based on preset timing criteria. In some embodiments, trigger module 121 receives trigger signals from outside haptic feedback module 133 (e.g., in some embodiments, haptic feedback module 133 receives trigger signals from hardware input processing module 146 located outside haptic feedback module 133) and relays the trigger signals to other components within haptic feedback module 133 (e.g., waveform module 123) or software applications that trigger operations (e.g., with trigger module 121) based on activation of a user interface element (e.g., an application icon or an affordance within an application) or a hardware input device (e.g., a home button or an intensity-sensitive input surface, such as an intensity-sensitive touch screen). In some embodiments, trigger module 121 also receives tactile feedback generation instructions (e.g., from haptic feedback module 133, FIGS. 1A and 3A). In some embodiments, trigger module 121 generates trigger signals in response to haptic feedback module 133 (or trigger module 121 in haptic feedback module 133) receiving tactile feedback instructions (e.g., from haptic feedback module 133, FIGS. 1A and 3A).

Waveform module 123 receives trigger signals (e.g., from trigger module 121) as an input, and in response to receiving trigger signals, provides waveforms for generation of one or more tactile outputs (e.g., waveforms selected from a predefined set of waveforms designated for use by waveform module 123, such as the waveforms described in greater detail below with reference to FIGS. 4F-4G).

Mixer 125 receives waveforms (e.g., from waveform module 123) as an input, and mixes together the waveforms. For example, when mixer 125 receives two or more waveforms (e.g., a first waveform in a first channel and a second waveform that at least partially overlaps with the first waveform in a second channel) mixer 125 outputs a combined waveform that corresponds to a sum of the two or more waveforms. In some embodiments, mixer 125 also modifies one or more waveforms of the two or more waveforms to emphasize particular waveform(s) over the rest of the two or more waveforms (e.g., by increasing a scale of the particular waveform(s) and/or decreasing a scale of the rest of the waveforms). In some circumstances, mixer 125 selects one or more waveforms to remove from the combined waveform (e.g., the waveform from the oldest source is dropped when there are waveforms from more than three sources that have been requested to be output concurrently by tactile output generator 167).

Compressor 127 receives waveforms (e.g., a combined waveform from mixer 125) as an input, and modifies the waveforms. In some embodiments, compressor 127 reduces the waveforms (e.g., in accordance with physical specifications of tactile output generators 167 (FIG. 1A) or 357 (FIG. 3A)) so that tactile outputs corresponding to the waveforms are reduced. In some embodiments, compressor 127 limits the waveforms, such as by enforcing a predefined maximum amplitude for the waveforms. For example, compressor 127 reduces amplitudes of portions of waveforms that exceed a predefined amplitude threshold while maintaining amplitudes of portions of waveforms that do not exceed the predefined amplitude threshold. In some embodiments, compressor 127 reduces a dynamic range of the waveforms. In some embodiments, compressor 127 dynamically reduces the dynamic range of the waveforms so that the combined waveforms remain within performance specifications of the tactile output generator 167 (e.g., force and/or moveable mass displacement limits).

Low-pass filter 129 receives waveforms (e.g., compressed waveforms from compressor 127) as an input, and filters (e.g., smooths) the waveforms (e.g., removes or reduces high frequency signal components in the waveforms). For example, in some instances, compressor 127 includes, in compressed waveforms, extraneous signals (e.g., high frequency signal components) that interfere with the generation of tactile outputs and/or exceed performance specifications of tactile output generator 167 when the tactile outputs are generated in accordance with the compressed waveforms. Low-pass filter 129 reduces or removes such extraneous signals in the waveforms.

Thermal controller 131 receives waveforms (e.g., filtered waveforms from low-pass filter 129) as an input, and adjusts the waveforms in accordance with thermal conditions of device 100 (e.g., based on internal temperatures detected within device 100, such as the temperature of haptic feedback controller 161, and/or external temperatures detected by device 100). For example, in some cases, the output of haptic feedback controller 161 varies depending on the temperature (e.g. haptic feedback controller 161, in response to receiving same waveforms, generates a first tactile output when haptic feedback controller 161 is at a first temperature and generates a second tactile output when haptic feedback controller 161 is at a second temperature that is distinct from the first temperature). For example, the magnitude (or the amplitude) of the tactile outputs may vary depending on the temperature. To reduce the effect of the temperature variations, the waveforms are modified (e.g., an amplitude of the waveforms is increased or decreased based on the temperature).

In some embodiments, haptic feedback module 133 (e.g., trigger module 121) is coupled to hardware input processing module 146. In some embodiments, other input controller(s) 160 in FIG. 1A includes hardware input processing module 146. In some embodiments, hardware input processing module 146 receives inputs from hardware input device 145 (e.g., other input or control devices 116 in FIG. 1A, such as a home button or an intensity-sensitive input surface, such as an intensity-sensitive touch screen). In some embodiments, hardware input device 145 is any input device described herein, such as touch-sensitive display system 112 (FIG. 1A), keyboard/mouse 350 (FIG. 3A), touchpad 355 (FIG. 3A), one of other input or control devices 116 (FIG. 1A), or an intensity-sensitive home button. In some embodiments, hardware input device 145 consists of an intensity-sensitive home button, and not touch-sensitive display system 112 (FIG. 1A), keyboard/mouse 350 (FIG. 3A), or touchpad 355 (FIG. 3A). In some embodiments, in response to inputs from hardware input device 145 (e.g., an intensity-sensitive home button or a touch screen), hardware input processing module 146 provides one or more trigger signals to haptic feedback module 133 to indicate that a user input satisfying predefined input criteria, such as an input corresponding to a “click” of a home button (e.g., a “down click” or an “up click”), has been detected. In some embodiments, haptic feedback module 133 provides waveforms that correspond to the “click” of a home button in response to the input corresponding to the “click” of a home button, simulating a haptic feedback of pressing a physical home button.

In some embodiments, the tactile output module includes haptic feedback controller 161 (e.g., haptic feedback controller 161 in FIG. 1A), which controls the generation of tactile outputs. In some embodiments, haptic feedback controller 161 is coupled to a plurality of tactile output generators, and selects one or more tactile output generators of the plurality of tactile output generators and sends waveforms to the selected one or more tactile output generators for generating tactile outputs. In some embodiments, haptic feedback controller 161 coordinates tactile output requests that correspond to activation of hardware input device 145 and tactile output requests that correspond to software events (e.g., tactile output requests from haptic feedback module 133) and modifies one or more waveforms of the two or more waveforms to emphasize particular waveform(s) over the rest of the two or more waveforms (e.g., by increasing a scale of the particular waveform(s) and/or decreasing a scale of the rest of the waveforms, such as to prioritize tactile outputs that correspond to activations of hardware input device 145 over tactile outputs that correspond to software events).

In some embodiments, as shown in FIG. 1C, an output of haptic feedback controller 161 is coupled to audio circuitry of device 100 (e.g., audio circuitry 110, FIG. 1A), and provides audio signals to audio circuitry of device 100. In some embodiments, haptic feedback controller 161 provides both waveforms used for generating tactile outputs and audio signals used for providing audio outputs in conjunction with generation of the tactile outputs. In some embodiments, haptic feedback controller 161 modifies audio signals and/or waveforms (used for generating tactile outputs) so that the audio outputs and the tactile outputs are synchronized (e.g., by delaying the audio signals and/or waveforms). In some embodiments, haptic feedback controller 161 includes a digital-to-analog converter used for converting digital waveforms into analog signals, which are received by amplifier 163 and/or tactile output generator 167.

In some embodiments, the tactile output module includes amplifier 163. In some embodiments, amplifier 163 receives waveforms (e.g., from haptic feedback controller 161) and amplifies the waveforms prior to sending the amplified waveforms to tactile output generator 167 (e.g., any of tactile output generators 167 (FIG. 1A) or 357 (FIG. 3A)). For example, amplifier 163 amplifies the received waveforms to signal levels that are in accordance with physical specifications of tactile output generator 167 (e.g., to a voltage and/or a current required by tactile output generator 167 for generating tactile outputs so that the signals sent to tactile output generator 167 produce tactile outputs that correspond to the waveforms received from haptic feedback controller 161) and sends the amplified waveforms to tactile output generator 167. In response, tactile output generator 167 generates tactile outputs (e.g., by shifting a moveable mass back and forth in one or more dimensions relative to a neutral position of the moveable mass).

In some embodiments, the tactile output module includes sensor 169, which is coupled to tactile output generator 167. Sensor 169 detects states or state changes (e.g., mechanical position, physical displacement, and/or movement) of tactile output generator 167 or one or more components of tactile output generator 167 (e.g., one or more moving parts, such as a membrane, used to generate tactile outputs). In some embodiments, sensor 169 is a magnetic field sensor (e.g., a Hall effect sensor) or other displacement and/or movement sensor. In some embodiments, sensor 169 provides information (e.g., a position, a displacement, and/or a movement of one or more parts in tactile output generator 167) to haptic feedback controller 161 and, in accordance with the information provided by sensor 169 about the state of tactile output generator 167, haptic feedback controller 161 adjusts the waveforms output from haptic feedback controller 161 (e.g., waveforms sent to tactile output generator 167, optionally via amplifier 163).

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIGS. 7A-7H) and/or method 800 (FIGS. 8A-8D) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”;
   Icon 446 for a settings application or module, which provides access to
   settings for device 100 and its various applications 136;
   Widget 448 for displaying information from a weather application; and
   Widget 452 for displaying information from a photos application.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Although only specific frequencies, amplitudes, and waveforms are represented in the sample tactile output patterns in FIGS. 4F-4K for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well.

### User Interfaces and Associated Processes

Attention is now directed towards embodiments of user interfaces (“UI”) and associated processes that may be implemented on an electronic device (or computer system more generally), such as portable multifunction device 100 or device 300, with one or more display devices such as a display, one or more input devices such as a touch-sensitive surface, one or more tactile output generators for generating tactile outputs, and (optionally) one or more one or more audio output devices for outputting audio content.

FIGS. 5A-5O illustrate example user interfaces for outputting haptic feedback in conjunction with media in accordance with some embodiments. FIGS. 5P-5S illustrate example graphs for generating haptic outputs in accordance with some embodiments. FIGS. 6A-6G illustrate example patterns of haptic outputs in accordance with some embodiments. FIGS. 6H-6S illustrate example user interfaces for controlling and/or receiving haptic outputs in accordance with some embodiments. The user interfaces in these figures are used to illustrate the processes described below, including the processes in FIGS. 7A-7H and 8A-8D. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) posed, changing pose, and/or moving in physical space while a location or object is targeted, such as when the location of the hand(s) and/or finger(s) are on or near the object or the location or while a focus selector is on the location or object.

FIGS. 5A-5O illustrate example user interfaces for outputting haptic feedback in conjunction with media in accordance with some embodiments. FIG. 5A illustrates a user interface 500-a, such as a home screen user interface. In some embodiments, a music session (e.g., and/or other media playback session) is active at the device 100. In some embodiments, a representation of the active music session is displayed in a session region 502-a, including an indication of the currently playing music, such as an album cover (e.g., cover art for the currently playing Album “A”) and optionally animated sound bars representing the currently playing music. In some embodiments, the session region 502-a is expanded (e.g., increases in size) (e.g., in response to a tap user input directed to the session region 502-a) to include one or more control options (e.g., play/pause, skip, and/or other control options) and/or to include additional information for the active music session, while maintaining display of the home screen user interface 500-a. In some embodiments, the expanded version of the session region 502-a includes a control (e.g., corresponding to icon 516-b (FIG. 5C) and/or control 524-a (FIG. 5D), described below) for activating and/or deactivating (e.g., turning on or off) a music haptics setting (e.g., and/or for pausing or unpausing the music haptics). In some embodiments, the session region 502-a is persistent such that, while displaying other user interfaces (e.g., a wake screen user interface, a control user interface, and/or other application user interfaces (other than a music application user interface, in accordance with some embodiments)), the session region 502-a continues to display information about the active playback session and is expandable such that the user can easily access the one or more control options from a plurality of user interfaces.

In some embodiments, the device 100 detects a user input 504 that corresponds to a swipe gesture that is initiated from and/or near a respective edge of the device 100 (e.g., more specifically, the touchscreen 112 of the device 100). For example, in FIG. 5A, the user input 504 is initiated in a middle portion of the device 100 and/or along the top edge of the device 100.

In some embodiments, in response to the user input 504, a user interface 500-b, such as a cover sheet user interface and/or a wake screen user interface, is displayed at the device 100, as illustrated in FIG. 5B. In some embodiments, the user interface 500-b includes a platter 512 that displays information about the active music session (e.g., more information about the active music session than was displayed in the session region 502-b), and optionally the device 100 ceases display of the representation of the active music session in the session region 502-b while the platter 512 is displayed. In some embodiments, the platter 512 includes an indication of the currently playing music, such as an album cover, text representing a name of the currently playing song, and/or text representing an artist of the currently playing song. In some embodiments, the platter 512 includes one or more user-selectable control options for controlling the music session, including a favorite control 514-a, a skip backward control 514-b, a pause and/or play control 514-c, a skip forward control 514-d, and/or a playback device control 514-e. For example, in response to a user input selecting the favorite control 514-a, the currently playing song (e.g., Song A) is added to a favorites playlist or otherwise marked (e.g., starred) as a preferential song for the user of the device 100. In some embodiments, in response to a user input selecting the skip backward control 514-b, such as a user input 508 (e.g., a tap input or other selection input), the device 100 skips to a previously played song (e.g., the song that was played prior to playback of Song A) or restarts the currently playing song (e.g., Song A) from the beginning. In some embodiments, in response to a user input selecting the pause and/or play control 514-c, the device 100 pauses the currently playing song and the control 514-c is updated from the pause control to the play control such that, in response to user selection of the play control 514-c, the device 100 resumes playback of the currently playing song. In some embodiments, in response to a user input selecting the skip forward control 514-d, the device 100 skips to a next song. In some embodiments, in response to a user input (e.g., user input 510, such as a tap input or other selection input) selecting the playback device control 514-e, the device 100 displays one or more options of available devices (e.g., speakers, headphones, and/or other devices) at which the music session can be played back.

In some embodiments, the platter 512 includes animated sound bars 516-a representing the currently playing music, where the sound bars 516-a are animated in accordance with the audio of the currently playing music. In some embodiments, the sound bars 516-a are displayed while a music haptics setting of the device 100 is turned off. For example, while the music haptics setting of the device 100 is turned off, the sound bars 516-a are displayed in the platter 512, and while the music haptics setting of the device 100 is turned on, a music haptics icon 516-b (FIG. 5C) is displayed in the platter 512, optionally without displaying the sound bars 516-a. In some embodiments, while the music haptics setting of the device 100 is turned on, the device 100 generates and/or outputs one or more haptics 520-a (e.g., corresponding to audio features of the currently playing music). In some embodiments, the one or more haptics 520-a correspond to the audio of the current music session. For example, as described with reference to FIGS. 5P-5S, haptics are determined (e.g., optionally by a server separate from device 100) for a respective song based on vocals, instrumentals (e.g., including percussive or other beats) and/or other properties of the respective song, and the haptics are output by the device 100 during playback of the respective song while the music haptics setting is turned on.

It will be understood that although the examples used herein for the music haptics setting illustrate music playing back as the media content that is presented in conjunction with haptic outputs, in some embodiments, the media content is another type of media content, such as video content, that optionally includes an audio portion.

In some embodiments, in response to a user input 506 (e.g., a tap input, a tap and hold input, or other selection input) directed to the sound bars 516-a, the device 100 turns on the music haptics setting and/or the platter 512 is updated to display the music haptics icon 516-b and/or the haptics button 518, as illustrated in FIG. 5C.

In some embodiments, in response to a user input 521 (e.g., in FIG. 5B), such as a swipe input that is initiated in a top right corner of the device 100, the device 100 displays a user interface 500-c, as illustrated in FIG. 5D. In some embodiments, the user interface 500-c is a control user interface that includes one or more control options for the device 100. For example, the one or more control options for the device 100 optionally include controls to toggle connectivity settings (e.g., Wi-Fi, airplane mode, cellular connection, Bluetooth connection, and/or other connectivity settings), controls to lock an orientation of the device 100, a control to turn a flashlight of the device on and/or off, controls to change a brightness and/or volume of the device, and/or controls to quickly access one or more applications, such as a camera application, a timer application and/or a calculator application. It will be understood that alternative and/or additional controls may be included in the control user interface 500-c. In some embodiments, the control user interface 500-c optionally includes a control 524-a to toggle a music haptics setting on and off. For example, while the music haptics setting is off, the control 524-a includes a music haptics icon that is struck through and/or otherwise visually deemphasized (e.g., dimmed, greyed out, and/or otherwise displayed with less prominence relative to one or more other controls that are on and/or active) as compared to while the music haptics setting is on, and the control 524-b is displayed without the strikethrough and/or is otherwise visually emphasized to indicate that the music haptics setting is on.

In some embodiments, in response to a user input 526 selecting the control 524-a, the device 100 turns on the music haptics setting, such that the one or more haptics 520-b corresponding to the current audio output of the music session are output by the device 100, as illustrated in FIG. 5E. In some embodiments, the control 524-a is updated to the control 524-b to include the music haptics icon without the visual deemphasis (e.g., without strikethrough, and/or without being dimmed, greyed out and/or otherwise displayed with less prominence). In some embodiments, the control 524-b is automatically added to the control user interface 500-c in response to a user input turning on the music haptics setting in a settings user interface (e.g., as described below with reference to FIGS. 5L-5M).

As illustrated in FIG. 5E, in some embodiments, the session region 502-c is updated to indicate the music haptics setting is turned on (e.g., as compared to the session region 502-a in FIG. 5D that includes the animated sound bars while the music haptics setting is turned off). In some embodiments, the session region 502-c includes the indication that the music haptics setting is turned on, and optionally, displays the indication with a first set of visual properties in accordance with a determination that the music haptics setting is turned on and active (e.g., not paused), and displays the indication with a second set of visual properties (e.g., displayed as greyed out, with decreased luminance, and/or with other visual deemphasis) in accordance with a determination that the music haptics setting is turned on and inactive (e.g., paused).

In some embodiments, the device 100 detects a user input 522 (e.g., a tap input, a tap and hold input, or other selection input) directed to a now playing control region of the control user interface 500-c. In some embodiments, the control 524-a is optionally displayed within the now playing control region of the control user interface 500-c (e.g., instead of or in addition to being displayed as a separate control, as illustrated in FIG. 5D). In some embodiments, the now playing control region includes one or more controls for controlling the current music session (e.g., controls to skip forward and/or backward and a play and/or pause control).

In some embodiments, in response to the user input 522, a now playing user interface 500-d is displayed, as illustrated in FIG. 5F. In some embodiments, the now playing user interface 500-d includes a platter 538 that optionally includes one or more of the controls displayed in the platter 512 (FIG. 5B). For example, the platter 538 includes a favorite control 514-a, a skip backward control 514-b, a pause and/or play control 514-c, a skip forward control 514-d, and/or a playback device control 514-e. In some embodiments, the platter 538 includes a volume control 514-f, such that, in response to detecting a user input 536, such as a drag user input, the volume of the playback device is updated in accordance with the user input 536 (e.g., a drag input to the left decreases the volume and a drag input to the right increases the volume). In some embodiments, the now playing user interface 500-d includes an option 534 for controlling music sessions at other devices different from the device 100 (e.g., speakers, headphones, and/or other external devices).

In some embodiments, in response to detecting a user input 530 directed to the music haptics icon 516-b in the platter 538, the device 100 toggles the music haptics setting between active and paused (e.g., inactive or otherwise ceased output of the haptics). For example, the user input 530 directed to the music haptics icon 516-b (e.g., representing that the music haptics setting is in the active state) to pause the haptics 520-c causes the device 100 to cease outputting the haptics 520-c, and while the music haptics setting is paused, another user input directed to the music haptics icon 516-c (e.g., representing that the music haptics setting is in the paused state) causes the device 100 to resume outputting the haptics 520-c by reinstating the active state of the music haptics setting. In some embodiments, the haptics 520-c that are output by the device 100 correspond to the audio that is playing back at the time the haptics 520-c are output. For example, the haptics 520-a that are output 35 seconds into Song A (FIG. 5C) correspond to the audio of Song A at 35 seconds, while the haptics 520-c that are output 45 seconds into Song A (FIG. 5F) correspond to the audio of Song A at 45 seconds. As such, toggling the music haptics setting between the paused state and the active state causes the haptics to cease to play while continuing playback of the audio of currently playing Song A (e.g., and optionally removes the music haptics icon 516-b from the platter 512 such that the music haptics setting can only be turned on via the control user interface 500-c and/or the settings user interface 500-f) while the setting is set to the paused state, and to be resumed (e.g., to output the haptics that correspond to the current timestamp of the playing song) in response to turning the setting to the active state.

In some embodiments, in response to a user input 532 that is outside the platter 538 and not directed to the option 534, the now playing user interface 500-d is dismissed and the device 100 redisplays the control user interface 500-c, as illustrated in FIG. 5E, or displays another user interface, such as a home screen user interface 500-a as illustrated in FIG. 5G.

FIG. 5E further illustrates a user input 528 corresponding to a request to dismiss control user interface 500-c. In some embodiments, in response to the user input 528, the device 100 displays the home screen user interface 500-a, as illustrated in FIG. 5G. In some embodiments, the device 100 continues to output the haptics 520-d (FIG. 5G) while the music haptics setting is on. In some embodiments, in response to a user input 542 (FIG. 5G) corresponding to a request to display a cover sheet and/or a wake screen user interface (e.g., the user input 542 is analogous to the user input 504 (FIG. 5A)), the user interface 500-b is displayed, as illustrated in FIG. 5H (e.g., which is analogous to FIG. 5C). In some embodiments, in response to detecting a user input 540 directed to a power button of the device 100 (e.g., a button press or other activation input), the display of the device 100 turns off (e.g., is dimmed or otherwise put into a sleep state), and upon waking the device 100 after the display of the device 100 has turned off, the user interface 500-b is displayed (e.g., a wake screen user interface is displayed upon waking the device 100), as illustrated in FIG. 5H (e.g., the user input 540 and the user input 542 represent alternative ways of transitioning to the user interface 500-b from another user interface).

FIG. 5H illustrates detecting one or more inputs directed to the controls 514 displayed in the platter 512. For example, in response to detecting the user input 548 directed to the favorite control 514-a, Song A is added to a favorites list of the user of device 100. In another example, in response to detecting the user input 550 directed to the pause control 514-c, playback of Song A is paused, including pausing playback of the audio and haptics for Song A.

In some embodiments, in response to a user input 546 directed to the platter 512 outside of the controls 514 (e.g., controls 514-a through 514-e) displayed in the platter 512, the device 100 displays a music application user interface 500-e, as illustrated in FIG. 5I. In some embodiments, the music application user interface 500-e includes the controls 514 that are available in the platter 512 (FIG. 5H) and/or in the platter 538 (FIG. 5F) and optionally additional controls (e.g., volume controls and/or other controls).

In some embodiments, in response to a user input 544, such as a tap input or other selection input, directed to the music haptics icon 516-b, the haptics 520-e cease to be output by the device 100 (e.g., the haptics 520-e are paused). In some embodiments, while the haptics 520-e are paused, the music haptics icon 516-c is visually deemphasized (e.g., greyed out, dimmed, faded, or otherwise displayed with less prominence relative to the music haptics icon 516-b while the music haptics 520-e are not paused). For example, in FIG. 5I, the music haptics icon 516-c is displayed as dashed while the music haptics are paused (e.g., FIG. 5I illustrates a transition from FIG. 5H in response to detecting the user input 546 to transition to the music application user interface 500-e after detecting the user input 544 to pause the haptics 520-e). Similarly, in FIG. 5J, the music haptics icon 516-c is displayed as dashed while the music haptics are paused, and in response to detecting a user input 552 directed to the music haptics icon 516-c, the haptics 520-f are resumed, as illustrated in FIG. 5K (e.g., the haptics 520-f are resumed at 50 seconds into Song A consistent with the user input 552 being detected at 50 seconds into Song A in FIG. 5J, and correspond in FIG. 5K to the audio of Song A at 52 seconds). In some embodiments, while the haptics 520-e are paused (e.g., whether in conjunction with pausing playback of Song A in response to the user input 550 directed to the pause control 514-c or separately from playback of Song A in response to the user input 544 directed to the music haptics icon 516-b (e.g., while playback of Song A continues)), the haptics 520-e remain loaded or otherwise available at device 100 in order to reduce a lag if the user turns the haptics 520-e back the active state (e.g., resumes or un-pauses the haptics, for example as haptics 520-f (e.g., optionally together with resuming the playback of Song A, if also paused).

FIG. 5K illustrates detecting a user input 554, such as a tap input or other selection input, directed to the haptics button 518. In some embodiments, in response to the user input 554 directed to the haptics button 518, a settings user interface 500-f is displayed, as illustrated in FIG. 5L. In FIG. 5L, playback of the audio of Song A continues and haptics 520-g are output with the audio of Song A while the music haptics setting is set to the active state (e.g., on).

In some embodiments, the settings user interface 500-f provides control options for enabling and/or disabling haptics for one or more applications. In some embodiments, music haptics are controlled at a global level (e.g., via the music haptics setting being turned on and/or off using toggle 556) and/or at an application level (e.g., via music haptics toggles 570, 572, and 574 for respective applications), via the settings user interface 500-f. In some embodiments, the user selects and/or deselects whether to turn on and/or off music haptics for individual applications (e.g., for which music haptics are available). For example, in FIG. 5L, music haptics is turned off for application C 568 via toggle 574 such that, even while the music haptics setting is turned on for the device 100 (e.g., globally for device 100 via toggle 556, via icon 516-b (FIG. 5C) and/or via control 524 (FIG. 5D)) (e.g., in some embodiments, toggle 556, icon 516-b and/or control 524 each control the music haptics setting as set to on and/or off, where optionally, toggling the music haptics setting (e.g., to on or off) via one of the aforementioned controls automatically causes the state of the other controls to be updated to reflect the toggled state of the music haptics setting (e.g., to on or off, respectively)), haptics would not be output concurrently with audio that is output via application C, whereas for music application 564 and application B 566 (e.g., where the music haptics is turned on for each respective application, such as via toggle 570 for music application 564 and via toggle 572 for application B 566), haptics are output, when available, concurrently with audio that is output via music application 564 and concurrently with audio that is output via application B 566 (e.g., unless the music haptics setting is turned off for all applications via toggle 556, via icon 516-b (FIG. 5C) and/or via control 524 (FIG. 5D)). In response to detecting a user input 576 directed to the toggle 574 for application C 568, the music haptics setting for application C 568 is turned from off to on.

In some embodiments, in response to detecting a user input 558 directed to music haptics toggle 556-a in the settings user interface 500-f, the music haptics setting is toggled to off, as illustrated in FIG. 5M, and the settings user interface 500-f is updated to remove the additional control options related to the music haptics setting. In some embodiments, in response to detecting the user input 578 directed to the music haptics toggle 556-b, the music haptics setting is toggled back on, and the settings user interface 500-f illustrated in FIG. 5L is redisplayed. In some embodiments, in response to detecting the user input 558 corresponding to a request to turn off the haptics setting via the settings user interface 500-f (FIGS. 5L-5M), the haptics setting is turned off (e.g., rather than paused). For example, while the haptics setting is turned off, the music haptics icon 516-b is optionally not displayed in the platter 512 (FIG. 5C) and/or the platter 538 (FIG. 5F) (e.g., the icon 516-a that includes the sound bars is displayed without displaying the music haptics icon) and/or the control 524-a is optionally not displayed in the control user interface 500-c (FIG. 5D) (e.g., in contrast to the music haptics icon 516-b continuing to be displayed, with one or more distinct visual properties (e.g., as illustrated by the music haptics icon 516-c) while the music haptics setting is paused rather than turned off). As such, the device 100 displays a different visual indication based on whether the music haptics setting is turned on, turned on but paused, or turned off. In some embodiments, the control 524-a is automatically added to the control user interface 500-c in response to the user input 578 toggling the music haptics setting on (e.g., and optionally in accordance with a determination that a respective mode, such as an accessibility mode that includes one or more settings to improve the accessibility of the device to users with visual or motor difficulties or other accessibility needs, is enabled). In some embodiments, the control 524-a (FIG. 5D) continues to be displayed in the control user interface 500-c (FIG. 5D) without regard to whether the music haptics setting is turned on or off. As such, the control 524-a controls turning the music haptics setting on and/or off in the same manner that toggle 556-a controls the music haptics setting. For example, the control 524-a is synchronized in status with the status of the toggle 556-a.

In some embodiments, the music haptics icon 516-b and/or 516-c is displayed in the platter 512 even after detecting a user input to control the music haptics setting via the control 524-a and/or the settings user interface 500-f via toggle 556-a. For example, in some embodiments, the music haptics icon 516-b is displayed in the platter 512 while the music haptics setting is set to on and the music haptics icon 516-c is displayed in the platter 512 while the music haptics setting is set to off (e.g., there is no functional difference between the music haptics setting being paused via the platter 512 and the music haptics setting being turned off via control 524-a or toggle 556-a).

In some embodiments, the settings user interface 500-f (FIG. 5L) includes an option 560 to play a sample of haptics accompanying audio output by the device 100. For example, in response to detecting the user input 562 directed to the option 560, the device 100 outputs a sample (e.g., a 10-second, 30-second, 1-minute, or another length sample) audio with accompanying haptics.

In some embodiments, in response to a user input 580 directed to the power button of the device 100, the display 112 of the device 100 turns off (e.g., is dimmed or otherwise put into a sleep state).

In some embodiments, the settings user interface 500-f (e.g., and/or the control user interface 500-c) further includes one or more options for changing one or more properties of the haptic outputs. For example, the settings user interface 500-f (e.g., and/or the control user interface 500-c) displays an option for assigning the haptic outputs to a respective type of audio, such as assigning the haptic outputs to correspond to (e.g., complement or otherwise be generated based on) a percussive signal of the audio, a vocal signal of the audio and/or an instrumental signal of the audio. In some embodiments, the settings user interface 500-f (e.g., and/or the control user interface 500-c) displays an option for changing an intensity of the haptic output (e.g., to increase and/or decrease an amplitude of the haptic outputs). For example, the haptic outputs are optionally generated and/or output without regard to a current volume of the device 100, such that the intensity of the haptic outputs are controlled independently from the volume.

FIG. 5N illustrates display of the user interface 500-b that is displayed upon waking the device 100 (e.g., the display 112 of the device 100 is turned off in response to the user input 580 (FIG. 5M)). In some embodiments, the platter 512 indicates that Song B is playing back at the device 100. In some embodiments, the platter 512 displays the music haptics icon 516-d with one or more visual properties (e.g., different from the visual properties of the music haptics icon 516-b and/or 516-c) to indicate that the music haptics setting is turned on, but haptics are unavailable for Song B.

In some embodiments, the haptics icon 516-d is animated over time, for example, if haptics are available for Song B (e.g., at a server system) but are still loading and not yet available at the device 100, to indicate a progress of the download of the haptics for Song B. For example, while the haptics are downloading (e.g., buffering or otherwise temporarily unavailable at device 100), the device 100 is unable to output haptics concurrently with Song B. In some embodiments, in accordance with a determination that the haptics for Song B are available, the music haptics icon 516-d is updated to the music haptics icon 516-b, as illustrated in FIG. 5O, and the haptics 520-h are output by device 100.

FIGS. 5P-5S illustrate example graphs for generating haptic outputs in accordance with some embodiments. In some embodiments, the haptic outputs are generated, for a respective song, by the device 100 locally and/or at a distinct server system, such that the haptic outputs are prepared, in advance of playback of the respective song, and available for download at the device 100 to play back with the respective song. For example, when determining the haptic outputs to be generated with a respective media item (e.g., music, video content, and/or another type of media item), the device 100 and/or the server system preprocesses the respective media item to select timing, frequency, and/or intensity of the haptic outputs for the respective media item such that the generated haptic outputs complement the respective media item.

FIG. 5P illustrates determining onset curves based on a percussive signal from audio, in accordance with some embodiments. For example, the music haptics are configured to play back concurrently with a maximum of the onset curve (e.g., corresponding to peak energy of the percussive event) as determined in graph 588. In some embodiments, the music haptics are determined based on a width of the percussive event. In some embodiments, a computer system and/or server system takes the audio signal (e.g., for a respective song), as illustrated in graph 584, and extracts the percussive signal. The graph 586 illustrates the percussive signal and the onset curve that represents peak energies of the percussive events. The vertical lines in the graph 588 illustrate the timing at which haptics are generated, based on the identified onset curve of the percussive signal.

In some embodiments, a plurality of percussive events (e.g., and/or other type of audio events) occur in quick succession. In some embodiments, the music haptics are generated to connect sequential, maintained tones and/or audio events that occur within less than a threshold duration of time of each other in a sequence (e.g., in quick succession). For example, a vibration haptic is output and extended, in time, (e.g., instead of generating two or more discrete haptic events) to encompass or otherwise overlap with the plurality of audio events in the sequence. In some embodiments, a plurality of output generators (e.g., non-visual output generators), including haptic generators, speakers and/or other output generators, are used to output the haptics. In some embodiments, where multiple haptic outputs would overlap (e.g., and cannot be generated using a single output generator), multiple different output generators are used to generate different ones of the multiple haptic outputs. In some embodiments, one or more discrete haptic outputs are not generated for a respective audio event of one or more audio events if the respective audio event occurs for less than a threshold duration of time (e.g., less than 20 milliseconds, less than 40 milliseconds, less than 1 second, less than 2 seconds, or another duration of time). In some embodiments, a discrete haptic event is used for percussive signals, and a continuous haptic event, also called a vibration event (e.g., an ongoing vibration event), is used for maintained tones in the audio. As such, the music haptics are generated to match, or complement, one or more audio properties of the media content item.

FIG. 5Q illustrates estimating a predominant pitch, as illustrated in graph 592, of the vocal signal illustrated in graph 590. In some embodiments, the haptic output (e.g., a vibration event) is generated to have a frequency that is determined based at least in part on the predominant pitch of the audio signal. FIG. 5R illustrates extracting a vocal signal 594-b and a non-vocal signal 594-c from an original signal 594-a corresponding to a respective song. In some embodiments, the haptic output (e.g., a vibration event) is generated to have a frequency that is based at least in part on a pitch of the vocal signal 594-b (e.g., in accordance with a determination that vocals are present) and/or based on a pitch of the non-vocal signal 594-c (e.g., representing instrumentation) (e.g., optionally while or in accordance with a determination that vocals are not present). FIG. 5S illustrates a graph 596 for mapping frequency to sharpness. For example, the frequency curve 597 defines a sharpness of a haptic output as a function of a fundamental frequency of an audio event. In another example, the bandwidth mapping curve 598 defines a sharpness of a haptic output as a function of the bandwidth of an audio event.

FIGS. 6A-6G illustrate examples of haptic outputs, prominent haptic outputs, and audio outputs in accordance with some embodiments. In some embodiments, based on a setting of the device, such as a haptics prominence setting, either the haptic output or the prominent haptic output for a respective audio output is generated and output by the device 100. In some embodiments, a respective audio output and corresponding haptic output and/or prominent haptic output is associated with a respective type of alert (e.g., a notification from a first application, a notification from a second application, a system alert, and/or other types of alerts). For example, in accordance with a determination that a first type of alert occurs, the audio output associated with the first type of alert is output and/or the haptic output or prominent haptic output is generated based on a value of the haptics prominence setting.

FIG. 6A illustrates a first set of haptic patterns and audio outputs that are associated with a first type of alert. In some embodiments, in response to detecting occurrence of the first type of alert, the audio 604 is output concurrently with either prominent haptic 602, if the haptics prominence setting is set to on, or with haptic 606, if the haptics prominence setting is set to off. In some embodiments, the audio 604 is optionally not output concurrently with the prominent haptic 602 and/or haptic 606, for example, if the device is set to silent or vibrate mode, such that only prominent haptic 602 or haptic 606 is output by the device 100 in response to detecting occurrence of the first type of alert without an audio output.

As illustrated in FIG. 6A, the prominent haptic 602 includes a haptic pattern having haptic events that occur at same time stamps as (e.g., synchronously with) haptic events of the haptic pattern of the non-prominent haptic 606. For example, seven haptic events are output by both a prominent haptic 602 and by a haptic 606, with the prominent haptic 602 corresponding to a modified version of the haptic 606 that increases an amplitude of one or more haptic events of the prominent haptic 602 relative to those of the haptic 606. In some embodiments, the haptic 606 includes successive haptic events that increase in amplitude before decreasing in amplitude. In some embodiments, the prominent haptic 602 includes successive haptic events that are all output at a same increased amplitude (e.g., a maximum amplitude of the successive haptic events of haptic 606).

FIG. 6B illustrates a second set of haptic and audio outputs that is associated with a second type of alert. In some embodiments, the haptic 612 includes a haptic pattern that comprises three haptic events, including two short haptic events followed by one long haptic event that ceases within a first time threshold of an end of the audio 610 output. In some embodiments, the prominent haptic 608 corresponds to a modified version of the haptic 612 that includes three haptic events, including the two short haptic events followed by a longer haptic event (e.g., that ceases within a second time threshold, different from the first time threshold, of the end of the audio 610 output), optionally with a same amplitude as the long haptic event of the haptic 612. In some embodiments, the second time threshold is a longer time threshold than the first time threshold. In some embodiments, the occurrence and timing of haptic events are based at least in part on the audio 610. For example, the haptic events are timed to overlap, to partially overlap, and/or to avoid overlap with an audio event of the audio 610.

FIG. 6C illustrates a third set of haptic and audio outputs that is associated with a third type of alert. In some embodiments, the haptic 618 includes a haptic pattern that comprises three haptic events, optionally repeating a same haptic event three times. In some embodiments, the haptic pattern causes a haptic event to occur at the onset of an audio event of the audio 616 (e.g., each haptic event occurs at the onset of a corresponding audio event of the audio 616). In some embodiments, the prominent haptic 614 corresponds to a modified haptic pattern compared to the haptic 618. For example, the prominent haptic 614 includes three haptic events, optionally with the first two haptic events matching the first two haptic events of the haptic 618, and a third haptic event that comprises attenuating an extended haptic event over a period of time that is longer than the duration of first two haptic events.

FIG. 6D illustrates a fourth set of haptic and audio outputs that is associated with a fourth type of alert. In some embodiments, the haptic 624 includes a haptic pattern that comprises six haptic events, including two haptic events with a first amplitude followed by a haptic event with a second amplitude that is less than the first amplitude. In some embodiments, the fourth haptic event matches the first two haptic events with the first amplitude, the fifth haptic event has a third amplitude that is less than the first amplitude (and optionally greater than the second amplitude) and a sixth haptic event has a fourth amplitude that is less than the second amplitude. As such, the second half of the haptic pattern attenuates over time. In some embodiments, the prominent haptic 620 corresponds to a modified haptic pattern that includes six haptic events that share a same amplitude (e.g., the first amplitude of the haptic pattern of the haptic 624). In some embodiments, the haptic events overlap with and/or are synchronous with audio events in the audio 622.

FIG. 6E illustrates a fifth set of haptic and audio outputs that is associated with a fifth type of alert. In some embodiments, the haptic 630 includes a haptic pattern that comprises five discrete haptic events, each of the haptic events optionally having a same amplitude as the other haptic events, and optionally offset from audio events in the audio 628. In some embodiments, the prominent haptic 626 associated with the audio 628 includes a haptic pattern that comprises an ongoing haptic event (e.g., that optionally starts when the output of the audio 628 starts and that continues until the output of the audio 628 ceases, thus spanning the length of the audio 628). In some embodiments, the haptic event of the prominent haptic 626 has a larger amplitude and/or a smaller frequency than the haptic events of the haptic 630.

FIG. 6F illustrates a sixth set of haptic and audio outputs that is associated with a sixth type of alert. In some embodiments, the haptic 636 includes a haptic pattern that includes a first haptic event that gradually increases in amplitude over a first time period before a discrete second haptic event that occurs over a second time period that is less than the first time period. In some embodiments, the prominent haptic 632 initially includes the same haptic pattern as the haptic 636 before mirroring the first haptic event of the haptic pattern of the haptic 636 as a third haptic event such that the third haptic event of the prominent haptic 632 gradually decreases in amplitude over a third time period (e.g., longer than the first and second time periods).

FIG. 6G illustrates a seventh set of haptic and audio outputs that is associated with a seventh type of alert. In some embodiments, the haptic 642 includes a haptic pattern that comprises five discrete haptic events. In some embodiments, the first two haptic events have a first amplitude, and the following three haptic events have amplitudes that decrease over time with each successive event. In some embodiments, the prominent haptic 638 includes a haptic pattern that comprises eight discrete haptic events (e.g., such that the prominent haptic 638 is output for a longer period of time than the haptic 642). In some embodiments, the first five haptic events of the prominent haptic 638 have the same amplitude (e.g., optionally the same amplitude as the first amplitude of the first two haptic events of the haptic 642), and the following three haptic events have amplitudes that decrease over time with each successive event, optionally in the same manner as the last three events of the haptic 642. In some embodiments, the discrete haptic events of the prominent haptic 638 occur at timings that are offset from the timings of the discrete haptic events of the haptic 642. For example, at least some of the haptic events of the prominent haptic 638 occur closer together in time to generate a more rapid haptic output that also lasts for a longer period of time overall relative to the haptic 642.

FIG. 6H illustrates a user interface 500-a, such as a home screen user interface, displayed at a device 100. In some embodiments, in response to a user input 6002 directed to a settings icon 446, the device 100 displays a user interface 500-g, such as a settings user interface for controlling one or more settings, as illustrated in FIG. 6I. In some embodiments, the user interface 500-g illustrated in FIG. 6I includes one or more options for controlling audio and/or haptic settings of the device 100. For example, the user sets a respective tone to assign to each respective type of alert. For example, “ringtone” is set to “Tone 1” 6008-a, “text tone” is set to “Tone 2” 6008-b, “new mail” is set to “Tone 3” 6008-c, “calendar alerts” is set to “Tone 4” 6008-d, and “default alerts” is set to “Tone 5” 6008-e. In some embodiments, each of “Tone 1” through “Tone 5” corresponds to one of the set of haptic and audio outputs described with reference to FIGS. 6A-6G, or another set of haptic and audio outputs. In some embodiments, the user reassigns one or more tones from a collection of available tones to a respective type of alert. In some embodiments, two or more categories of alerts can be assigned to any respective tone from the same collection of available tones (e.g., the same options for tones are presented for the “new mail” category and the “calendar alerts” category and/or one or more other categories of alerts).

In some embodiments, the user changes “ringtone” from “Tone 1” to “Tone 2” (e.g., or another available tone, such as “Tone 7”). In some embodiments, each available tone in the set of available tones is associated with a prominent haptic and a non-prominent haptic. In some embodiments, a same tone is assigned to different types and/or categories of alerts; for example, both “ringtone” and “text tone” are assigned to “Tone 1” such that outputs (e.g., a prominent haptic, a non-prominent haptic, and/or audio) selected from the same set of outputs (e.g., “Tone 1” outputs) are generated and output by the device 100 in response to detecting occurrence of an incoming call (e.g., corresponding to the “ringtone” category) and in response to detecting occurrence of an incoming message notification (e.g., corresponding to the “text tone” category).

In some embodiments, the user interface 500-g further includes one or more controls for controlling the system sounds and haptics; for example, the user can toggle crown haptics on and/or off using the toggle 6010, toggle system haptics on and/or off using the toggle 6012 and toggle a cover to mute option on and/or off using the toggle 6014.

In FIG. 6I, the haptics setting is set to the “Default” setting 6006-a. In some embodiments, default haptics correspond to the non-prominent haptics (e.g., haptic 606, haptic 612, haptic 618, haptic 624, haptic 630, haptic 636, and haptic 642 (FIGS. 6A-6G)). For example, while the haptics setting is set to the default 6006-a, the non-prominent haptic is output in conjunction with (and in some cases concurrently with) the corresponding audio output in response to detecting the occurrence of a respective alert assigned that haptic output and audio output set. In some embodiments, in response to a user input 6004 (FIG. 6I), the device 100 displays a user interface 500-h to set the haptics setting (e.g., to turn haptics “off”, to the “default” non-prominent haptics, or to “prominent” haptics), as illustrated in FIG. 6J. FIG. 6J illustrates detecting a user input 6016 corresponding to a request to set the haptics setting to “prominent,” as reflected in the updated user interface 500-g showing the haptics setting set to the “Prominent” setting 6006-b, as illustrated in FIG. 6K.

FIGS. 6L-6M illustrate the different haptic outputs in response to the device 100 receiving a same notification type, based on the current haptics setting of the device 100. For example, in FIG. 6L, the haptics setting is set to “Prominent” such that, in response to occurrence of a first type of notification, such as a message notification 6018-a, the device 100 outputs the prominent haptic 602. In some circumstances, the haptics setting is set to “Default” such that, in response to occurrence of the first type of notification, such as the message notification 6018-b, the device 100 outputs the haptic 606, as illustrated in FIG. 6M. As described above with reference to FIG. 6A, the prominent haptic 602 and the haptic 606 are paired in the same set of haptic and audio outputs, whereby a same audio output (e.g., the audio 604) is optionally generated and output by the device (e.g., if the device is not in silent and/or vibrate only mode) in both FIGS. 6L and 6M. For example, the “text tone” set to “Tone 2” in FIGS. 6I and 6K corresponds to the set that includes the prominent haptic 602, the audio 604 and/or the haptic 606 described with respect to FIG. 6A.

FIGS. 6N-6O illustrate another example of different haptic outputs in response to the device 100 receiving a same notification type, based on the current haptics setting of the device 100. For example, in FIG. 6N, the haptics setting is set to “Prominent” such that, in response to occurrence of a second type of notification (e.g., different from the first type of notification in FIGS. 6L-6M), such as an incoming phone call 6020-a, the device 100 outputs the prominent haptic 608. In some circumstances, the haptics setting is set to “Default” such that, in response to occurrence of the second type of notification, such as the phone call 6020-b, the device 100 outputs the haptic 612, as illustrated in FIG. 6O. As described above with respect to FIG. 6B, the prominent haptic 608 and the haptic 612 are paired in the same set of haptic and audio outputs, whereby a same audio output (e.g., the audio 610) is optionally generated and output by the device (e.g., if the device is not in silent and/or vibrate only mode) in both FIGS. 6N and 6O. For example, the “ringtone” set to “Tone 1” in FIGS. 6I and 6K corresponds to the set that includes the prominent haptic 608, the audio 610, and/or the haptic 612 described with respect to FIG. 6B.

FIGS. 6P-6Q illustrate an example of different haptic outputs in response to a device 600 (e.g., a wearable device, mobile device, or other device) receiving a same notification type, based on the current haptics setting of the device 600. For example, in FIG. 6P, the haptics setting is set to “Prominent” such that, in response to occurrence of a third type of notification (e.g., different from the first type of notification in FIGS. 6L-6M and/or the second type of notification in FIGS. 6N-6O), such as a calendar alert 6024-a displayed in the user interface 6022-a, the device 600 outputs the prominent haptic 614. In some circumstances, the haptics setting is set to “Default” such that, in response to occurrence of the third type of notification, such as a calendar alert 6022-b displayed in the user interface 6022-b, the device 600 outputs haptic 618, as illustrated in FIG. 6O. As described above with respect to FIG. 6C, the prominent haptic 614 and the haptic 618 are paired in the same set of haptic and audio outputs, whereby a same audio output (e.g., the audio 616) is optionally generated and output by the device 600 (e.g., if the device 600 is not in silent and/or vibrate only mode) in both FIGS. 6P and 6Q. For example, the “calendar alerts” set to “Tone 4” in FIGS. 6I and 6K corresponds to the set that includes the prominent haptic 614, the audio 616, and/or the haptic 618 described with respect to FIG. 6C.

FIGS. 6R-6S illustrate another example of different haptic outputs in response to the device 600 receiving a same notification type, based on the current haptics setting of the device 600. For example, in FIG. 6R, the haptics setting is set to “Prominent” such that, in response to occurrence of a fourth type of notification (e.g., different from the first type of notification in FIGS. 6L-6M and/or the second type of notification in FIGS. 6N-6O and/or the third type of notification in FIGS. 6P-6Q), such as an alarm notification 6026-a, the device 600 outputs prominent haptic 620. In some circumstances, the haptics setting is set to “Default” such that, in response to occurrence of the fourth type of notification, such as the alarm notification 6026-b, the device 600 outputs the haptic 624 (e.g., a default haptic), as illustrated in FIG. 6S. As described above with respect to FIG. 6D, the prominent haptic 620 and the haptic 624 are paired in the same set of haptic and audio outputs, whereby a same audio output (e.g., the audio 622) is optionally generated and output by the device 600 (e.g., if the device 600 is not in silent and/or vibrate only mode) in both FIGS. 6R and 6S. For example, the “default alerts” set to “Tone 5” in FIGS. 6I and 6K corresponds to the set that includes the prominent haptic 620, the audio 622, and/or the haptic 624 described with respect to FIG. 6D.

In some embodiments, one or more categories of alerts do not change a haptic output (e.g., between a prominent and non-prominent haptic output) that is generated in response to detecting occurrence of an alert in the one or more categories. For example, in response to detecting occurrence of an alert in the one or more categories of alerts that do not change the haptic output based on the haptics setting, a same haptic is output regardless of the current value of the haptics setting. In some embodiments, the one or more categories include input feedback alerts, such as haptics that are generated in response to detecting a user input (e.g., haptics output in response to a typing user input on a keyboard, a selection user input on a button, and/or other types of user inputs). For example, the haptic outputs that are provided in response to detecting user inputs directed to, e.g., a virtual keyboard, a button, and/or a user interface object that is displayed in a user interface of the device 100, do not change in response to the user changing the haptics setting from default to prominent, or vice-versa.

FIGS. 7A-7H are flow diagrams illustrating method 700 of outputting tactile outputs with audio content in accordance with some embodiments. Method 700 is performed at a computer system (e.g., device 300 (FIG. 3A) or portable multifunction device 100 (FIG. 1A)) with one or more display devices (e.g., touch-sensitive display system 112 (FIG. 1A) or display 340 (FIG. 3A)) and one or more tactile output generators (e.g., tactile output generator(s) 167 (FIG. 1A) or tactile output generator(s) 357 (FIG. 3A)), the computer system being in communication with one or more audio output devices (e.g., speaker 111 (FIG. 1A)) and one or more input devices (e.g., touch screen 112 (FIG. 1A), keyboard/mouse 350 (FIG. 3A), touchpad 355 (FIG. 3A), hardware input device 145 (FIG. 1C), and/or other input or control devices 116 (FIG. 1A)). Some operations in method 700 are, optionally, combined and/or the order of some operations is, optionally, changed.

As described herein, method 700 provides tactile outputs in conjunction with audio outputs for media items played back using a media player application. Outputting tactile outputs that are generated based on audio properties of the media item to be played back concurrently with the tactile outputs, and enabling the user to easily switch the tactile outputs on and/or off, assists the user with exploring and consuming the media items that are playing back without the need for the user to provide additional inputs and navigate complex user interfaces (e.g., with multiple user interface elements across multiple hierarchy levels), thereby reducing the number, complexity, and extent of user inputs. Additionally, forgoing providing haptic outputs while in an off and/or paused state reduces the power consumption of the computer system, thereby increasing the battery life of the computer system. These and other benefits of method 700 are particularly beneficial to users with reduced hearing (or other hearing impairments), making user interaction with the computer system, and media items played back at the computer system, more accessible to a wider population.

The computer system outputs (701), via the one or more audio output devices, audio content of media (e.g., audio content or video content with audio) being played via a media player application. In some embodiments, if the media being played includes video content, the video content is output in conjunction with the audio content. For example, as described with reference to FIG. 5A, a music session is active at device 100, as indicated in the session region 502-a, such that audio for the music session is output by device 100 and/or by another device (e.g., speakers, headphones, and/or other devices) while playback is controlled by the device 100.

While outputting the audio content without outputting tactile outputs corresponding to the audio content, the computer system displays (702), via the one or more display devices, a tactile output control (e.g., that is activatable to control output of tactile outputs associated with the audio content being played), and detects, via the one or more input devices, a first input activating the tactile output control. For example, as described with reference to FIG. 5B, a user input 506 (e.g., corresponding to the first input) directed toward the icon 516-a causes the device 100 to begin outputting haptics 520-a. In some embodiments, as described with reference to FIGS. 5D-5E, a user input (e.g., corresponding to the first input) activates or deactivates a control 524-b (e.g., a tactile output control) for enabling and/or disabling haptics by turning the music haptics setting on or off. In some embodiments, as described with reference to FIG. 5L, a user input (e.g., corresponding to the first input) directed to the music haptics control toggle 556-b turns on the music haptics setting.

In response to detecting the first input activating the tactile output control, the computer system outputs (704), via the one or more tactile output generators, a sequence of tactile outputs corresponding to a plurality of audio features of the audio content that are being output in conjunction with (e.g., concurrently with) the sequence of tactile outputs (e.g., generated from and/or based on the audio content). In some embodiments, in response to detecting the first input activating the tactile output control: in accordance with a determination that the first input activating the tactile output control was detected while outputting the audio content without corresponding tactile outputs, the computer system continues outputting the audio content in conjunction with outputting (e.g., beginning to output or resuming outputting) one or more tactile outputs corresponding to the audio content; and in accordance with a determination that the first input activating the tactile output control was detected while outputting the audio content with corresponding tactile outputs, the computer system ceases to output tactile outputs corresponding to the audio content while continuing to output the audio content. For example, as described with reference to FIG. 5B, the device 100 outputs haptics 520-a in response to a user input turning on the music haptics setting.

In some embodiments, while outputting the sequence of tactile outputs corresponding to a plurality of audio features of the audio content that are being output in conjunction with (e.g., concurrently with) the sequence of tactile outputs and while displaying the tactile output control, the computer system detects (706), via the one or more input devices, a second input activating the tactile output control; and in response to detecting the second input activating the tactile output control, the computer system ceases to output, via the one or more tactile output generators, the sequence of tactile outputs corresponding to the plurality of audio features of the audio content while continuing to output the audio content of the media being played. For example, as described with reference to FIGS. 5F and 5I, the music haptics setting is toggled to the paused state in response to detecting a user input 530 directed to icon 516-b, and the device 100 ceases to output the haptics 520-c while continuing playback of the audio of currently playing Song A. Providing a control option that, when selected by a user, pauses the haptic outputs that are played back concurrently with audio content, while continuing the playback of the audio content, provides the user with additional control options for consuming media with or without haptics and reduces the battery usage of the computer system by forgoing providing haptics while the haptic outputs are paused.

In some embodiments, the computer system displays (708), via the one or more display devices, a media player user interface, wherein the media player user interface includes a plurality of controls corresponding to different functions of the media player application, and the plurality of controls includes the tactile output control. In some embodiments, the plurality of controls includes a play/pause button for starting or stopping media playback, a next button for moving to a next media item or moving forward within the current media item, a previous button for moving to a previous media item or moving backward within the current media item, a volume control for changing media output volume, and/or a navigation control for indicating playback progress through the current media item and/or for moving to different locations within the current media item. For example, as described with reference to FIGS. 5B-5C, the icon 516-b is displayed in the platter 512 corresponding to a media player user interface that includes a plurality of other controls 514. In some embodiments, the icon 516-b is displayed in a now playing user interface 500-d with the plurality of other controls 514, as illustrated in FIG. 5F. Displaying a control option within a media player user interface element that includes one or more other control options for the media player, whereby selection of the control option pauses the haptic outputs that are played back concurrently with audio content, reduces the number of inputs required for the user to consume media with or without haptics, without requiring the user to navigate complex menu hierarchies.

In some embodiments, the media player user interface is displayed (710) in a user interface of a media player application. For example, as described with reference to FIG. 5I, the icon 516-c and/or the plurality of other controls 514 for the music session are displayed in a music application user interface 500-e. Displaying a media player user interface element within a user interface for a media application, whereby the media player user interface element includes one or more controls for controlling content provided by and/or settings of the media application, provides additional control options for the media application and reduces the number of inputs required for the user to control and/or change settings of the media application, without requiring the user to navigate complex menu hierarchies.

In some embodiments, the media player user interface is displayed (712) in a wake screen user interface that corresponds to a restricted state of the computer system (e.g., a lock screen user interface, a wake screen user interface, a dimmed always-on user interface, or other type of user interface that is displayed when the computer system transitions into a low-power and/or locked state, and/or that must be dismissed in order to access a home screen user interface of the computer system or application user interface). For example, as described with reference to FIG. 5B, the icon 516-b is displayed in the platter 512 that is displayed within the user interface 500-b (e.g., a wake screen user interface and/or a cover sheet user interface). Displaying a media player user interface element in a wake screen user interface that is displayed in response to waking the computer system, whereby the media player user interface element includes one or more controls for controlling content provided by and/or settings of the media application, provides additional control options for the media application from a wake screen user interface, and reduces the number of inputs required for the user to control and/or change settings of the media application, without requiring the user to navigate complex menu hierarchies. Further, displaying a limited set of control options, including the controls in the media player user interface element, in the wake screen user interface that is displayed while the computer system is in a locked state, without requiring user authentication from the user, enhances the security of the computer system while providing limited access to certain media controls.

In some embodiments, the media player user interface is displayed (714) in a media playback control region (e.g., module or other portion of the user interface) in a control user interface that includes a plurality of controls corresponding to a plurality of control functions of the computer system. For example, as described with reference to FIGS. 5D-5E, the device 100 displays the user interface 500-c (e.g., a control user interface), including displaying the control 524-a in the user interface 500-c and/or in a now playing control region of the control user interface. Displaying a media player user interface element in a control user interface that is displayed in response to a first type of user input (e.g., a swipe user input that starts at a top right corner, or other respective portion, of the display), whereby the media player user interface element includes one or more controls for controlling content provided by and/or settings of the media application, provides additional control options for the media application while displaying a control user interface with additional user-selectable controls, and reduces the number of inputs required for the user to control and/or change settings of the media application, without requiring the user to navigate complex menu hierarchies.

In some embodiments, the media player user interface is displayed (716) in a status region displayed concurrently with at least a portion of a home screen user interface of the computer system (e.g., the home screen user interface including a plurality of application icons that are activatable to launch respective applications of the computer system). In some embodiments, the first status region is an expanded status region that includes status information about the media being played and the plurality of controls (e.g., corresponding to different media playback control functions of the media player application). In some embodiments, the first status region is displayed concurrently with a different user interface, such an application user interface, instead of the home scree user interface. In some embodiments, the status region (also called a session region) provides status information for one or more applications (e.g., in some embodiments for multiple applications concurrently), within a consistently located display region that persists during navigation between user interfaces outside of the status region (e.g., typically user interfaces of applications not represented in the status region). In some embodiments, the status information for a respective application in the status region is updated over time while an active session for the respective application is ongoing (e.g., the respective application continues executing on the computer system, optionally as a background process), during display and/or interaction with a user interface of another application outside of the status region and/or during navigation between user interfaces of one or more applications other than the respective application and/or one or more system user interfaces). For example, as described with reference to FIG. 5A, in some embodiments, the session region 502-a is optionally expanded, while displaying the user interface 500-a (e.g., a home screen user interface). In some embodiments, the expanded session region includes a control for activating and/or deactivating a music haptics setting and/or includes one or more of the controls 514 in the platter 512. Displaying a media player user interface element concurrently with a home screen user interface, optionally in a session region that is updated based on one or more active sessions corresponding to respective applications of the computer system, whereby the media player user interface element includes one or more controls for controlling content provided by and/or settings of the media application, provides additional control options for the media application while displaying a home screen user interface, and reduces the number of inputs required for the user to control and/or change settings of the media application, without requiring the user to navigate complex menu hierarchies or relaunch the media application.

In some embodiments, while displaying the media player user interface, which includes the tactile output control, in the status region concurrently with displaying at least the portion of the home screen user interface, the computer system detects (718), via the one or more input devices, one or more user inputs corresponding to a request to reduce a visual prominence of the status region; and in response to detecting the one or more user inputs corresponding to the request to reduce the visual prominence of the status region, the computer system displays, via the one or more display devices, concurrently with at least the portion of the home screen user interface (and in some embodiments concurrently with an additional portion of the home screen user interface previously occupied by the first status region), an updated status region (e.g., a different status region or a modified version of the previously displayed status region) that includes status information about the media being played without including the tactile output control (e.g., and without including controls corresponding to functions of the media player application), wherein the updated status region is different from the status region that was displayed prior to detecting the one or more user inputs corresponding to the request to reduce the visual prominence of the status region (e.g., the computer system ceases to display the tactile output control, and optionally other controls for the media player application, in transitioning from displaying the first status region to displaying the second status region). In some embodiments, the status information about the media being played includes an indication of which song or track is playing, a waveform animation indicating that media is playing, a time elapsed and/or time remaining in the current media item being played, and/or other status information. For example, as described with reference to FIGS. 5D-5E, the session region 502-a includes an indication that the music haptics setting is turned off, whereas the session region 502-c is updated to indicate that the music haptics setting is turned on (e.g., and optionally displays a visual indication as to whether the music haptics are active or paused). Maintaining display of a status of a media application, concurrently with a home screen user interface, optionally in a session region that is in a minimized state, provides the user with real-time status of the media application without visually obstructing the other user interface elements available in the home screen user interface.

In some embodiments, the computer system displays (720), via the one or more display devices, a control user interface that provides access to a plurality of controls corresponding to different control functions of the computer system, wherein the control user interface includes the tactile output control. For example, as described with reference to FIGS. 5D-5E, the control 524-a is displayed in the user interface 500-c (e.g., a control user interface), and is optionally displayed in a now playing control region of the control user interface. Displaying a control option, whereby selection of the control option pauses and/or activates haptic outputs to be played back concurrently with audio content, within a control user interface that is displayed in response to a first type of user input (e.g., a swipe user input that starts at a top right corner, or other respective portion, of the display) provides additional control options for the user and reduces the number of inputs required for the user to consume media with or without haptics, without requiring the user to navigate complex menu hierarchies.

In some embodiments, while a respective mode (e.g., a mode for outputting tactile outputs corresponding to audio features of audio content) is not enabled, the computer system detects (722), via the one or more input devices, one or more first inputs corresponding to a request to display the control user interface. In some embodiments, in response to detecting the one or more first inputs, the computer system displays, via the one or more display devices, the control user interface without the tactile output control; and while the respective mode is enabled, the computer system detects, via the one or more input devices, one or more second inputs corresponding to a request to display the control user interface. In some embodiments, the respective mode is enabled in response to detecting one or more inputs corresponding to a request to enable the respective mode (e.g., in an accessibility settings menu that provides access to assistive features of the computer system to better enable users with disabilities to use the computer system). In some embodiments, displaying the control user interface that includes the tactile output control is performed in response to detecting the one or more second inputs via the one or more input devices. In some embodiments, the tactile output control is included in the control user interface automatically based on the respective mode being enabled (e.g., without requiring separate user input(s) to add the tactile output control to the control user interface). In some embodiments, if the respective mode is disabled, the tactile output control is not included (e.g., removed, if previously included) in the control user interface or alternatively is maintained in the control user interface. In some embodiments, if the respective mode is disabled, the tactile output control is not included (e.g., or no longer included) in any region of the control user interface (e.g., removed as a module from the control user interface itself and also removed from within a media playback control module of the control user interface that is different from the tactile output control module), or is not included in one region of the control user interface while continuing to be included in another region of the control user interface (e.g., maintained as a standalone tactile output control module and removed from within the media playback control module, or vice versa). In some embodiments, whether the tactile output control is removed from the control user interface altogether, and/or whether the tactile output control is removed from one module of the control user interface versus another, is dependent on whether another mode (e.g., an accessibility mode) of the computer system is enabled. For example, as described with reference to FIGS. 5D and 5L-5M, the control 524-b is automatically added to the control user interface 500-c in response to a user input turning on the music haptics setting in a settings user interface. Automatically including a control option, whereby selection of the control option pauses and/or activates haptic outputs to be played back concurrently with audio content, within a control user interface that is displayed in response to a first type of user input (e.g., a swipe user input that starts at a top right corner, or other respective portion, of the display) provides the user with additional control options in the control user interface and reduces the number of inputs required for a user to manually add the control option to the control user interface.

In some embodiments, the computer system displays (724), via the one or more display devices, a settings user interface that provides access to a plurality of configuration options for the computer system, wherein the settings user interface includes the tactile output control. For example, as described with reference to FIGS. 5L-5M, the device 100 displays the settings user interface 500-f that includes toggle 556-a for turning the music haptics setting on and/or off. Displaying a control option, whereby selection of the control option pauses and/or activates haptic outputs to be played back concurrently with audio content, within a settings user interface that includes a plurality of additional controls for controlling settings of the computer system, provides additional control options to the user.

In some embodiments, the computer system displays (726), via the one or more display devices, in the settings user interface, a list of one or more software applications of the computer system that are configured to output tactile outputs corresponding to audio features of audio content (e.g., in accordance with activation of the tactile output control, and optionally in accordance with enabling outputting tactile outputs corresponding to audio content). For example, as described with reference to FIG. 5L, the settings user interface 500-f includes a list of applications (e.g., music application 564, application B 566, application C 568, and/or other applications) for which the music haptics setting is individually controllable. Displaying a list of available applications that are enabled to output haptics in conjunction with audio provided by the respective application, provides the user with additional information and enables the user to individually configure a haptics setting for applications in the list of available applications, thereby providing the user with additional and more refined control over the haptic outputs.

In some embodiments, the computer system, in accordance with a determination that a respective mode (e.g., a mode for outputting tactile outputs corresponding to audio features of audio content) is enabled, displays (728), via the one or more display devices, in the media player user interface, a first indication. In some embodiments, the first indication is the tactile output control (e.g., the tactile output control is displayed in accordance with the determination that the respective mode is enabled). In some embodiments, the first indication is the tactile output control with a first appearance (e.g., that indicates that outputting tactile outputs corresponding to a plurality of audio features of audio content being played is enabled). In some embodiments, the computer system, in accordance with a determination that the respective mode is not enabled (e.g., is turned off, disabled, or unavailable for the computer system), forgoes displaying, in the media player, the first indication (e.g., and optionally displaying a second indication that is different from the first indication). In some embodiments, the computer system forgoes displaying the first indication by not displaying the tactile output control with the first appearance (e.g., that indicates that outputting tactile outputs corresponding to a plurality of audio features of audio content being played is enabled), and optionally by displaying the tactile output control with a second appearance that is different from the first appearance (e.g., and that indicates that outputting tactile outputs corresponding to a plurality of audio features of audio content being played is not enabled). For example, as described with reference to FIGS. 5B-5C, the platter 512 displays animated sound bars 516-a while the music haptics setting is turned off and music haptics icon 516-b while the music haptics setting is turned on to indicate whether the music haptics setting is turned on. Automatically determining whether or not to display an indication that indicates whether a haptics output mode is active or inactive, and displaying, or forgoing displaying, the indication based on the current mode improves the visual feedback about the state of the computer system.

In some embodiments, the computer system, in accordance with the determination that the respective mode is enabled, displays (730), via the one or more display devices, in the media player user interface, the first indication without regard to whether tactile outputs corresponding to a plurality of audio features of the audio content are available (e.g., the first indication is displayed even if tactile outputs are not available, for example because the audio content does not have associated tactile outputs). For example, as described with reference to FIG. 5N, the platter 512 displays the music haptics icon 516-d to indicate the music haptics setting is turned on, but haptics are unavailable for Song B. Automatically displaying an indication that indicates that a haptics output mode is active, including displaying the indication while the haptics mode is active even if haptics are unavailable for a currently playing audio content item, provides visual feedback about the state of the computer system.

In some embodiments, the computer system, in accordance with the determination that the respective mode is enabled: while loading information that can be used by the computer system to generate the tactile outputs corresponding to a plurality of audio features of the audio content, displays (732), via the one or more display devices, a plurality of intermediate indications (e.g., indicating progress of the loading of the information that can be used by the computer system to generate the tactile outputs). In some embodiments, prior to loading (e.g., prior to beginning to load) the information that can be used by the computer system to generate the tactile outputs, an indication that the respective mode is enabled and that the information that can be used by the computer system to generate the tactile outputs is not loaded (e.g., not available) is displayed (e.g., and is different from (e.g., a respective one of) the plurality of intermediate indications). In some embodiments, after completing the loading of the information that can be used by the computer system to generate the tactile outputs, an indication that the respective mode is enabled and that the information that can be used by the computer system to generate the tactile outputs are loaded is displayed (e.g., and is different from (e.g., a respective one of) the plurality of intermediate indications). For example, as described with reference to FIG. 5N, the platter 512 optionally displays the music haptics icon 516-d as animating (e.g., by gradually changing a color, luminance and/or other visual properties of the icon 516-d), while the haptics are still loading and not yet available at the device 100, to indicate a progress of the download of the haptics for Song B. Displaying an indication that indicates that a haptics output mode is active, while the haptics are loading, including modifying the indication to show a progress of the loading of the haptics, provides visual feedback about the state of the computer system.

In some embodiments, the media being played via the media application is (734) music (e.g., a piece of music, or in other circumstances a podcast, audiobook, or other audio-based format that does not include video content). For example, as described with reference to FIG. 5A, in some embodiments, the music haptics setting, when enabled, causes the device 100 to output haptics concurrently with playback of music (e.g., Song A). Outputting tactile outputs that are generated based on audio properties of music that is played back concurrently with the tactile outputs, assists the user with exploring and consuming the music that is playing back, which is particularly beneficial to users with reduced hearing (or other hearing impairments), making user interaction with the computer system, and music played back at the computer system, more accessible to a wider population.

In some embodiments, the media being played via the media application includes (736) video content (e.g., the media is a video, movie, or other audiovisual format). For example, as described with reference to FIG. 5A, in some embodiments, the music haptics setting, when enabled, causes the device 100 to output haptics concurrently with playback of video content (e.g., with playback of the audio portion of the video content). Outputting tactile outputs that are generated based on audio properties of video content that is played back concurrently with the tactile outputs, assists the user with exploring and consuming the video content that is playing back, which is particularly beneficial to users with reduced hearing (or other hearing impairments), making user interaction with the computer system, and music played back at the computer system, more accessible to a wider population.

In some embodiments, the sequence of tactile outputs corresponding to the plurality of audio features of the audio content is (738) automatically generated (e.g., independently of, and in some embodiments, prior to, detecting the first input activating the tactile output control). In some embodiments, the sequence of tactile outputs corresponding to the plurality of audio features of the audio content is generated by the computer system or obtained by the computer system from a different computer system used to generate the sequence (e.g., prior to outputting the audio content of the media being played and/or prior to detecting the first input activating the tactile output control). For example, as described with reference to FIGS. 5P-5S, haptics are automatically determined (e.g., optionally by device 100 and/or a server separate from device 100) for a respective media content item. Automatically generating haptics to be associated with a respective media item (e.g., in advance of playing back the respective media item) and providing the generated haptics to the computer system to be available while a respective media item is played back, reduces the computational resources required of the computer system to generate the haptic outputs in real-time.

In some embodiments, while outputting the sequence of tactile outputs corresponding to the plurality of audio features of the audio content that are being output in conjunction with (e.g., concurrently with) the sequence of tactile outputs, the computer system: detects (740) occurrence of an event corresponding to a request to pause playback of the audio content (e.g., an input, via the one or more input devices, activating an audio output control, receipt of a notification or alert, a request to play different audio content, or other event associated with pausing playback of the audio content); and in response to detecting the occurrence of the event corresponding to the request to pause the audio content, ceases to output, via the one or more audio output devices, the audio content of the media being played in conjunction with (e.g., concurrently with) ceasing to output, via the one or more tactile output generators, the sequence of tactile outputs corresponding to the plurality of audio features of the audio content. In some embodiments, the sequence of tactile outputs corresponding to the audio content remain loaded and available to continue to be output, for example if playback of the audio content is resumed (e.g., in response to an input (e.g., another input, via the one or more input devices) activating the audio output control, acknowledgment or expiration of the notification or alert, stopping or pausing playback of the different audio content, or other event associated with resuming playback of the audio content). For example, as described with reference to FIGS. 5H-5I, in response to a user input 550, such as a tap input or other selection input, directed to the pause control 514-c, the haptics 520-e cease to be output by the device 100 (e.g., the haptics 520-e are paused) in addition to playback of Song A being paused. Automatically ceasing to output the haptic outputs in response to a user input that causes the media item associated with the haptic outputs to pause, such that the haptic outputs remain synchronized with the audio output of the media item, while maintaining the availability of the haptic outputs to be resumed upon resuming playback of the media item, provides improved feedback about a state of the computer system, and in particular, improves the feedback to users with reduced hearing (or other hearing impairments) as to a current state of the computer system.

In some embodiments, outputting the sequence of tactile outputs corresponding to the plurality of audio features of the audio content that are being output in conjunction with (e.g., concurrently with) the sequence of tactile outputs includes outputting the sequence of tactile outputs at a first tactile output volume while the audio content is being output at a first audio output volume. In some embodiments, the computer system detects (742), via the one or more input devices, an input corresponding to a request to change a media output volume; and in response to detecting the input corresponding to the request to change the media output volume, outputs, via one or more tactile output generators, the sequence of tactile outputs at the first tactile output volume while outputting, via the one or more audio output devices, the audio content at a second audio output volume that is different from the first audio output volume. For example, as described with reference to FIG. 5M, in some embodiments, the haptic outputs are optionally output without regard to a current volume of the device 100. Maintaining the haptic outputs that are based on the audio properties of the currently playing media content item, including while a volume of the computer system is changed, without increasing a volume of the haptics protects the haptic generators from damage caused by outputting haptics at a higher volume, without limiting the user's control options for changing a volume of the audio of the computer system.

In some embodiments, one or more properties of the sequence of tactile outputs corresponding to the plurality of audio features of the audio content are (744) selected by a user (e.g., in a settings user interface that provides access to a plurality of configuration options for the computer system and/or in a control user interface that provides access to a plurality of controls corresponding to different control functions of the computer system). For example, as described with reference to FIG. 5M, the settings user interface 500-f (e.g., and/or the control user interface 500-c) optionally includes one or more options for changing one or more properties of the haptic outputs. Displaying user-selectable controls for controlling properties of the haptic outputs that are output with the currently playing media content provides additional control options for the user to customize the haptic outputs.

In some embodiments, outputting the sequence of tactile outputs corresponding to the plurality of audio features of a respective portion of the audio content includes (746): in accordance with a determination that a first tactile output intensity setting is selected by a user, outputting the sequence of tactile outputs with a first set of tactile output intensities during the respective portion of the audio content (e.g., determined based on the first tactile output intensity setting); and in accordance with a determination that a second tactile output intensity setting is selected by a user, wherein the second tactile output intensity setting is different from the first tactile output intensity setting, outputting the sequence of tactile outputs with a second set of tactile output intensities that is different from the first set of tactile output intensities during the respective portion of the audio content (e.g., determined based on the second tactile output intensity setting). For example, as described with reference to FIG. 5M, the settings user interface 500-f (e.g., and/or the control user interface 500-c) optionally includes an option for changing an intensity of the haptic output. Displaying user-selectable controls for controlling properties of the haptic outputs that are output with the currently playing media content, including a user-selectable control for changing an intensity of the haptic outputs, provides additional control options for the user to customize the intensity of haptic outputs, which may be particularly beneficial to users with various levels of reduced hearing (or other hearing impairments).

In some embodiments, outputting the sequence of tactile outputs corresponding to the plurality of audio features of a respective portion of the audio content includes (748): in accordance with a determination that a first set of audio feature types (also called types of audio events) is selected by a user, outputting, via the one or more tactile output generators, a first sequence of tactile outputs corresponding to a plurality of audio features of the audio content of the first set of audio feature types during the respective portion of the audio content; and in accordance with a determination that a second set of audio feature types is selected by a user, wherein the second set of audio feature types is different from the first set of audio feature types (e.g., by including a different audio feature type or combination of audio feature types), outputting, via the one or more tactile output generators, a second sequence of tactile outputs corresponding to a plurality of audio features of the audio content of the second set of audio feature types, wherein the second sequence of tactile outputs is different from the first sequence of tactile outputs during the respective portion of the audio content. In some embodiments, if a first audio feature type (e.g., percussive audio) is selected, the respective sequence of tactile outputs includes a first type of tactile output (e.g., a discrete tactile output) corresponding to the first audio feature type; if the first audio feature type is not selected, the respective sequence of tactile outputs does not include (e.g., any) tactile outputs of the first type of tactile output corresponding to the first audio feature type. Similarly, if a second audio feature type (e.g., vocal audio) is selected, the respective sequence of tactile outputs includes a second type of tactile output (e.g., a continuous tactile output) different from the first type of tactile output and corresponding to the second audio feature type (e.g., and does not include such type of tactile output if the second audio feature type is not selected). If a third audio feature type (e.g., instrumental audio) is selected, the respective sequence of tactile outputs includes a third type of tactile output different from the first and second types of tactile outputs (e.g., a different type of discrete tactile output or a different type of continuous tactile output) corresponding to the third audio feature type (e.g., and does not include such type of tactile output if the third audio feature type is not selected. For example, as described with reference to FIG. 5M, the settings user interface 500-f (e.g., and/or the control user interface 500-c) optionally includes one or more controls for assigning the haptic outputs to be generated based on a percussive signal of the audio, a vocal signal of the audio, an instrumental signal of the audio and/or one or more other signals of the audio. Displaying user-selectable controls for controlling properties of the haptic outputs that are output with the currently playing media content, including a user-selectable control for changing audio features that are associated with respective haptic outputs, provides additional control options for the user to customize the pattern of haptic outputs according to audio features of the currently playing media content.

In some embodiments, outputting the sequence of tactile outputs corresponding to the plurality of audio features of the audio content includes (750): in accordance with a determination that the audio content includes a first type of audio event indicative of percussive sound (e.g., typically short, transient, high intensity, high amplitude, unpitched or of indefinite pitch, and/or rhythmic), outputting, via the one or more tactile output generators, a first type of tactile output that is a discrete tactile output (e.g., having a tactile output duration less than a threshold duration) as part of the sequence of tactile outputs corresponding to the plurality of audio features of the audio content; and in accordance with a determination that the audio content includes a second type of audio event indicative of sustained sound (e.g., typically longer, tonal, with definite pitch, and/or melodic or harmonic), outputting, via the one or more tactile output generators, a second type of tactile output that is a continuous tactile output (e.g., having a tactile output duration greater than the a threshold duration (and optionally based on a duration of the sustained sound); sometimes also called a vibration tactile output) as part of the sequence of tactile outputs corresponding to the plurality of audio features of the audio content, wherein the second type of tactile output is different from the first type of tactile output. In some embodiments, determining which type(s) of audio events the audio content includes (e.g., in order to determine which type(s) of tactile outputs to generate) occurs prior to detecting an input requesting playback of the audio content (e.g., pre-processing of the audio content) or in response to detecting an input requesting playback of the audio content (e.g., on-demand processing of the audio content), and is optionally performed (e.g., locally) by the computer system or at a remote device or computer system that is different from the computer system (e.g., and conveyed to the computer system). Optionally, portions of the audio content are processed successively to determine which corresponding tactile outputs to generate, so that a first portion of the audio content can be output along with corresponding tactile outputs while tactile outputs are being determined for a later, second portion of the audio content prior to output of the second portion of the audio content. For example, as described with reference to FIG. 5M, a discrete haptic event is used for percussive signals and a continuous haptic event (e.g., an ongoing vibration event) is used for maintained tones in the audio. Determining whether to output a sequence of discrete haptic outputs or to output a continuous haptic output based on the type of audio event in the media item, such that the haptic outputs are generated to match the respective type of audio event, provides an improved experience by synchronizing the haptic outputs with a current audio event automatically, without requiring the user to identify and/or configure the haptic outputs, and reduces a number of user inputs. Additionally, matching the haptic outputs to respective types of audio events provides an enriched experience for consuming the media content and is particularly beneficial to users with reduced hearing (or other hearing impairments), making user interaction with the computer system, and media items played back at the computer system, more accessible to a wider population.

In some embodiments, the second type of tactile output that is a continuous tactile output has (752) a tactile output frequency that is based on a pitch associated with the second type of audio event (e.g., a predominant pitch of the sustained sound that is indicated by the second type of audio event). For example, as described with reference to FIG. 5Q, the haptic output (e.g., a continuous haptic event) is generated to have a frequency that is determined based at least in part on the predominant pitch of the audio portion of the media content item. Automatically generating and outputting a vibration haptic based on a determined pitch of the media content item, such that the vibration haptic outputs are generated to match the pitch of the audio portion of the media content item, provides an improved experience by synchronizing the haptic outputs with a predominant audio pitch automatically, without requiring the user to identify and/or configure the haptic outputs, and reduces a number of user inputs. Additionally, matching the haptic outputs to a pitch of the audio portion of the media content item provides an enriched experience for consuming the media content and is particularly beneficial to users with reduced hearing (or other hearing impairments), making user interaction with the computer system, and media items played back at the computer system, more accessible to a wider population.

In some embodiments, outputting the second type of tactile output that is a continuous tactile output includes (754): in accordance with a determination that the second type of audio event indicative of sustained sound is associated with vocal sound (e.g., singing or other sound produced by human voice, also called vocal music or vocals), outputting the second type of tactile output with a tactile output frequency that is based on a pitch of the vocal sound (e.g., a predominant pitch of the corresponding vocals). In some embodiments, the tactile output frequency of the second type of tactile output is based on the pitch of the vocal sound even if instrumental sound is also present. In some embodiments, outputting the second type of tactile output that is a continuous tactile output includes: in accordance with a determination that the second type of audio event indicative of sustained sound is not associated with vocal sound (e.g., the sustained sound corresponds to instrumental sound that is present in the audio content of the media being played, rather than vocal sound), outputting the second type of tactile output with a tactile output frequency that is based on a pitch associated with instrumental sound (e.g., sound produced by playing an instrument, also called instrumental music or instrumentals) (e.g., based on a predominant pitch of the corresponding instrumentals). In some embodiments, determining whether or not an audio event included in the audio content has one or more properties (e.g., is indicative of a particular type of sound) (e.g., in order to determine one or more properties, such as frequency, of tactile outputs to generate) occurs through pre-processing or on-demand processing of the audio content, locally at the computer system or remotely at another device or computer system. For example, as described with reference to FIG. 5R, the haptic output is generated to have a frequency that is based at least in part on a pitch of the vocal signal 594-b and/or based on a pitch of the non-vocal signal. Automatically generating and outputting a vibration haptic based on a determined pitch of vocals of the media content item and/or pitch of instrumentation of the media content item, such that the vibration haptic outputs are generated to match the vocals and/or instrumentation of the media content item, provides an improved experience by synchronizing the haptic outputs with the pitch of the vocals and/or pitch of the instrumentals automatically, without requiring the user to identify and/or configure the haptic outputs, and reduces a number of user inputs. Additionally, matching the haptic outputs to a pitch of vocals of the media content item and/or pitch of instrumentation of the media content item provides an enriched experience for consuming the media content and is particularly beneficial to users with reduced hearing (or other hearing impairments), making user interaction with the computer system, and media items played back at the computer system, more accessible to a wider population.

In some embodiments, the first type of tactile output that is a discrete tactile output has (756) an amplitude that is based on a peak energy associated with the first type of audio event (e.g., a peak energy of the percussive sound that is indicated by the first type of audio event). For example, as described with reference to FIG. 5P, the haptic outputs are configured to play back concurrently with a maximum of the onset curve (e.g., corresponding to peak energy of the percussive event) as determined in graph 588. Automatically generating and outputting a vibration haptic based on a peak energy of a percussive event that occurs within the media content item, such that the vibration haptic outputs are generated to match the percussive energy of the media content item, provides an improved experience by synchronizing the haptic outputs with the energy of percussive events automatically, without requiring the user to identify and/or configure the haptic outputs, and reduces a number of user inputs. Additionally, matching the haptic outputs to a peak energy of percussive events of the media content item provides an enriched experience for consuming the media content and is particularly beneficial to users with reduced hearing (or other hearing impairments), making user interaction with the computer system, and media items played back at the computer system, more accessible to a wider population.

In some embodiments, the first type of tactile output that is a discrete tactile output has (758) a frequency that is based on a width associated with the first type of audio event (e.g., a width, such as a spectral width or bandwidth, of the percussive sound that is indicated by the first type of audio event). For example, as described with reference to FIG. 5P, the haptic outputs are determined based on a width of the percussive event. Automatically generating and outputting a vibration haptic based on a width of a percussive event that occurs within the media content item, such that the vibration haptic outputs are generated with a frequency to match the timing of the entire percussive event, automatically, without requiring the user to identify and/or configure the haptic outputs, reduces a number of user inputs. Additionally, matching the haptic outputs to a pitch of vocals of the media content item and/or pitch of instrumentation of the media content item provides an enriched experience for consuming the media content and is particularly beneficial to users with reduced hearing (or other hearing impairments), making user interaction with the computer system, and media items played back at the computer system, more accessible to a wider population.

In some embodiments, determining that the audio content includes the second type of audio event indicative of sustained sound (e.g., the audio content includes one or more maintained tones) includes (760) determining that the audio content includes sustained sound that is at least a threshold duration. In some embodiments, outputting the sequence of tactile outputs corresponding to the plurality of audio features of the audio content includes: in accordance with a determination that the audio content includes a third type of audio event indicative of sustained sound that is less than the threshold duration, forgoing outputting a tactile output that is a continuous tactile output and that corresponds to the third type of audio event. In some embodiments, no tactile output, whether continuous or discrete, is output for the third type of audio event. In some embodiments, determining whether or not an audio event included in the audio content has one or more properties (e.g., includes or is indicative of a particular type of sound) (e.g., in order to determine whether or not to generate one or more corresponding tactile outputs) occurs through pre-processing or on-demand processing of the audio content, locally at the computer system or remotely at another device or computer system. For example, as described with reference to FIG. 5P, one or more discrete haptic outputs are not generated for one or more of audio events if the respective audio event is less than a threshold duration of time. Forgoing outputting a vibration haptic for an audio event that occurs shortly after another audio event for which a vibration haptic is already being output, to prevent muddling of the vibration haptics for audio events that occur close together in time, reduces the amount of wear on the haptic generators and increases battery life of the computer system.

In some embodiments, the computer system, in accordance with a determination that the audio content includes a first event that is the second type of audio event indicative of sustained sound (e.g., a first maintained tone) followed (e.g., immediately after) by a second event that is the second type of audio event indicative of sustained sound (e.g., a second maintained tone), outputs (762), via the one or more tactile output generators, one or more tactile outputs of the second type corresponding to the first event and the second event, including: in accordance with a determination that the second event occurs less than a threshold amount of time after the first event (e.g., a beginning of the second maintained tone (e.g., corresponding to an increase, such as in amplitude, power, or other property, above a first threshold) occurs less than the threshold amount of time after an end of the first maintained tone (e.g., corresponding to a decrease, such as in amplitude, power, or other property, below a second threshold, wherein the first threshold is optionally the same as or different from the second threshold), or more generally a determination that an amount of time between a time corresponding to the first event and a time corresponding to the second event is less than the threshold amount of time), outputting, via the one or more tactile output generators, a first tactile output portion of the second type corresponding to the first event and a second tactile output portion of the second type corresponding to the second event without a gap (e.g., an absence of the second type of tactile output) between the first tactile output portion and the second tactile output portion; and in accordance with a determination that the second event occurs at least the threshold amount of time after the first event, outputting, via the one or more tactile output generators, a first tactile output of the second type corresponding to the first event and a second tactile output of the second type corresponding to the second event with a gap (e.g., an absence of the second type of tactile output) between the first tactile output and the second tactile output. In some embodiments, the first tactile output portion corresponding to the first event (output in circumstances involving less than the threshold amount of separation between the first and second events) is longer than the first tactile output corresponding to the first event (output in circumstances involving more than the threshold amount of separation between the first and second events), because the first tactile output portion extends the first tactile output to fill in the gap. For example, as described with reference to FIG. 5P, a vibration haptic is output and extended, in time (e.g., over a longer duration), to encompass or otherwise overlap with the plurality of audio events in a sequence of audio events that occur less than a threshold amount of time from each other. Extending the output of a vibration haptic to cover a first audio event and a second audio event that occurs shortly after the first audio event, rather than attempting to output distinct haptic events for each audio event, prevents muddling of the vibration haptics for audio events that occur close together in time, reduces the amount of wear on the haptic generators and increases battery life of the computer system.

In some embodiments, the computer system outputs (764), via the one or more audio output devices, a respective portion of the audio content that includes a first audio portion (e.g., that is a first tone or first type of audio) and a second audio portion (e.g., that is a second tone or second type of audio, different from the first), wherein the second audio portion is different from the first audio portion, and a tactile output corresponding to the first audio portion overlaps (e.g., at least partially overlaps) with a tactile output corresponding to the second audio portion. In some embodiments, the first audio portion and the second audio portion overlap as well. In some embodiments, the first audio portion and the second audio portion do not overlap (e.g., although the corresponding tactile outputs overlap). In some embodiments, the computer system outputs the tactile output corresponding to the first audio portion (e.g., the first tone or first type of audio) using a first device of the one or more tactile output generators, concurrently with outputting the tactile output corresponding to the second audio portion (e.g., outputting at least a portion of the tactile output corresponding to the second audio portion) using a second device of the one or more tactile output generators, wherein the second device is different from the first device. More generally, in some embodiments, concurrent tactile outputs, or at least overlapping portions of concurrent tactile outputs, are generated using different tactile output devices. For example, as described with reference to FIG. 5P, multiple output generators, including haptic generators, speakers and/or other output generators, are used to output overlapping haptics. Using multiple tactile output generators to generate concurrent yet different haptic outputs provides a wider range of haptic and/or audio output combinations without adding additional hardware to the computer system, and reduces the amount of wear to a single output generator over time.

It should be understood that the particular order in which the operations in FIGS. 7A-7H have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 800) are also applicable in an analogous manner to method 700 described above with respect to FIGS. 7A-7H. For example, the tactile outputs, inputs, and/or audio output devices, described above with reference to method 700 optionally have one or more of the characteristics of the tactile outputs, inputs, and/or audio output devices described herein with reference to other methods described herein (e.g., method 800). For brevity, these details are not repeated here.

FIGS. 8A-8D are flow diagrams illustrating method 800 of outputting tactile outputs for alert conditions in accordance with some embodiments. Method 800 is performed at a computer system (e.g., device 300 (FIG. 3A) or portable multifunction device 100 (FIG. 1A)) with one or more display devices (e.g., touch-sensitive display system 112 (FIG. 1A) or display 340 (FIG. 3A)), one or more tactile output generators (e.g., tactile output generator(s) 167 (FIG. 1A) or tactile output generator(s) 357 (FIG. 3A)), and optionally one or more audio output devices (e.g., speaker 111 (FIG. 1A)). Some operations in method 800 are, optionally, combined and/or the order of some operations is, optionally, changed.

As described herein, method 800 provides respective tactile outputs in response to respective alert conditions, in accordance with a prominence setting of the computer system. Outputting tactile outputs for a same alert condition as either a prominent haptic or a non-prominent haptic based on the prominence setting of the computer system provides the user with additional control over receiving alert conditions from the computer system, thereby providing feedback about a state of the computer system and, by automatically providing either the prominent or non-prominent haptic output based on the setting, reduces the number, complexity, and extent of user inputs.

The computer system detects (801) occurrence of a first alert condition. Examples of alert conditions include inputs detected via one or more input devices (e.g., touch screen 112 (FIG. 1A), keyboard/mouse 350 (FIG. 3A), touchpad 355 (FIG. 3A), hardware input device 145 (FIG. 1C), and/or other input or control devices 116 (FIG. 1A)), notifications (e.g., received messages or calls, event reminders, or the like), system status changes (e.g., alerts concerning battery level, connectivity status, or the like), or other events or conditions that trigger one or more outputs to be generated to alert the user. For example, as described with reference to FIGS. 6L-6M, device 100 detects occurrence of a message notification 6018, and, as described with reference to FIGS. 6P-6Q, the device 600 detects occurrence of a calendar notification 6024.

In response to detecting the occurrence of the first alert condition, the computer system outputs (802), via the one or more tactile output generators, a tactile output corresponding to the first alert condition, including: in accordance with a determination that an increased salience setting of the computer system is not enabled (e.g., the first alert condition is detected while the increased salience setting is not enabled), outputting (804), via the one or more tactile output generators, a first lower prominence tactile output corresponding to the first alert condition. For example, as described with reference to FIG. 6M, while the device 100 does not have a haptics setting set to “Prominent”, the device 100 outputs haptic 606 in response to detecting the incoming message notification 6018-b. In some embodiments, as described with reference to FIG. 6Q, while the device 600 does not have a haptics setting set to “Prominent”, the device 600 outputs haptic 618 in response to detecting the calendar alert 6024-b. and in accordance with a determination that the increased salience setting of the computer system is enabled (e.g., the first alert condition is detected while the increased salience setting is enabled).

The computer system outputs (802), via the one or more tactile output generators, the tactile output corresponding to the first alert condition, including outputting (806), via the one or more tactile output generators, a first higher prominence tactile output corresponding to the first alert condition, wherein a prominence of the first higher prominence tactile output is higher than a prominence of the first lower prominence tactile output, and wherein there is a first tactile output difference between the first higher prominence tactile output and the first lower prominence tactile output. For example, as described with reference to FIG. 6L, while the device 100 has a haptics setting set to “Prominent”, the device 100 outputs haptic 602 in response to detecting the incoming message notification 6018-a. In some embodiments, as described with reference to FIG. 6P, while the device 600 has a haptics setting set to “Prominent”, the device 600 outputs prominent haptic 614 in response to detecting the calendar alert 6024-a.

After detecting the first alert condition (and optionally, after outputting the tactile output corresponding to the first alert condition), the computer system detects (807) occurrence of a second alert condition that is different from the first alert condition. For example, as described with reference to FIGS. 6L-6S, the device 100 detects occurrence of an incoming phone call 6020 and device 600 detects occurrence of an alarm notification 6026.

In response to detecting the occurrence of the second alert condition, the computer system outputs (808), via the one or more tactile output generators, a tactile output corresponding to the second alert condition, including: in accordance with a determination that the increased salience setting of the computer system is not enabled (e.g., the second alert condition is detected while the increased salience setting is not enabled), outputting (810), via the one or more tactile output generators, a second lower prominence tactile output corresponding to the second alert condition. For example, as described with reference to FIG. 6O, while the device 100 does not have a haptics setting set to “Prominent”, the device 100 outputs haptic 612 in response to detecting the incoming phone call 6020-b. For example, as described with reference to FIG. 6S, while the device 600 does not have a haptics setting set to “Prominent”, the device 600 outputs haptic 624 in response to detecting the alarm notification 6026-b.

The computer system outputs (808), via the one or more tactile output generators, the tactile output corresponding to the second alert condition, including: in accordance with a determination that the increased salience setting of the computer system is enabled (e.g., the second alert condition is detected while the increased salience setting is enabled), outputting (812), via the one or more tactile output generators, a second higher prominence tactile output corresponding to the second alert condition, wherein a prominence of the second higher prominence tactile output is higher than a prominence of the second lower prominence tactile output, and wherein there is a second tactile output difference between the second higher prominence tactile output and the second lower prominence tactile output. For example, as described with reference to FIG. 6N, while the device 100 has a haptics setting set to “Prominent”, the device 100 outputs prominent haptic 608 in response to detecting the incoming phone call 6020-a. For example, as described with reference to FIG. 6R, while the device 600 has a haptics setting set to “Prominent”, the device 600 outputs prominent haptic 620 in response to detecting the alarm notification 6026-a.

The first tactile output difference is (814) different from the second tactile output difference. For example, as described with reference to FIG. 6A, the difference between prominent haptic 602 and haptic 606 (e.g., output in response to the incoming message notification 6018) includes differences in the amplitudes of a plurality of discrete haptic events in that, for the haptic 606, the amplitudes of the plurality of discrete haptic events in the pattern are modulated, whereas in the prominent haptic 602, each haptic event has a same amplitude (e.g., that is no less than the amplitude of a respective discrete haptic event in the haptic 606). In another example, as described with reference to FIG. 6B, the difference between prominent haptic 608 and haptic 612 (e.g., that are output in response to the incoming phone call 6020) includes differences in a length of a third haptic event (e.g., to increase the length of the third haptic event in the prominent haptic 608 relative to the haptic 612). In some embodiments, the first tactile output difference is associated with a first change in tactile output pattern, and the second tactile output difference is associated with a second change in tactile output pattern that is different from the first change in tactile output pattern (e.g., the first higher prominence tactile output differs in pattern from the first lower prominence tactile output in a different manner than the second higher prominence tactile output differs in pattern from the second lower prominence tactile output). As an illustrative example, the first higher prominence tactile output is longer in duration than the first lower prominence tactile output (e.g., because the first higher prominence tactile output includes a longer series of tactile output components than in the first lower prominence tactile output) whereas the second higher prominence tactile output has the same duration and number of pulses as the second lower prominence tactile output yet the amplitude(s) of one or more of the pulses of the second higher prominence tactile output is higher than in the second lower prominence tactile output.

In some embodiments, the first alert condition is (816) a first type of alert condition (e.g., in a first category, class, or group of alert conditions); and the second alert condition is a second type of alert condition that is different from the first type of alert condition (e.g., in a second class or group of alert conditions). In some embodiments, in response to detecting a third alert condition that is different from the first alert condition and from the second alert condition, and if a higher prominence tactile output is to be provided for the third alert condition (e.g., if the increased salience setting is enabled), if the third alert condition is the first type of alert condition, the higher prominence tactile output corresponding to the third alert condition differs from a corresponding lower prominence tactile output corresponding to the third alert condition by the first tactile output difference, whereas if the third alert condition is the second type of alert condition, the higher prominence tactile output corresponding to the third alert condition differs from the lower prominence tactile output corresponding to the third alert condition by the second tactile output difference. For example, as described with reference to FIGS. 6I and 6K, different haptic patterns and/or audio patterns (e.g., a set of haptic and audio outputs) are assigned to different types of alerts. Associating a different haptic pattern with different types of alerts and/or notifications enables the user to identify receipt of a respective type of alert and/or notification based on the haptic pattern, thereby providing feedback about a state of the computer system without requiring the user to view a visual representation of the alert and/or notification.

In some embodiments, the computer system is in communication with one or more audio output devices, and in response to detecting the occurrence of the first alert condition, the computer system outputs (818), via the one or more audio output devices, an audio output corresponding to the first alert condition (e.g., in conjunction with, or concurrently with, outputting the tactile output corresponding to the first alert condition). For example, as described with reference to FIGS. 6A-6G, a set (e.g., pair) of prominent and non-prominent haptic outputs is associated with a corresponding respective audio output (e.g., prominent haptic 602 and haptic 606 are associated with audio 604 (FIG. 6A)). In some embodiments, as described with reference to FIGS. 6I and 6K, a “Tone” that includes the audio and haptic output set is assigned to a respective type of alert. For example, as described with reference to FIGS. 6L-6M, the “text tone” (e.g., that is provided in response to detecting occurrence of a message notification 6018) is set to “Tone 2,” which corresponds to the prominent haptic 602, the audio 604 and/or the haptic 606. Associating a different haptic pattern, and a corresponding audio output, with different types of alerts and/or notifications enables the user to identify receipt of a respective type of alert and/or notification based on the haptic pattern and/or audio output, thereby providing feedback about a state of the computer system without requiring the user to view a visual representation of the alert and/or notification.

In some embodiments, the first lower prominence tactile output is configured to (820) complement (e.g., is designed to match, such as by including one or more tactile output features selected to complement) the audio output corresponding to the first alert condition, and the first higher prominence tactile output is configured to complement (e.g., is designed to match, such as by including one or more tactile output features selected to complement) the audio output corresponding to the first alert condition. In some embodiments, the first lower prominence tactile output includes one or more of the same tactile output features selected to complement the audio output corresponding to the first alert condition as the first higher prominence tactile output includes. In some embodiments, the first lower prominence tactile output includes different tactile output features selected to complement the audio output corresponding to the first alert condition than the first higher prominence tactile output includes (e.g., optionally, the first lower prominence tactile output and the first higher prominence tactile output both include tactile output features selected to complement the audio output corresponding to the first alert condition yet include none of the same tactile output features as each other). For example, as described with reference to FIGS. 6A-6G, the prominent and non-prominent haptic outputs are designed to match the audio associated with the set of prominent and non-prominent haptic outputs. For example, one or more haptic events in prominent haptic 602 and haptic 606 are generated to occur at a same time as one or more audio events in the audio 604, and optionally, the haptic 606 is modulated in amplitude based on an amplitude of the audio events in audio 604. In another example, in FIG. 6C, discrete haptic events in the prominent haptic 614, as well as discrete haptic events in the non-prominent haptic 618, occur at respective times that corresponds to an onset of an audio event of the audio 616. In some embodiments, a length of the third event illustrated in the prominent haptic 614 is extended to match, or extend past, a length of the audio event illustrated in the audio 616 in FIG. 6C. Associating a prominent haptic pattern and a non-prominent haptic pattern for a respective type of alert and/or notification with a same corresponding audio output enables the user to identify receipt of a respective type of alert and/or notification based on the prominent haptic pattern, the non-prominent haptic pattern and/or the audio output, thereby providing feedback about a state of the computer system without requiring the user to view a visual representation of the alert and/or notification.

In some embodiments, the computer system is in communication with one or more audio output devices, and, in response to detecting the occurrence of the second alert condition, the computer system outputs (822), via the one or more audio output devices, an audio output corresponding to the second alert condition (e.g., in conjunction with, or concurrently with, outputting the tactile output corresponding to the second alert condition). For example, as described with reference to FIGS. 6A-6G, a set (e.g., pair) of prominent and non-prominent haptic outputs is associated with a corresponding respective audio output (e.g., prominent haptic 608 and haptic 612 are associated with audio 610 (FIG. 6B)). For example, as described with reference to FIGS. 6N-6O, the “ringtone” (e.g., that is provided in response to detecting occurrence of the incoming phone call 6020) is set to “Tone 1,” which corresponds to the prominent haptic 608, the audio 610 and/or the haptic 612. Associating a second haptic pattern with a second type of alert, including associating the second haptic pattern with an audio output of the second type of alert whereby the second haptic pattern is based on (e.g., complements or otherwise matches one or more audio events of) the audio output of the second type of alert, enables the user to identify a respective type of alert and/or notification based on the haptic pattern, thereby providing feedback about a state of the computer system without requiring the user to view a visual representation of the alert and/or notification.

In some embodiments, the second lower prominence tactile output is configured to (824) complement (e.g., is designed to match, such as by including one or more tactile output features selected to complement) the audio output corresponding to the second alert condition, and the second higher prominence tactile output is configured to complement (e.g., is designed to match, such as by including one or more tactile output features selected to complement) the audio output corresponding to the second alert condition. In some embodiments, the second lower prominence tactile output include one or more of the same tactile output features or different tactile output features (and in some embodiments, none of the same tactile output features) selected to complement the audio output corresponding to the second alert condition as the second higher prominence tactile output includes (e.g., as described herein with reference to the first lower prominence tactile output and first higher prominence tactile output). For example, as described with reference to FIGS. 6A-6G, the prominent and non-prominent haptic outputs are designed to match the audio associated with the set of prominent and non-prominent haptic outputs. For example, in FIG. 6B, the prominent haptic 608 and/or the non-prominent haptic 612 include haptic events that occur at times that correspond to (e.g., overlap with or otherwise play concurrently with) audio events in audio 610. Associating a second prominent haptic pattern and a second non-prominent haptic pattern for the second type of alert and/or notification with a same corresponding audio output for the second type of alert, whereby the second prominent haptic pattern and the second non-prominent haptic pattern is based on (e.g., complements or otherwise matches one or more audio events of) the audio output of the second type of alert, enables the user to identify receipt of the second type of alert and/or notification based on the prominent haptic pattern, the non-prominent haptic pattern and/or the audio output, thereby providing feedback about a state of the computer system without requiring the user to view a visual representation of the alert and/or notification.

In some embodiments, the first higher prominence tactile output for the first alert condition and the first lower prominence tactile output for the first alert condition are (826) selected by a user for the first alert condition (e.g., in a settings user interface that provides access to a plurality of configuration options for the computer system and/or in a control user interface that provides access to a plurality of controls corresponding to different control functions of the computer system, and that enables the user to select tactile outputs for one or more alert conditions). In some embodiments, while a third higher prominence tactile output and a third lower prominence tactile output are selected by a user for the first alert condition (e.g., in response to detecting one or more inputs, via one or more input devices, corresponding to a request to change the tactile outputs selected for the first alert condition), wherein the third higher prominence tactile output is different from the first higher prominence tactile output, and the third lower prominence tactile output is different from the first lower prominence tactile output, the computer system detects a second occurrence of the first alert condition (e.g., a different instance or occurrence, such as a subsequent occurrence or a prior occurrence, of an alert condition as described herein, such as an input detected via one or more input devices, a notification, a system status change, or another event or condition that triggers one or more outputs to be generated to alert the user); and in response to detecting the second occurrence of the first alert condition, the computer system outputs a tactile output corresponding to the first alert condition, including: in accordance with a determination that the increased salience setting of the computer system is not enabled (e.g., the second occurrence of the first alert condition is detected while the increased salience setting is not enabled), outputting, via the one or more tactile output generators, the third lower prominence tactile output corresponding to the first alert condition; and in accordance with a determination that the increased salience setting of the computer system is enabled (e.g., the second occurrence of the first alert condition is detected while the increased salience setting is enabled), outputting, via the one or more tactile output generators, the third higher prominence tactile output corresponding to the first alert condition. In some embodiments, the third higher prominence tactile output is higher than a prominence of the third lower prominence tactile output. In some embodiments, a user is analogously enabled to select a different set of higher prominence and lower prominence tactile outputs for the second alert condition, so as to change the higher prominence tactile output (e.g., if the increased salience setting is enabled) and lower prominence tactile output (e.g., if the increased salience setting is not enabled) that would be output in response to detecting another occurrence of the second alert condition while the different set of higher and prominence and lower prominence tactile outputs for the second alert condition are selected. For example, as described with reference to FIG. 6I, the user selects a respective “Tone” corresponding to a set of audio and/or haptic outputs to associate with different types of alerts, such that at least one of the outputs in the set of audio and/or haptic outputs selected for a respective type of alert is provided in response to detecting occurrence of the respective type of alert. For example, in accordance with the user changing the tone selected for the “text tone” to a different tone, e.g., from Tone 2 to Tone 7, a different set of outputs (e.g., prominent haptic 638, haptic 642 and/or audio 640 (FIG. 6G) instead of prominent haptic 602, haptic 606 and/or audio 604 (FIG. 6A)) will be provided in response to detecting a message notification. Providing the user with control options to change a first respective haptic to a second respective haptic for a set of alerts, an automatically updating the haptic output to the second respective haptic in response to detecting occurrence of an alert in the set of alerts, provides the user with additional control options and enables the user to more easily identify a type of alert based on the respective haptic the user assigned to the type of alert.

In some embodiments, the computer system is in communication with one or more audio output devices, and, in response to detecting the occurrence of the first alert condition, the computer system outputs (828), via the one or more audio output devices, a first audio output corresponding to the first alert condition (e.g., in conjunction with, or concurrently with, outputting the tactile output corresponding to the first alert condition); and in response to detecting the second occurrence of the first alert condition, the computer system outputs, via the one or more audio output devices, a second audio output corresponding to the first alert condition, wherein the second audio output is different from the first audio output (e.g., consistent with the different higher and lower prominence tactile outputs being selected for the first alert condition). For example, as described with reference to FIG. 6I, the user selects a respective “Tone” corresponding to a set of audio and/or haptic outputs to associate with different types of alerts, such that at least one of the outputs in the set of audio and/or haptic outputs selected for a respective type of alert is provided in response to detecting occurrence of the respective type of alert. For example, in accordance with the user changing the tone selected for the “text tone” to a different tone, e.g., from Tone 2 to Tone 7, audio 640 will be provided in response to detecting a message notification instead of audio 604. Automatically changing an audio output that is associated with a second respective haptic that has been assigned to a set of alerts, such that the audio output corresponds to the second respective haptic, reduces the number of inputs required from the user to coordinate haptic and audio outputs.

In some embodiments, a prominence of the second respective higher prominence tactile output is (830) different than (e.g., lower than or higher than) a prominence of the respective higher prominence tactile output, and/or a prominence of the second respective lower prominence tactile output is different than (e.g., lower than or higher than) a prominence of the respective lower prominence tactile output. In some embodiments, selecting a different tactile output option for a respective alert condition changes the prominence of the higher prominence tactile output, or of the lower prominence tactile output, or of both the higher and lower prominence tactile outputs for the respective alert condition. For example, as illustrated in FIGS. 6A-6G, the sets of haptic outputs that are assigned to different types of alerts have different levels of prominence. For example, the haptic 636 (FIG. 6F) has a higher (or lower) level of prominence than the haptic 630 (FIG. 6E), and/or the prominent haptic 632 (FIG. 6F) has a higher (or lower) level of prominence than the prominent haptic 626 (FIG. 6E). In another example, the haptic 612 (FIG. 6B) has a higher (or lower) level of prominence than the haptic 618 (FIG. 6C), and/or the prominent haptic 608 (FIG. 6B) has a higher (or lower) level of prominence than the prominent haptic 614 (FIG. 6C). Outputting a second haptic output, that is different than a first haptic output, with different available levels of prominence that are different from the different levels of prominence available for the first haptic output, provides a wider range of haptic combinations such that the user can more easily identify a type of alert based on the respective haptic, whether played with a higher prominence or a lower prominence.

In some embodiments, the computer system detects (832) occurrence of a third alert condition that is a third type of alert condition (e.g., as described herein, an input detected via one or more input devices, a notification, a system status change, or another event or condition that triggers one or more outputs to be generated to alert the user). In some embodiments, in response to detecting the occurrence of the third alert condition: in accordance with a determination that the increased salience setting of the computer system is not enabled (e.g., the second alert condition is detected while the increased salience setting is not enabled), the computer system outputs, via the one or more tactile output generators, a third tactile output for the third alert condition; and in accordance with a determination that the increased salience setting of the computer system is enabled (e.g., the second alert condition is detected while the increased salience setting is enabled), the computer system outputs, via the one or more tactile output generators, the third tactile output for the third alert condition, wherein the first alert condition is a different type of alert condition than the third type of alert condition, and the second alert condition is a different type of alert condition than the third type of alert condition (e.g., whether the first alert condition and the second alert condition are the same or different types of alert condition, neither is the third type of alert condition (e.g., neither is the same type of alert condition as the third alert condition)). In some embodiments, in response to detecting occurrence of a respective alert condition that is a type of alert condition for which higher prominence tactile outputs are not to be provided, such as alert conditions of the third type, the same respective tactile output is output for the respective alert condition without regard to whether or not the increased salience setting is enabled or not. For example, distinct higher and lower prominence tactile outputs are not provided for tactile outputs generated to provide feedback for detected inputs (e.g., button presses, keyboard presses, touch inputs, air gestures, and/or other inputs). For example, as described with reference to FIG. 6A-6S, the haptic outputs that are provided in response to detecting user inputs, including those directed to a virtual keyboard that is displayed in a user interface of the device 100, and/or in response to other types of notifications, alerts, and/or haptic triggers do not change in response to the user changing the haptics setting from default to prominent, or vice-versa. Providing a same haptic output for a respective type of alert, regardless of whether an increased prominence setting is enabled or disabled decreases the amount of wear on the haptic output generators.

In some embodiments, a duration of a respective higher prominence tactile output for a respective alert condition is (834) longer than a duration of a respective lower prominence tactile output for the respective alert condition. For example, the first higher prominence tactile output is longer in duration than the first lower prominence tactile output (e.g., the first tactile output difference includes differences in the tactile output duration for the first alert condition), and/or the second higher prominence tactile output is longer in duration than the second lower prominence tactile output (e.g., the second tactile output difference includes differences in the tactile output duration for the second alert condition). In some embodiments, more generally, a respective tactile output difference between the respective higher prominence tactile output and the respective lower prominence tactile output for the respective alert condition includes a difference in duration. For example, as described with reference to FIG. 6B, the haptic 612 includes three haptic events, including two short haptic events followed by one long haptic event that ceases within a first time threshold of an end of the audio 610 output, while the prominent haptic 608 also includes three haptic events like haptic 612, but the last haptic event for the prominent haptic 608 has a longer duration than the last haptic event of haptic 612. More generally, one or more haptic events in prominent haptic 608 are different in duration than respective corresponding haptic events in haptic 612. Providing a more prominent version of a respective haptic output, that is output for a longer period of time than a less prominent version of the respective haptic, enables the user to more easily perceive the alert and differentiate between whether an increased prominence setting of the computer system is enabled or disabled, thereby providing feedback about a state of the computer system.

In some embodiments, a respective higher prominence tactile output for a respective alert condition includes (836) one or more differences in amplitude (e.g., of one or more portions of the tactile output) from a respective lower prominence tactile output for the respective alert condition. In some embodiments, more generally, a respective tactile output difference includes one or more differences in amplitude. For example, as described with reference to FIG. 6A, the haptic 606 includes seven discrete haptic events, whereby the amplitude of the first three haptic events gradually increases (e.g., with each successive haptic event) before the last four haptic events gradually decrease (e.g., with each successive haptic event) in amplitude, whereas the prominent haptic 602 maintains seven discrete haptic events without changing an amplitude of the haptic events. More generally, one or more haptic events in prominent haptic 602 are different in amplitude than respective corresponding haptic events in haptic 606. Providing a more prominent version of a respective haptic output, that is output with a different amplitude (e.g., and/or modulation of amplitudes) than a less prominent version of the respective haptic, enables the user to more easily perceive the alert and differentiate between whether an increased prominence setting of the computer system is enabled or disabled, thereby providing feedback about a state of the computer system.

In some embodiments, a respective higher prominence tactile output for a respective alert condition includes (838) an additional sequence of one or more tactile output components (e.g., in series with a first sequence of tactile output components or a higher prominence version of the first sequence of tactile output components), and a respective lower prominence tactile output for the respective alert condition does not include the additional sequence of one or more tactile output components (e.g., while including the first sequence of tactile output components or a lower prominence version of the first sequence of tactile output components). In some embodiments, more generally, a respective tactile output difference includes differences in the number of tactile output components in sequence. For example, as described with reference to FIG. 6F, the non-prominent haptic 636 includes two haptic events, including a first haptic event that increases in amplitude over a first period of time, followed by a second discrete haptic event, whereas the prominent haptic 632 includes the same two haptic events of haptic 636 with an additional third haptic event (e.g., following the first two haptic events) that decreases in amplitude over a second period of time (e.g., that is optionally longer than the first period of time). In some embodiments, as described with reference to FIG. 6G, the non-prominent haptic 642 includes five discrete haptic events, whereas the prominent haptic 638 includes eight discrete haptic events, whereby the prominent haptic 638 is output for a longer period of time than the haptic 642 (e.g., the prominent haptic 638 includes three additional haptic events before the five haptic events of haptic 642). Providing a more prominent version of a respective haptic output that is output with additional haptic events added to the end portion of the haptic output, as compared to a less prominent version of the respective haptic, enables the user to more easily perceive the alert and differentiate between whether an increased prominence setting of the computer system is enabled or disabled, thereby providing feedback about a state of the computer system.

In some embodiments, the tactile output corresponding to the first alert condition includes (840) one or more tactile output components selected from a respective collection of tactile output components, and the tactile output corresponding to the second alert condition includes one or more tactile output components selected from the respective collection of tactile output components (e.g., the tactile output for the first alert condition and the tactile output for the second alert condition optionally include tactile output components selected from the same respective collection of components, and optionally include one or more of the same tactile output components). For example, as described with reference to FIG. 6I, a same respective tone, such as “Tone 1,” is assigned to two or more categories of alerts (e.g., “ringtone” and “text tone”). In some embodiments, as described with reference to FIG. 6I, the same options for tones are presented as a collection of tones from which the user selects tones to assign to, e.g., the “new mail” category and the “calendar alerts” category and/or one or more other categories of alerts. Enabling a user to select a respective haptic output from a plurality of available haptic output options, and to assign the respective haptic output to one or more types of alerts, provides a collection of haptic outputs for the user to choose from, thereby providing additional control options for the user while limiting wear of the haptic output generators by limiting which haptic outputs are available for selection.

It should be understood that the particular order in which the operations in FIGS. 8A-8D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 800 described above with respect to FIGS. 8A-8D. For example, the tactile outputs, inputs, and/or audio output devices, described above with reference to method 800 optionally have one or more of the characteristics of the tactile outputs, inputs, and/or audio output devices, described herein with reference to other methods described herein (e.g., method 700). For brevity, these details are not repeated here.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at a computer system that includes one or more display devices, and one or more tactile output generators and is in communication with one or more audio output devices and one or more input devices:
outputting, via the one or more audio output devices, audio content of media being played via a media player application;
while outputting the audio content without outputting tactile outputs corresponding to the audio content, displaying, via the one or more display devices, a tactile output control, and detecting, via the one or more input devices, a first input activating the tactile output control; and
in response to detecting the first input activating the tactile output control, outputting, via the one or more tactile output generators, a sequence of tactile outputs corresponding to a plurality of audio features of the audio content that are being output in conjunction with the sequence of tactile outputs.

2. The method of claim 1, including, while outputting the sequence of tactile outputs corresponding to a plurality of audio features of the audio content that are being output in conjunction with the sequence of tactile outputs and while displaying the tactile output control:
detecting, via the one or more input devices, a second input activating the tactile output control; and
in response to detecting the second input activating the tactile output control, ceasing to output, via the one or more tactile output generators, the sequence of tactile outputs corresponding to the plurality of audio features of the audio content while continuing to output the audio content of the media being played.

3. The method of claim 1, including displaying, via the one or more display devices, a media player user interface, wherein the media player user interface includes a plurality of controls corresponding to different functions of the media player application, and the plurality of controls includes the tactile output control.

4. The method of claim 3, wherein the media player user interface is displayed in a user interface of a media player application.

5. The method of claim 3, wherein the media player user interface is displayed in a wake screen user interface that corresponds to a restricted state of the computer system.

6. The method of claim 3, wherein the media player user interface is displayed in a media playback control region in a control user interface that includes a plurality of controls corresponding to a plurality of control functions of the computer system.

7. The method of claim 3, wherein the media player user interface is displayed in a status region displayed concurrently with at least a portion of a home screen user interface of the computer system.

8. The method of claim 7, including:
while displaying the media player user interface, which includes the tactile output control, in the status region concurrently with displaying at least the portion of the home screen user interface, detecting, via the one or more input devices, one or more user inputs corresponding to a request to reduce a visual prominence of the status region; and
in response to detecting the one or more user inputs corresponding to the request to reduce the visual prominence of the status region, displaying, via the one or more display devices, concurrently with at least the portion of the home screen user interface, an updated status region that includes status information about the media being played without including the tactile output control, wherein the updated status region is different from the status region that was displayed prior to detecting the one or more user inputs corresponding to the request to reduce the visual prominence of the status region.

9. The method of claim 1, including displaying, via the one or more display devices, a control user interface that provides access to a plurality of controls corresponding to different control functions of the computer system, wherein the control user interface includes the tactile output control.

10. The method of claim 9, including:
while a respective mode is not enabled, detecting, via the one or more input devices, one or more first inputs corresponding to a request to display the control user interface;
in response to detecting the one or more first inputs, displaying, via the one or more display devices, the control user interface without the tactile output control; and
while the respective mode is enabled, detecting, via the one or more input devices, one or more second inputs corresponding to a request to display the control user interface;
wherein displaying the control user interface that includes the tactile output control is performed in response to detecting the one or more second inputs via the one or more input devices.

11. The method of claim 1, including displaying, via the one or more display devices, a settings user interface that provides access to a plurality of configuration options for the computer system, wherein the settings user interface includes the tactile output control.

12. The method of claim 11, including displaying, via the one or more display devices, in the settings user interface, a list of one or more software applications of the computer system that are configured to output tactile outputs corresponding to audio features of audio content.

13. The method of claim 1, including:
in accordance with a determination that a respective mode is enabled, displaying, via the one or more display devices, in a media player user interface, a first indication; and
in accordance with a determination that the respective mode is not enabled, forgoing displaying, in the media player user interface, the first indication.

14. The method of claim 13, including, in accordance with the determination that the respective mode is enabled, displaying, via the one or more display devices, in the media player user interface, the first indication without regard to whether tactile outputs corresponding to a plurality of audio features of the audio content are available.

15. The method of any of claim 13, including:
in accordance with the determination that the respective mode is enabled:
while loading information that can be used by the computer system to generate the tactile outputs corresponding to a plurality of audio features of the audio content, displaying, via the one or more display devices, a plurality of intermediate indications.

16. The method of claim 1, wherein the media being played via the media player application is music.

17. The method of claim 1, wherein the media being played via the media player application includes video content.

18. The method of claim 1, wherein the sequence of tactile outputs corresponding to the plurality of audio features of the audio content is automatically generated.

19. The method of claim 1, including, while outputting the sequence of tactile outputs corresponding to the plurality of audio features of the audio content that are being output in conjunction with the sequence of tactile outputs:
detecting occurrence of an event corresponding to a request to pause playback of the audio content; and
in response to detecting the occurrence of the event corresponding to the request to pause the audio content, ceasing to output, via the one or more audio output devices, the audio content of the media being played in conjunction with ceasing to output, via the one or more tactile output generators, the sequence of tactile outputs corresponding to the plurality of audio features of the audio content.

20. The method of claim 1, wherein outputting the sequence of tactile outputs corresponding to the plurality of audio features of the audio content that are being output in conjunction with the sequence of tactile outputs includes outputting the sequence of tactile outputs at a first tactile output volume while the audio content is being output at a first audio output volume, and the method includes:
detecting, via the one or more input devices, an input corresponding to a request to change a media output volume; and
in response to detecting the input corresponding to the request to change the media output volume, outputting, via one or more tactile output generators, the sequence of tactile outputs at the first tactile output volume while outputting, via the one or more audio output devices, the audio content at a second audio output volume that is different from the first audio output volume.

21. The method of claim 1, wherein one or more properties of the sequence of tactile outputs corresponding to the plurality of audio features of the audio content are selected by a user.

22. The method of claim 21, wherein outputting the sequence of tactile outputs corresponding to the plurality of audio features of a respective portion of the audio content includes:
in accordance with a determination that a first tactile output intensity setting is selected by a user, outputting the sequence of tactile outputs with a first set of tactile output intensities during the respective portion of the audio content; and
in accordance with a determination that a second tactile output intensity setting is selected by a user, wherein the second tactile output intensity setting is different from the first tactile output intensity setting, outputting the sequence of tactile outputs with a second set of tactile output intensities that is different from the first set of tactile output intensities during the respective portion of the audio content.

23. The method of claim 21, wherein outputting the sequence of tactile outputs corresponding to the plurality of audio features of a respective portion of the audio content includes:
in accordance with a determination that a first set of audio feature types is selected by a user, outputting, via the one or more tactile output generators, a first sequence of tactile outputs corresponding to a plurality of audio features of the audio content of the first set of audio feature types during the respective portion of the audio content; and
in accordance with a determination that a second set of audio feature types is selected by a user, wherein the second set of audio feature types is different from the first set of audio feature types, outputting, via the one or more tactile output generators, a second sequence of tactile outputs corresponding to a plurality of audio features of the audio content of the second set of audio feature types, wherein the second sequence of tactile outputs is different from the first sequence of tactile outputs during the respective portion of the audio content.

24. The method of claim 1, wherein outputting the sequence of tactile outputs corresponding to the plurality of audio features of the audio content includes:
in accordance with a determination that the audio content includes a first type of audio event indicative of percussive sound, outputting, via the one or more tactile output generators, a first type of tactile output that is a discrete tactile output as part of the sequence of tactile outputs corresponding to the plurality of audio features of the audio content; and
in accordance with a determination that the audio content includes a second type of audio event indicative of sustained sound, outputting, via the one or more tactile output generators, a second type of tactile output that is a continuous tactile output as part of the sequence of tactile outputs corresponding to the plurality of audio features of the audio content, wherein the second type of tactile output is different from the first type of tactile output.

25. The method of claim 24, wherein the second type of tactile output that is a continuous tactile output has a tactile output frequency that is based on a pitch associated with the second type of audio event.

26. The method of claim 24, wherein outputting the second type of tactile output that is a continuous tactile output includes:
in accordance with a determination that the second type of audio event indicative of sustained sound is associated with a vocal sound, outputting the second type of tactile output with a tactile output frequency that is based on a pitch of the vocal sound; and
in accordance with a determination that the second type of audio event indicative of sustained sound is not associated with vocal sound, outputting the second type of tactile output with a tactile output frequency that is based on a pitch associated with instrumental sound.

27. The method of claim 24, wherein the first type of tactile output that is a discrete tactile output has an amplitude that is based on a peak energy associated with the first type of audio event.

28. The method of claim 24, wherein the first type of tactile output that is a discrete tactile output has a frequency that is based on a width associated with the first type of audio event.

29. The method of claim 24, wherein determining that the audio content includes the second type of audio event indicative of sustained sound includes determining that the audio content includes sustained sound that is at least a threshold duration, and outputting the sequence of tactile outputs corresponding to the plurality of audio features of the audio content includes:
in accordance with a determination that the audio content includes a third type of audio event indicative of sustained sound that is less than the threshold duration, forgoing outputting a tactile output that is a continuous tactile output and that corresponds to the third type of audio event.

30. The method of claim 24, including:
in accordance with a determination that the audio content includes a first event that is the second type of audio event indicative of sustained sound followed by a second event that is the second type of audio event indicative of sustained sound, outputting, via the one or more tactile output generators, one or more tactile outputs of the second type corresponding to the first event and the second event, including:
in accordance with a determination that the second event occurs less than a threshold amount of time after the first event, outputting, via the one or more tactile output generators, a first tactile output portion of the second type corresponding to the first event and a second tactile output portion of the second type corresponding to the second event without a gap between the first tactile output portion and the second tactile output portion; and
in accordance with a determination that the second event occurs at least the threshold amount of time after the first event, outputting, via the one or more tactile output generators, a first tactile output of the second type corresponding to the first event and a second tactile output of the second type corresponding to the second event with a gap between the first tactile output and the second tactile output.

31. The method of claim 1, including:
outputting, via the one or more audio output devices, a respective portion of the audio content that includes a first audio portion and a second audio portion, wherein the second audio portion is different from the first audio portion, and a tactile output corresponding to the first audio portion overlaps with a tactile output corresponding to the second audio portion; and
outputting the tactile output corresponding to the first audio portion using a first device of the one or more tactile output generators, concurrently with outputting the tactile output corresponding to the second audio portion using a second device of the one or more tactile output generators, wherein the second device is different from the first device.

32. A computer system in communication with one or more audio output devices and one or more input devices, comprising:
one or more display devices;
one or more tactile output generators;
one or more processors; and
memory storing one or more programs, wherein the one or more programs are configured to be executed by the one or more processors, the one or more programs including instructions for:
outputting, via the one or more audio output devices, audio content of media being played via a media player application;
while outputting the audio content without outputting tactile outputs corresponding to the audio content, displaying, via the one or more display devices, a tactile output control, and detecting, via the one or more input devices, a first input activating the tactile output control; and
in response to detecting the first input activating the tactile output control, outputting, via the one or more tactile output generators, a sequence of tactile outputs corresponding to a plurality of audio features of the audio content that are being output in conjunction with the sequence of tactile outputs.

33. A computer readable storage medium storing one or more programs, the one or more programs comprising instructions that, when executed by a computer system with one or more display devices and one or more tactile output generators that is in communication with one or more audio output devices and one or more input devices, cause the computer system to:
output, via the one or more audio output devices, audio content of media being played via a media player application;
while outputting the audio content without outputting tactile outputs corresponding to the audio content, display, via the one or more display devices, a tactile output control, and detecting, via the one or more input devices, a first input activating the tactile output control; and
in response to detecting the first input activating the tactile output control, output, via the one or more tactile output generators, a sequence of tactile outputs corresponding to a plurality of audio features of the audio content that are being output in conjunction with the sequence of tactile outputs.

34-49. (canceled)
